(19) United States
(12) Patent Application Publication
(10) Pub. No.: US 2014/0198234 A1
(43) Pub. Date: Jul. 17, 2014

(54) IMAGE PROCESSING APPARATUS, PROGRAM, IMAGE PROCESSING METHOD, AND IMAGING APPARATUS

(71) Applicant: NIKON CORPORATION, Tokyo (JP)

(72) Inventors: Hiroko Kobayashi, Tokyo (JP); Tsukasa Murata, Yamato-shi (JP); Takeshi Matsuo, Tokyo (JP)

(73) Assignee: Nikon Corporation, Tokyo (JP)

(21) Appl. No.: 14/239,445

(22) PCT Filed: Sep. 21, 2012
(86) PCT No.: PCT/JP2012/074230

§ 371 Date: Feb. 18, 2014

(30) Foreign Application Priority Data
Sep. 21, 2011 (JP) 2011-206024
Dec. 5, 2011 (JP) 2011-266143
Dec. 6, 2011 (JP) 2011-266805
Dec. 7, 2011 (JP) 2011-267882
Sep. 19, 2012 (JP) 2012-206296
Sep. 19, 2012 (JP) 2012-206297
Sep. 19, 2012 (JP) 2012-206298
Sep. 19, 2012 (JP) 2012-206299

(51) Int. Cl. H04N 1/21

(52) U.S. Cl. CPC H04N 1/2129
USPC 348/231.99

(57) ABSTRACT

An image processing apparatus includes: a decision unit that determines a character having a predetermined meaning from a captured image; a determination unit that determines whether the captured image is a person image or the captured image is an image which is different from the person image; a storage unit that stores a first syntax which is a syntax of a sentence used for the person image and a second syntax which is a syntax of a sentence used for the image which is different from the person image; and an output unit that outputs a sentence of the first syntax using the character having a predetermined meaning when the determination unit determines that the captured image is the person image, and outputs a sentence of the second syntax using the character having a predetermined meaning when the determination unit determines that the captured image is the image which is different from the person image.

### TECHNICAL FIELD

The present invention relates to an image processing apparatus, a program, an image processing method, and an imaging apparatus.

Priority is claimed on Japanese Patent Application No. 2011-266143 filed on Dec. 5, 2011, Japanese Patent Application No. 2011-206024 filed on Sep. 21, 2011, Japanese Patent Application No. 2011-266805 filed on Dec. 6, 2011, Japanese Patent Application No. 2011-267882 filed on Dec. 7, 2011, Japanese Patent Application No. 2012-206296 filed on Sep. 19, 2012, Japanese Patent Application No. 2012-206297 filed on Sep. 19, 2012, Japanese Patent Application No. 2012-206298 filed on Sep. 19, 2012, and Japanese Patent Application No. 2012-206299 filed on Sep. 19, 2012, the contents of which are incorporated herein by reference.

### BACKGROUND

In the related art, a technology is disclosed in which the birthday of a specific person, the date of an event, or the like can be registered in advance, and thereby character information can be added to a captured image, the character information including the name of the person whose birthday corresponds to the image capture date, the name of the event corresponding to the image capture date, or the like (for example, refer to Patent Document 1).

In addition, in an image processing apparatus of the related art in which an image is categorized, an image is divided into regions in a predetermined pattern, and a histogram of distribution regarding the color for each of the regions is created. Then, in the image processing apparatus of the related art, the most frequently appearing color which appears with a frequency exceeding a specific threshold value is determined to be a representative region color of the region. Moreover, in the image processing apparatus of the related art, a characteristic attribute of the region is extracted, and an image from which the characteristic attribute is extracted is defined on the basis of the determined characteristic attribute and the determined representative color of the region, thereby creating an image dictionary.

In the image processing apparatus of the related art, for example, a representative color of a large region at the upper of an image is extracted, and on the basis of the extracted representative color, the image is defined as “blue sky”, “cloudy sky”, “night sky”, or the like, thereby assembling an image dictionary (for example, refer to Patent Document 2).

In addition, currently, a technology is disclosed in which a text relating to a captured image is superimposed on the captured image (for example, refer to Patent Document 3). In Patent Document 3 of the related art, a superimposed image is generated by superimposing a text on a non-important region in the captured image which is a region other than an important region in which a relatively important object is imaged. Specifically, a region in which a person is imaged is classified as the important region, and the text is superimposed within the non-important region which does not include the center of the image.

In addition, a technology is disclosed in which a predetermined color conversion is applied to image data (for example, refer to Patent Document 4). In Patent Document 4 of the related art, when image data to which the predetermined color conversion is applied is sent to a printer, the image data is categorized as image data of an image, image data of a character, or image data of a non-image other than a character. A first color conversion is applied to the image data of an image, the first color conversion or a second color conversion is applied to the image data of a character, and the first color conversion or the second color conversion is applied to the image data of a non-image other than a character.

### RELATED ART DOCUMENTS

### Patent Documents

[Patent Document 1] Japanese Unexamined Patent Application, First Publication No. H2-303282
[Patent Document 2] Japanese Unexamined Patent Application, First Publication No. 2001-160057
[Patent Document 3] Japanese Unexamined Patent Application, First Publication No. 2007-96816
[Patent Document 4] Japanese Unexamined Patent Application, First Publication No. 2008-293082

### SUMMARY OF INVENTION

### Problems to be Solved by the Invention

However, in Patent Document 1 of the related art, only the character information which is registered in advance by a user can be added to the captured image.

In addition, in Patent Document 2 of the related art, since the image is categorized on the basis of the characteristic attribute extracted for each predetermined region and the representative color which is the most frequently appearing color, the burden of arithmetic processing used to categorize (label) the image is great.

In addition, in Patent Document 3 of the related art, a consideration is not made as to readability when the text is superimposed on the image. Therefore, for example, if the text is superimposed on a region in which a complex texture exists, the outline of a font which is used to display the text may overlap the edge of the texture, and thereby degrade the readability of the text. In other words, there is a possibility that the text is illegible.

In addition, in Patent Document 4 of the related art, in the case that a text relating to an image is superimposed on the image, a sufficient consideration is not made to control the font color of the text.

For example, when the font color is fixed, depending on the content of a given image, there is little contrast between the font color of the text and the color of the image region in which the text is drawn, and therefore the readability of the text is significantly degraded.

In addition, when the font color is fixed, or a complementary color which is calculated from image information is used as the font color, the impression of the image may be greatly changed.

An object of an aspect of the present invention is to provide a technology in which character information can be more flexibly added to a captured image.

Another object is to provide an image processing apparatus, an imaging apparatus, and a program that can reduce the burden of arithmetic processing used to label an image.

In addition, another object is to provide an image processing apparatus, a program, an image processing method, and an imaging apparatus that can superimpose a text on an image such that the text is easy for a viewer to read.

In addition, another object of the invention is to provide an image processing apparatus, a program, an image processing method, and an imaging apparatus that can superimpose a text on an image with an appropriate font color.

### Means for Solving the Problem

An image processing apparatus according to an aspect of the present invention includes: an image input unit that inputs a captured image; a storage unit that stores a person image template that is used to create a sentence for a person image in which a person is an imaged object, and a scenery image template that is used to create a sentence for a scenery image in which a scene is an imaged object, as a sentence template in which a word is inserted into a predetermined blank portion and a sentence is completed; a determination unit that determines whether the captured image is the person image or the captured image is the scenery image; and a sentence creation unit that creates a sentence for the captured image, by reading out the sentence template which is any one of the person image template and the scenery image template from the storage unit depending on a determination result by the determination unit with respect to the captured image, and inserting a word according to a characteristic attribute of the captured image or an imaging condition of the captured image into the blank portion of the sentence template which is read out.

An image processing apparatus according to another aspect of the present invention includes: an image input unit to which a captured image is input; a decision unit that determines a text corresponding to at least one of a characteristic attribute of the captured image and an imaging condition of the captured image; a determination unit that determines whether the captured image is an image of a first category or the captured image is an image of a second category that is different from the first category; a storage unit that stores a first syntax which is a syntax of a sentence used for the first category and a second syntax which is a syntax of a sentence used for the second category; and a sentence creation unit that creates a sentence of the first syntax using the text determined by the decision unit when the determination unit determines that the captured image is an image of the first category, and creates a sentence of the second syntax using the text determined by the decision unit when the determination unit determines that the captured image is an image of the second category.

An imaging apparatus according to another aspect of the present invention includes: an imaging unit that images an object and generates a captured image; a storage unit that stores a person image template that is used to create a sentence for a person image in which a person is an imaged object, and a scenery image template that is used to create a sentence for a scenery image in which a scene is an imaged object, as a sentence template in which a word is inserted into a predetermined blank portion and a sentence is completed; a determination unit that determines whether the captured image is the person image or the captured image is the scenery image; and a sentence creation unit that creates a sentence for the captured image, by reading out the sentence template which is any one of the person image template and the scenery image template from the storage unit depending on a determination result by the determination unit with respect to the captured image, and inserting a word according to a characteristic attribute of the captured image or an imaging condition of the captured image into the blank portion of the sentence template which is read out.

A program according to another aspect of the present invention is a program used to cause a computer of an image processing apparatus, the image processing apparatus including a storage unit that stores a person image template that is used to create a sentence for a person image in which a person is an imaged object and a scenery image template that is used to create a sentence for a scenery image in which a scene is an imaged object as a sentence template in which a word is inserted into a predetermined blank portion and a sentence is completed, to execute: an image input step of inputting a captured image; a determination step of determining whether the captured image is the person image or the captured image is the scenery image; and a sentence creation step of creating a sentence for the captured image, by reading out the sentence template which is any one of the person image template and the scenery image template from the storage unit depending on a determination result by the determination step with respect to the captured image, and inserting a word according to a characteristic attribute of the captured image or an imaging condition of the captured image into the blank portion of the sentence template which is read out.

An image processing apparatus according to another aspect of the present invention includes: a decision unit that determines a character having a predetermined meaning from a captured image; a determination unit that determines whether the captured image is a person image or the captured image is an image which is different from the person image; a storage unit that stores a first syntax which is a syntax of a sentence used for the person image and a second syntax which is a syntax of a sentence used for the image which is different from the person image; and an output unit that outputs a sentence of the first syntax using the character having a predetermined meaning when the determination unit determines that the captured image is the person image, and outputs a sentence of the second syntax using the character having a predetermined meaning when the determination unit determines that the captured image is the image which is different from the person image.

An image processing apparatus according to another aspect of the present invention includes: an image acquisition unit that acquires captured image data; a scene determination unit that determines a scene from the acquired image data; a main color extraction unit that extracts a main color on the basis of frequency distribution of color information from the acquired image data; a storage unit in which color information and a first label are preliminarily stored in a related manner for each scene; and a first-label generation unit that reads out the first label which is preliminarily stored and related to the extracted main color and the determined scene from the storage unit, and generates the first label which is read out as a label of the acquired image data.

An imaging apparatus according to another aspect of the present invention includes the image processing apparatus described above.

A program according to another aspect of the present invention is a program used to cause a computer to execute an image processing of an image processing apparatus having an imaging unit, the program causing the computer to execute: an image acquisition step of acquiring captured image data; a scene determination step of determining a scene from the acquired image data; a main color extraction step of extracting a main color on the basis of frequency distribution of color information from the acquired image data; and a first-label generation step of reading out the extracted main color and a first label from a storage unit in which color information and the first label are preliminarily stored in a related manner for each scene, and generating the first label which is read out as a label of the acquired image data.

An image processing apparatus according to another aspect of the present invention includes: a scene determination unit that determines whether or not a scene is a person imaging scene; a color extraction unit that extracts color information from the image data when the scene determination unit determines that a scene is not a person imaging scene; a storage unit in which color information and a character having a predetermined meaning are preliminarily stored in a related manner; and a readout unit that reads out the character having a predetermined meaning corresponding to the color information extracted by the color extraction unit from the storage unit when the scene determination unit determines that a scene is not a person imaging scene.

An image processing apparatus according to another aspect of the present invention includes: an acquisition unit that acquires image data and text data; a detection unit that detects an edge of the image data acquired by the acquisition unit; a region determination unit that determines a region in which the text data is placed in the image data, on the basis of the edge detected by the detection unit; and an image generation unit that generates an image in which the text data is placed in the region determined by the region determination unit.

An image processing apparatus according to another aspect of the present invention includes: an image input unit that inputs image data; an edge detection unit that detects an edge in the image data input by the image input unit; a text input unit that inputs text data; a region determination unit that determines a superimposed region of the text data in the image data, on the basis of the edge detected by the edge detection unit; and a superimposition unit that superimposes the text data on the superimposed region determined by the region determination unit.

A program according to another aspect of the present invention causes a computer to execute: a step of inputting image data; a step of inputting text data; a step of detecting an edge in the input image data; a step of determining a superimposed region of the text data in the image data, on the basis of the detected edge; and a step of superimposing the text data on the determined superimposed region.

An image processing method according to another aspect of the present invention includes: a step in which an image processing apparatus inputs image data; a step in which the image processing apparatus inputs text data; a step in which the image processing apparatus detects an edge in the input image data; a step in which the image processing apparatus determines a superimposed region of the text data in the image data, on the basis of the detected edge; and a step in which the image processing apparatus superimposes the text data on the determined superimposed region.

An imaging apparatus according to another aspect of the present invention includes the image processing apparatus described above.

An image processing apparatus according to another aspect of the present invention includes: a detection unit that detects an edge of image data; a region determination unit that determines a placement region in which a character is placed in the image data, on the basis of a position of the edge detected by the detection unit; and an image generation unit that generates an image in which the character is placed in the placement region determined by the region determination unit.

An image processing apparatus according to another aspect of the present invention includes: an image input unit that inputs image data; a text setting unit that sets text data; a text superimposed region setting unit that sets a text superimposed region that is a region on which the text data set by the text setting unit is superimposed in the image data input by the image input unit; a font setting unit including a font color setting unit that sets a font color with an unchanged hue and a changed tone with respect to the hue and the tone of a PCCS (Practical Color Co-ordinate System) color system on the basis of the image data input by the image input unit and the text superimposed region set by the text superimposed region setting unit, the font setting unit setting a font including at least a font color; and a superimposed image generation unit that generates data of a superimposed image that is data of an image in which the text data set by the text setting unit is superimposed on the text superimposed region set by the text superimposed region setting unit in the image data input by the image input unit using the font including at least the font color set by the font setting unit.

A program according to another aspect of the present invention causes a computer to execute: a step of inputting image data; a step of setting text data; a step of setting a text superimposed region that is a region on which the set text data is superimposed in the input image data; a step of setting a font color with an unchanged hue and a changed tone with respect to the hue and the tone of a PCCS color system on the basis of the input image data and the set text superimposed region, and setting a font including at least a font color; and a step of generating data of a superimposed image that is data of an image in which the set text data is superimposed on the set text superimposed region in the input image data using the set font including at least the font color.

An image processing method according to another aspect of the present invention includes: a step in which an image processing apparatus inputs image data; a step in which the image processing apparatus sets text data; a step in which the image processing apparatus sets a text superimposed region that is a region on which the set text data is superimposed in the input image data; a step in which the image processing apparatus sets a font color with an unchanged hue and a changed tone with respect to the hue and the tone of a PCCS color system on the basis of the input image data and the set text superimposed region, and sets a font including at least a font color; and a step in which the image processing apparatus generates data of a superimposed image that is data of an image in which the set text data is superimposed on the set text superimposed region in the input image data using the set font including at least the font color.

An imaging apparatus according to another aspect of the present invention includes the image processing apparatus described above.

An image processing apparatus according to another aspect of the present invention includes: an acquisition unit that acquires image data and text data; a region determination unit that determines a text placement region in which the text data is placed in the image data; a color setting unit that sets a predetermined color to text data; and an image generation unit that generates an image in which the text data of the predetermined color is placed in the text placement region, wherein a ratio of a hue value of the text placement region of the image data to a hue value of the text data is closer to one than a ratio of a tone value of the text placement region of the image data to a tone value of the text data.

An image processing apparatus according to another aspect of the present invention includes: a determination unit that determines a placement region in which a character is placed in image data; a color setting unit that sets a predetermined color to a character; and an image generation unit that generates an image in which the character is placed in the placement region, wherein the color setting unit sets the predetermined color such that a ratio of a hue value of the placement region to a hue value of the character is closer to one than a ratio of a tone value of the placement region to a tone value of the character.

### Advantage of the Invention

According to an aspect of the present invention, it is possible to add character information flexibly to a captured image.

In addition, according to an aspect of the present invention, it is possible to realize labeling suitable for an image.

In addition, according to an aspect of the present invention, it is possible to superimpose a text on an image such that the text is easy for a viewer to read.

In addition, according to an aspect of the present invention, it is possible to superimpose a text on an image with an appropriate font color.

### BRIEF DESCRIPTION OF THE DRAWINGS

FIG. 1 is an example of a functional block diagram of an image processing apparatus according to an embodiment of the present invention.

FIG. 2A is an example of a sentence template stored in a storage unit.

FIG. 2B is an example of a sentence template stored in the storage unit.

FIG. 2C is an example of a sentence template stored in the storage unit.

FIG. 2D is an example of a sentence template stored in the storage unit.

FIG. 3A is an example of a word stored in the storage unit.

FIG. 3B is an example of a word stored in the storage unit.

FIG. 4A is an illustration diagram which shows the extraction of a color combination pattern of a captured image.

FIG. 4B is an illustration diagram which shows the extraction of a color combination pattern of a captured image.

FIG. 4C is an illustration diagram which shows the extraction of a color combination pattern of a captured image.

FIG. 4D is an illustration diagram which shows the extraction of a color combination pattern of a captured image.

FIG. 5 is a flowchart which shows an example of the operation of the image processing apparatus.

FIG. 6 is a flowchart which shows an example of the operation of the image processing apparatus.

FIG. 7A is an example of a captured image to which a sentence is added by a sentence addition unit.

FIG. 7B is an example of a captured image to which a sentence is added by the sentence addition unit.

FIG. 7C is an example of a captured image to which a sentence is added by the sentence addition unit.

FIG. 7D is an example of a captured image to which a sentence is added by the sentence addition unit.

FIG. 7E is an example of a captured image to which a sentence is added by the sentence addition unit.

FIG. 8 is an example of a functional block diagram of an imaging apparatus according to another embodiment.

FIG. 9 is a schematic block diagram which shows a configuration of an imaging system according to another embodiment.

FIG. 10 is a block diagram of an image processing unit.

FIG. 11 is a diagram showing an example of image identification information stored in a storage medium and related to image data.

FIG. 12 is a diagram showing an example of a combination of a main color stored in a table storage unit and a first label.

FIG. 13 is a diagram showing an example of a main color of image data.

FIG. 14A is a diagram showing an example of the labeling of the main color extracted in FIG. 13.

FIG. 14B is a diagram showing an example of the labeling of the main color extracted in FIG. 13.

FIG. 15A is an example of image data of a sport.

FIG. 15B is a diagram showing a color vector of image data of the sport in FIG. 15A.

FIG. 16A is an example of image data of a portrait.

FIG. 16B is a diagram showing a color vector of image data of the portrait in FIG. 16A.

FIG. 17A is an example of image data of a scene.

FIG. 17B is a diagram showing a color vector of image data of the scene in FIG. 17A.

FIG. 18 is a diagram showing an example of a first label depending on the combination of main colors for each scene.

FIG. 19 is a diagram showing an example of a first label depending on time, a season, and a color vector.

FIG. 20 is a flowchart of the label generation performed by an imaging apparatus.

FIG. 21 is a block diagram of an image processing unit according to another embodiment.

FIG. 22 is a block diagram of an image processing unit according to another embodiment.

FIG. 23 is a flowchart of the label generation performed by an imaging apparatus.

FIG. 24 is a diagram showing an example in which a plurality of color vectors are extracted from image data according to another embodiment.

FIG. 25 is a block diagram showing a functional configuration of an image processing unit.

FIG. 26A is an image diagram showing an example of an input image.

FIG. 26B is an image diagram showing an example of a global cost image.

FIG. 26C is an image diagram showing an example of a face cost image.

FIG. 26D is an image diagram showing an example of an edge cost image.

FIG. 26E is an image diagram showing an example of a final cost image.

FIG. 26F is an image diagram showing an example of a superimposed image.

FIG. 27 is a flowchart showing a procedure of a superimposing process of a still image.

FIG. 28 is a flowchart showing a procedure of a superimposing process of a moving image.

FIG. 29 is a block diagram showing a functional configuration of an image processing unit according to another embodiment.

FIG. 30 is a flowchart showing a procedure of a superimposing process.

FIG. 31 is a block diagram showing a functional configuration of an image processing unit according to another embodiment.

FIG. 32 is a flowchart showing a procedure of a superimposing process.

FIG. 33 is an image diagram showing a calculation method of the sum of a cost within a text rectangular region.

FIG. 34 is a block diagram showing a functional configuration of an image processing unit according to another embodiment.

FIG. 35 is a diagram showing a relation regarding harmony of contrast with respect to a tone in a PCCS color system.

FIG. 36 is a flowchart showing a procedure of a process performed by an image processing unit.

FIG. 37 is a flowchart showing a procedure of a process performed by a font setting unit.

FIG. 38 is a diagram showing an example of an image of image data.

FIG. 39 is a diagram showing an example of an image of superimposed image data.

FIG. 40 is a diagram showing an example of an image of superimposed image data.

FIG. 41 is a diagram showing an example of a gray scale image of a hue circle of a PCCS color system.

FIG. 42 is a diagram showing an example of a gray scale image of a tone of a PCCS color system.

FIG. 43 is a diagram showing twelve tones of a chromatic color.

FIG. 44 is a diagram showing five tones of an achromatic color.

FIG. 45 is a diagram schematically showing an example of a process that extracts a characteristic attribute of a captured image.

FIG. 46 is a diagram schematically showing another example of a process that extracts a characteristic attribute of a captured image.

FIG. 47 is a flowchart schematically showing a determination method of a smile level.

FIG. 48A is a diagram showing an example of an output image from an image processing apparatus.

FIG. 48B is a diagram showing another example of an output image from the image processing apparatus.

FIG. 49 is a schematic block diagram showing an internal configuration of an image processing unit of an imaging apparatus.

FIG. 50 is a flowchart illustrating a flow of the determination of a representative color.

FIG. 51 is a conceptual diagram showing an example of a process in an image processing unit.

FIG. 52 is a conceptual diagram showing an example of a process in the image processing unit.

FIG. 53 is a conceptual diagram showing a result of the clustering performed with respect to a main region shown in FIG. 52.

FIG. 54 is an example of an image to which a sentence is added by a sentence addition unit.

FIG. 55 is another example of an image to which a sentence is added by the sentence addition unit.

FIG. 56 is a diagram showing an example of a correspondence table between a color and a word.

FIG. 57 is a diagram showing an example of a correspondence table for a distant view image (second scene image).

FIG. 58 is a diagram showing an example of a correspondence table for any other image (third scene image).

### DESCRIPTION OF EMBODIMENTS

### First Embodiment

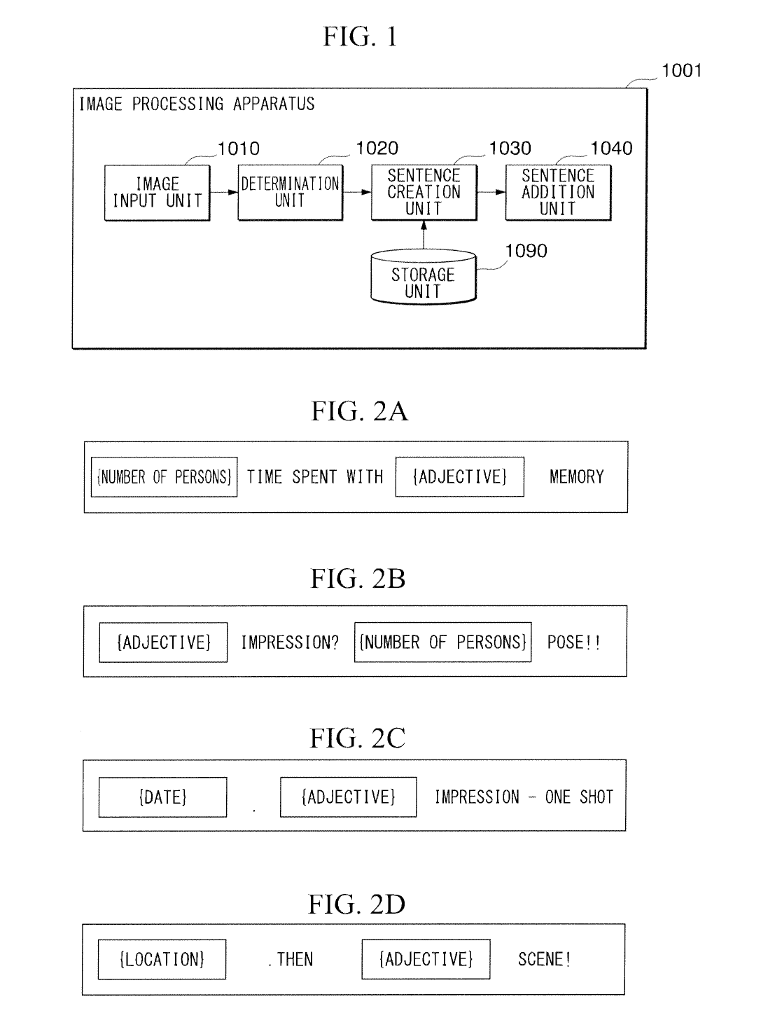

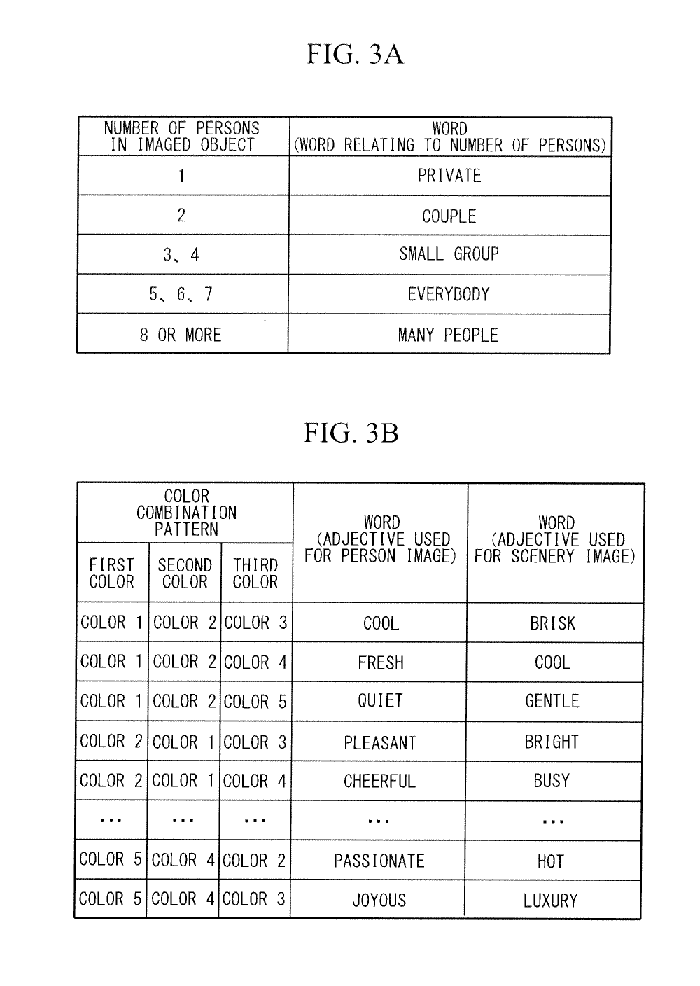

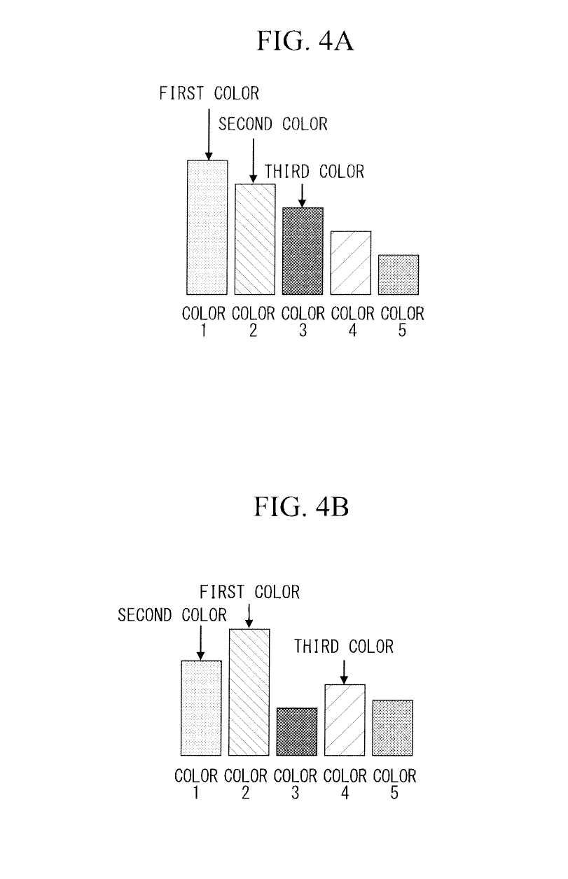

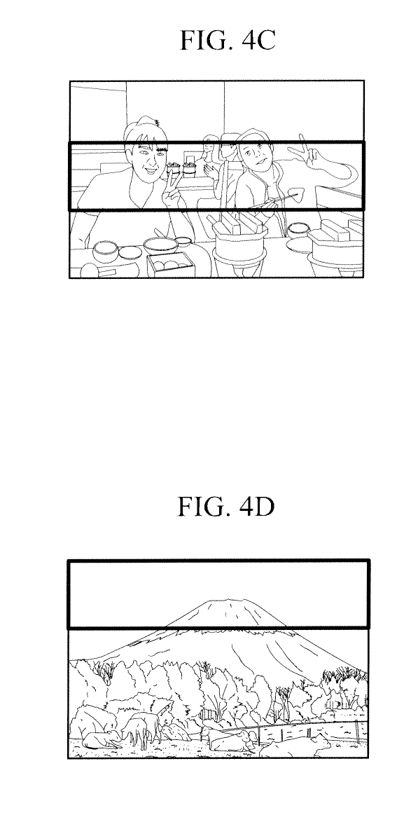

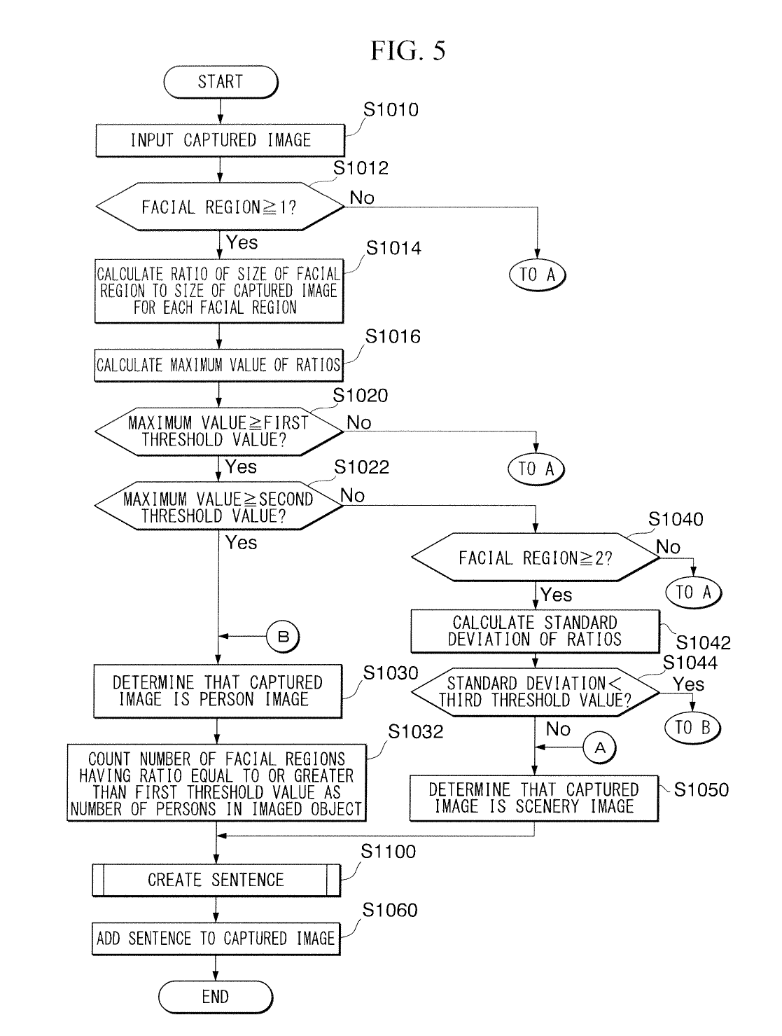

Hereinafter, a first embodiment of the present invention will be described with reference to the accompanying drawings. FIG. 1 is an example of a functional block diagram of an image processing apparatus 1001 according to a first embodiment of the present invention. FIGS. 2A to 2D are examples of a sentence template stored in a storage unit 1090. FIGS. 3A and 3B are examples of a word stored in the storage unit 1090. FIGS. 4A to 4D are illustration diagrams which show the extraction of a color combination pattern of a captured image.

The image processing apparatus 1001 includes, as is shown in FIG. 1, an image input unit 1010, a determination unit 1020, a sentence creation unit 1030, a sentence addition unit 1040, and a storage unit 1090. The image input unit 1010 inputs a captured image, for example, via a network or a storage medium. The image input unit 1010 outputs the captured image to the determination unit 1020.

The storage unit 1090 stores a sentence template in which a word is inserted into a predetermined blank portion and a sentence is completed. Specifically, the storage unit 1090 stores, as the sentence template, a person image template that is used to create a sentence for an image in which a person is an imaged object (hereinafter, referred to as a person image), and a scenery image template that is used to create a sentence for an image in which a scene (also referred to as a second category) is an imaged object (hereinafter, referred to as a scenery image). Note that an example of the person image is a portrait (also referred to as a first category).

For example, the storage unit 1090 stores two types of person image templates as is shown in FIGS. 2A and 2B. Note that the person image templates shown in FIGS. 2A and 2B include a blank portion in which a word according to the number of persons in the imaged object is inserted (hereinafter, referred to as “{number of persons} which is a blank portion”), and a blank portion in which a word according to a color combination pattern of the captured image is inserted (referred to as “{adjective} which is a blank portion”).

In addition, for example, the storage unit 1090 stores two types of scenery image templates as is shown in FIGS. 2C and 2D. Note that the scenery image template shown in FIG. 2C includes a blank portion in which a word according to an imaging condition of the captured image (date) is inserted (hereinafter, referred to as “{date} which is a blank portion”), and a blank portion in which a word according to a color combination pattern of the captured image is inserted. In addition, the scenery image template shown in FIG. 2D includes a blank portion in which a word according to an imaging condition of the captured image (location) is inserted (referred to as “{location} which is a blank portion”), and a blank portion in which a word according to a color combination pattern of the captured image is inserted.

Note that the person image template described above is a sentence template such as imagined when focusing on the person who is captured as an imaged object, namely a sentence template in which a blank portion is set to a sentence from a viewpoint of the person who is captured as an imaged object. For example, the wording “time spent” in the person image template in FIG. 2A and the wording “pose” in the person image template in FIG. 2B express the viewpoint of the person who is captured. On the other hand, the scenery image template described above is a sentence template such as imagined from the entire captured image, namely a sentence template in which a blank portion is set to a sentence from a viewpoint of the image capture person who captures an imaged object. For example, the wording “one shot” in the scenery image template in FIG. 2C and the wording “scene” in the scenery image template in FIG. 2D express the viewpoint of the image capture person.

Moreover, the storage unit 1090 stores a word which is inserted in each blank portion in the sentence template, in addition to the sentence template (person image template, scenery image template). For example, as is shown in FIG. 3A, the storage unit 1090 stores a word regarding a number of persons as the word inserted in {number of persons} which is a blank portion, while connecting the word to the number of persons in the imaged object of the captured image.

For example, when the number of persons in the imaged object is “one” in the case that the person image template is used, the word “private” is inserted in {number of persons} which is a blank portion of the person image template. Note that the sentence creation unit 1030 reads out the sentence template which is used from the storage unit 1090, and insert the word in the blank portion (described below).

Moreover, as is shown in FIG. 3B, the storage unit 1090 stores an adjective for the person image and an adjective for the scenery image as a word inserted in {adjective} which is a blank portion for the person image template or {adjective} which is a blank portion for the scenery image template, while connecting the adjectives to the color combination pattern of the captured image.

For example, when the color combination pattern of the entire region of the captured image is a first color: “color 1”, second color: “color 2”, and third color: “color 3”, as is shown in FIG. 4A, in the case that the person image template is used, the word “cool” is inserted in {adjective} which is a blank portion of the person image template. In addition, when the color combination pattern of the entire region of the captured image is a first color: “color 2”, second color: “color 1”, and third color: “color 4”, as is shown in FIG. 4B, in the case that the scenery image template is used, the word “busy” is inserted in (adjective) which is a blank portion of the scenery image template.

The color 1 to color 5 described above denotes five colors (five representative colors) into which individual colors actually presented in the captured image are categorized, for example, based on the criteria such as a warm color family/a cool color family. In other words, five colors into which the pixel value of each pixel of the captured image is categorized, for example, based on the criteria such as the warm color family/the cool color family are the above described color 1 to color 5.

In addition, the first color is the most frequently presented color in this captured image of color 1 to color 5, the second color is the second most frequently presented color in this captured image of color 1 to color 5, and the third color is the third most frequently presented color in this captured image of color 1 to color 5, the first to third color constituting the color combination pattern. In other words, the color of which the number of the categorized pixel values is the highest is the first color when the pixel value is categorized into color 1 to color 5, the color of which the number of the categorized pixel values is the second highest is the second color when the pixel value is categorized into color 1 to color 5, and the color of which the number of the categorized pixel values is the third highest is the third color when the pixel value is categorized into color 1 to color 5.

Note that the sentence creation unit 1030 extracts the color combination pattern from the captured image.

Note that a color combination pattern in a partial region of the captured image may be used, as an alternative to the color combination pattern of the entire region of the captured image. Namely, the sentence creation unit 1030 may insert an adjective according to the color combination pattern of the partial region of the captured image into the blank portion. Specifically, the sentence creation unit 1030 may determine a predetermined region of the captured image depending on whether the captured image is the person image or the captured image is the scenery image, and may insert the adjective according to the color combination pattern of the predetermined region which is determined of the captured image into the blank portion.

For example, when the captured image is the person image as is shown in FIG. 4C, the sentence creation unit 1030 may determine the central region of the person image as the predetermined region, may extract the color combination pattern of the central region, and may insert an adjective according to the extracted color combination pattern into the blank portion. On the other hand, when the captured image is the scenery image as is shown in FIG. 4D, the sentence creation unit 1030 may determine the upper region of the scenery image as the predetermined region, may extract the color combination pattern of the above-described region, and may insert an adjective according to the extracted color combination pattern into the blank portion.

In addition, although not shown in the drawings, the storage unit 1090 stores a word relating to the date (for example, time, “good morning”, “dusk”, “midsummer!!”, . . . ) as the word inserted into {date} which is a blank portion, while connecting the word to the image capture date. In addition, the storage unit 1090 stores a word relating to the location (for example, “northern district”, “old capital”, “Mt. Fuji”, “The Kaminarimon”, . . . ) as the word inserted into {location} which is a blank portion, while connecting the word to the image capture location.

The determination unit 1020 obtains a captured image from the image input unit 1010. The determination unit 1020 determines whether the obtained captured image is a person image or the obtained captured image is a scenery image. Hereinafter, a detailed description is made as to the determination of the person image/the scenery image by the determination unit 1020. Note that a first threshold value (also referred to as Flow) is a value which is smaller than a second threshold value (also referred to as Fhigh).

The determination unit 1020 makes an attempt to identify a facial region within the captured image.

(In the case of the facial region=0)

The determination unit 1020 determines that this captured image is a scenery image in the case that no facial region is identified within the captured image.

(In the case of the facial region=1)

The determination unit 1020 calculates a ratio R of the size of the facial region to the size of the captured image, according to expression (1) described below, in the case that one facial region is identified within the captured image.

R=Sf/Sp (1).

The Sp in the above-described expression (1) represents the size of the captured image, and specifically, the length in the longitudinal direction of the captured image is used as the Sp. The Sf in the above-described expression (1) represents the size of the facial region, and specifically, the length in the longitudinal direction of a rectangle which is circumscribed to the facial region (or the length of the major axis of an ellipse which surrounds the facial region (long diameter)) is used as the Sf.

The determination unit 1020, which has calculated the ratio R, compares the ratio R with the first threshold value Flow. The determination unit 1020 determines that this captured image is a scenery image in the case that the ratio R is determined to be less than the first threshold value Flow. On the other hand, the determination unit 1020 compares the ratio R with the second threshold value Fhigh in the case that the ratio R is determined to be the first threshold value Flow or more.

The determination unit 1020 determines that this captured image is a person image in the case that the ratio R is determined to be the second threshold value Fhigh or more. On the other hand, the determination unit 1020 determines that this captured image is a scenery image in the case that the ratio R is determined to be less than the second threshold value Fhigh.

(In the case of the facial region≧2)

The determination unit 1020 calculates a ratio R(i) of the size of each facial region to the size of the captured image, according to expression (2) described below, in the case that a plurality of facial regions are identified within the captured image.

R(i)=Sf(i)/Sp (2).

The Sp in the above-described expression (2) is the same as that in the above-described expression (1). The Sf(i) in the above-described expression (2) represents the size of the i-th facial region, and specifically, the length in the longitudinal direction of a rectangle which is circumscribed to the i-th facial region (or the length of the major axis of an ellipse which surrounds the facial region (long diameter)) is used as the Sf(i).

The determination unit 1020, which has calculated R(i), calculates the maximum value of R(i) (Rmax). Namely, the determination unit 1020 calculates a ratio Rmax of the size of the largest facial region to the size of the captured image.

The determination unit 1020, which has calculated the ratio Rmax, compares the ratio Rmax with the first threshold value Flow. The determination unit 1020 determines that this captured image is a scenery image in the case that the ratio Rmax is determined to be less than the first threshold value Flow. The determination unit 1020 compares the ratio Rmax with the second threshold value Fhigh in the case that the ratio Rmax is determined to be the first threshold value Flow or more.

The determination unit 1020 determines that this captured image is a person image in the case that the ratio Rmax is determined to be the second threshold value Fhigh or more. On the other hand, the determination unit 1020 calculates a standard deviation a of the R(i) in the case that the ratio Rmax is determined to be less than the second threshold value Fhigh. Expression (3) described below is a calculation formula of the standard deviation a.

$$\begin{matrix}[ Equation 1 ] & \\ σ = \sqrt{\frac{1}{n} {\sum }_{i = 1}^{n} {( R ( i ) )}^{2} - {( \frac{1}{n} {\sum }_{i = 1}^{n} ( R ( i ) ) )}^{2}} & ( 3 )\end{matrix}$$

The determination unit 1020, which has calculated the standard deviation σ, compares the standard deviation σ with a third threshold value (also referred to as Fstdev). The determination unit 1020 determines that this captured image is a person image in the case that the standard deviation σ is determined to be less than the third threshold value Fstdev. On the other hand, the determination unit 1020 determines that this captured image is a scenery image in the case that the standard deviation σ is determined to be the third threshold value Fstdev or more.

As is described above, in the case that a plurality of facial regions are identified within a captured image, and when the ratio Rmax of the size of the largest facial region to the size of the captured image is the second threshold value Fhigh or more, the determination unit 1020 determines that the captured image is a person image. In addition, when the ratio Rmax is the first threshold value Flow or more, even if the ratio Rmax is less than the second threshold value Fhigh, and when the standard deviation a of the ratio R(i) of the plurality of the facial regions is less than the third threshold value Fstdev, the determination unit 1020 determines that the captured image is a person image.

Note that the determination unit 1020 may perform the determination using a dispersion λ of the ratio R(i) of the plurality of the facial regions and a threshold value for the dispersion λ, as an alternative to the determination on the basis of the standard deviation a of the ratio R(i) of the plurality of the facial regions and the third threshold value Fstdev. In addition, the determination unit 1020 may use a standard deviation (or dispersion) of a plurality of facial regions Sf(i), as an alternative to the standard deviation (or dispersion) of the ratio R(i) of the plurality of the facial regions (in this case, a threshold value for the facial regions Sf(i) is used).

In addition, the determination unit 1020 determines (counts) the number of persons in the imaged object on the basis of the number of the facial regions of which the ratios R(i) are the first threshold value Flow or more, in the case that the captured image is determined to be a person image. In other words, the determination unit 1020 determines each facial region having a ratio R(i) which is the first threshold value Flow or more to be one person of the imaged object, and determines the number of facial regions with a ratio R(i) which is the first threshold value Flow or more to be the number of persons in the imaged object.

The determination unit 1020 outputs a determination result to the sentence creation unit 1030. Specifically, in the case that the captured image is determined to be a person image, the determination unit 1020 outputs image determination-result information indicating a determination result of being a person image, and number-of-persons determination-result information indicating a determination result of the number of persons in the imaged object, to the sentence creation unit 1030. On the other hand, in the case that the captured image is determined to be a scenery image, the determination unit 1020 outputs image determination-result information indicating a determination result of being a scenery image, to the sentence creation unit 1030.

In addition, the determination unit 1020 outputs the captured image obtained from the image input unit 1010, to the sentence creation unit 1030.

The sentence creation unit 1030 obtains the determination result and the captured image from the determination unit 1020. The sentence creation unit 1030 reads out a sentence template which is any one of the person image template and the scenery image template from the storage unit 1090, depending on the obtained determination result. Specifically, the sentence creation unit 1030 reads out one person image template which is randomly selected from two types of person image templates stored in the storage unit 1090, when obtaining image determination-result information indicating a determination result of being a person image. In addition, the sentence creation unit 1030 reads out one person image template which is randomly selected from two types of scenery image templates stored in the storage unit 1090, when obtaining image determination-result information indicating a determination result of being a scenery image.

The sentence creation unit 1030 creates a sentence for a captured image by inserting a word according to a characteristic attribute or an imaging condition of the captured image into a blank portion of the sentence template (person image template or scenery image template) which is read out. The word according to the characteristic attribute is an adjective according to the color combination pattern of the captured image, or a word according to the number of persons in the imaged object (word relating to the number of persons). In addition, the word according to the imaging condition of the captured image is a word according to the image capture date (word relating to the date), or a word according to the image capture location (word relating to the location).

As an example, when the person image template shown in FIG. 2A is read out, the sentence creation unit 1030 obtains the number of persons in the imaged object of this captured image from the number-of-persons determination-result information, reads out a word stored in connection with the number of persons (word relating to the number of persons) from the storage unit 1090 and inserts the word into {number of persons} which is a blank portion, extracts the color combination pattern of this captured image, reads out a word stored in connection with the extracted color combination pattern (adjective for the person image) from the storage unit 1090 and inserts the word into {adjective} which is a blank portion, and creates a sentence for this captured image. Specifically, if the number of persons in the imaged object is “one” and the color combination pattern is a first color: “color 1”, second color: “color 2”, and third color: “color 3”, the sentence creation unit 1030 creates a sentence “private time spent with cool memory”.

As another example, when the person image template shown in FIG. 2B is read out, in the same way as the case of FIG. 2A, the sentence creation unit 1030 reads out a word relating to the number of persons from the storage unit 1090 and inserts the word into {number of persons} which is a blank portion, reads out an adjective for the person image from the storage unit 1090 and inserts the word into {adjective} which is a blank portion, and creates a sentence for this captured image. Specifically, if the number of persons in the imaged object is “ten” and the color combination pattern is a first color: “color 5”, second color: “color 4”, and third color: “color 2”, the sentence creation unit 1030 creates a sentence “passionate impression?many people pose!!”.

As another example, when the scenery image template shown in FIG. 2C is read out, the sentence creation unit 1030 obtains the image capture date from the additional information of this captured image (for example, Exif (Exif; Exchangeable Image File Format)), reads out a word stored in connection with the obtained image capture date (word relating to the date) from the storage unit 1090 and inserts the word into {date} which is a blank portion, extracts the color combination pattern of this captured image, reads out a word stored in connection with the extracted color combination pattern (adjective for the scenery image) from the storage unit 1090 and inserts the word into {adjective} which is a blank portion, and creates a sentence for this captured image.

Specifically, in the case that a word “midsummer!!” is stored in connection with August in the storage unit 1090, if the image capture date is Aug. 10, 2011 and the color combination pattern is a first color: “color 5”, second color: “color 4”, and third color: “color 2”, the sentence creation unit 1030 creates a sentence “midsummer!!, hot impression—one shot”.

As another example, when the scenery image template shown in FIG. 2D is read out, the sentence creation unit 1030 obtains the image capture location from the additional information of this captured image, reads out a word stored in connection with the obtained image capture location (word relating to the location) from the storage unit 1090 and inserts the word into {location} which is a blank portion, extracts the color combination pattern of this captured image, reads out a word stored in connection with the extracted color combination pattern (adjective for the scenery image) from the storage unit 1090 and inserts the word into {adjective} which is a blank portion, and creates a sentence for this captured image.

Specifically, in the case that a word “old capital” is stored in connection with the Kyoto station in the storage unit 1090, if the image capture location is the front of the Kyoto station and the color combination pattern is a first color: “color 1”, second color: “color 2”, and third color: “color 5”, the sentence creation unit 1030 creates a sentence “old capital, then gentle scene!”.

The sentence creation unit 1030, which has created a sentence, outputs the created sentence and the captured image to the sentence addition unit 1040. The sentence addition unit 1040 obtains the sentence and the captured image from the sentence creation unit 1030. The sentence addition unit 1040 adds (superimposes) this sentence to this captured image.

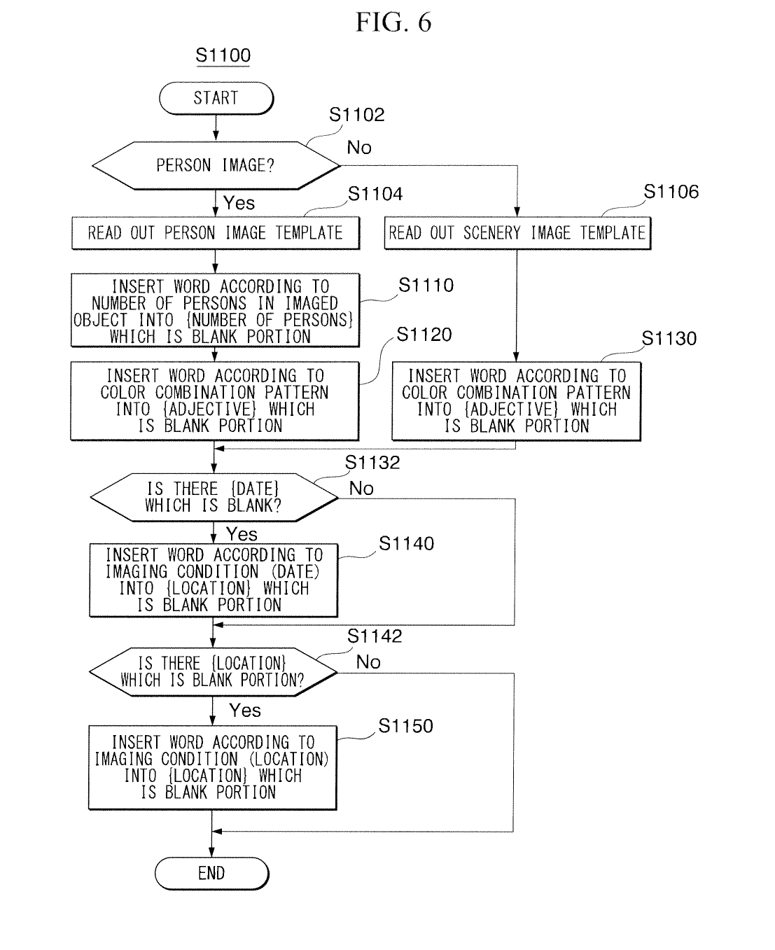

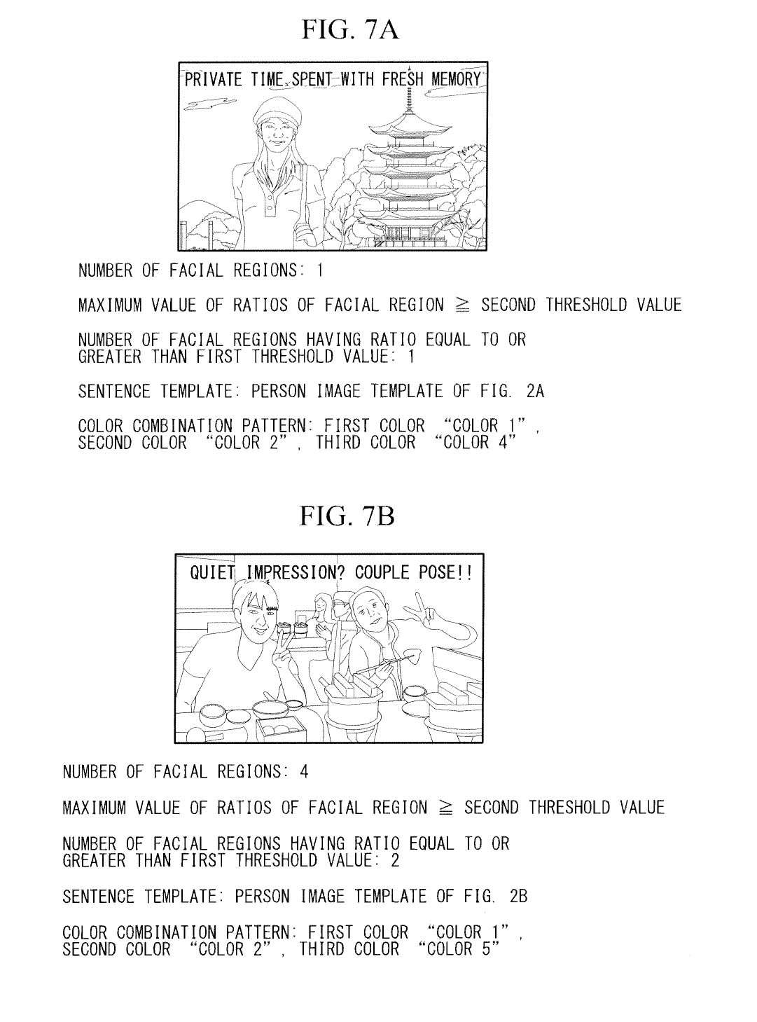

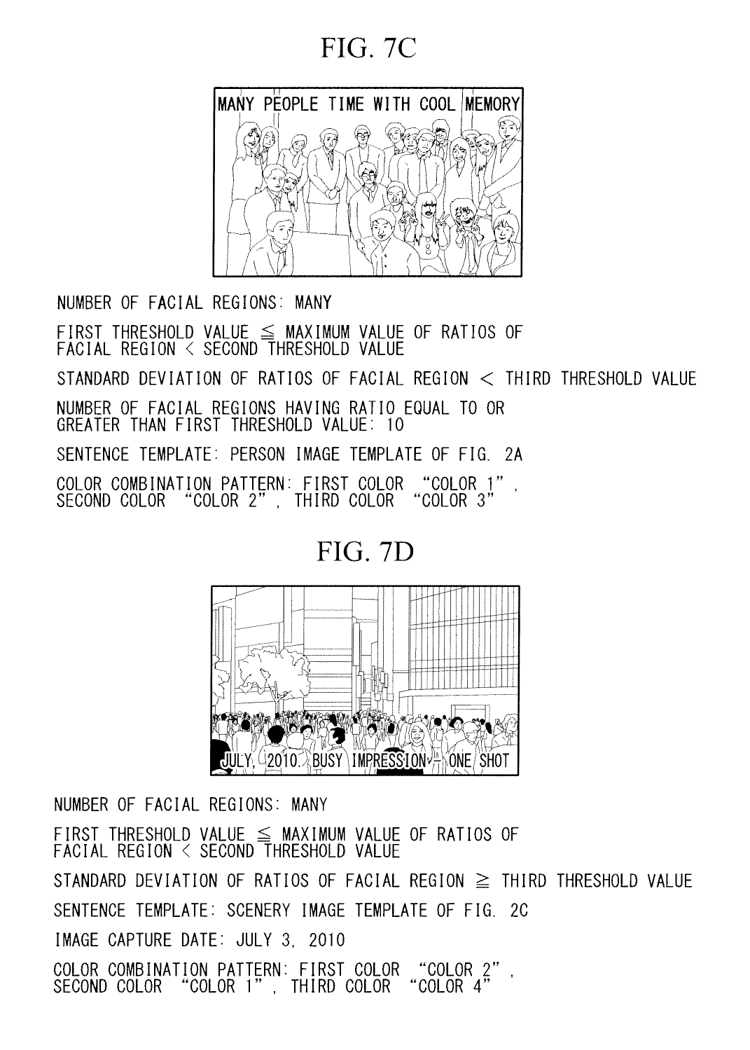

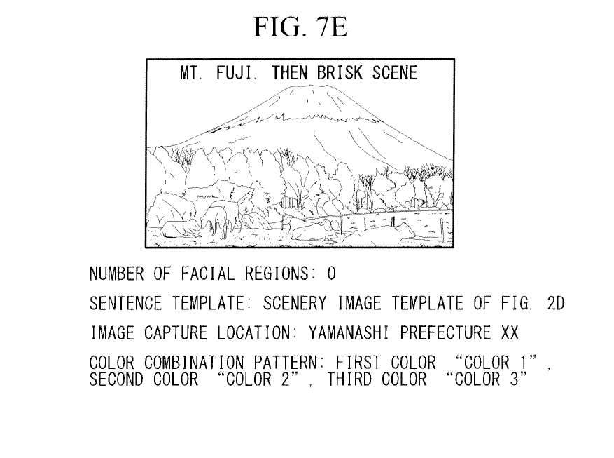

Next, an explanation of an operation of the image processing apparatus 1001 is provided. FIG. 5 and FIG. 6 are flowcharts showing an example of the operation of the image processing apparatus 1001.

In FIG. 5, the image input unit 1010 inputs a captured image (step S1010). The image input unit 1010 outputs the captured image to the determination unit 1020. The determination unit 20 determines whether or not there is one facial region or more within the captured image (step S1012). When a determination is made that there is one facial region or more within the captured image (step S1012: Yes), the determination unit 1020 calculates the ratio of the size of the facial region to the size of the captured image for each facial region (step S1014), and calculates a maximum value of the ratios (step S1016).

Following step S1016, the determination unit 1020 determines whether or not the maximum value calculated in step S1016 is the first threshold value or more (step S1020). When a determination is made that the maximum value calculated in step S1016 is the first threshold value or more (step S1020: Yes), the determination unit 1020 determines whether or not the maximum value is the second threshold value or more (step S1022). When a determination is made that the maximum value is the second threshold value or more (step S1022: Yes), the determination unit 1020 determines that the captured image is a person image (step S1030). Following step S1030, the determination unit 1020 counts the number of facial regions having a ratio which is equal to or greater than the first threshold value as the number of persons in the imaged object (step 1032). Following step S1032, the determination unit 1020 outputs the determination result (image determination-result information indicating a determination result of being a person image, and number-of-persons determination-result information indicating a determination result of the number of persons in the imaged object), and the captured image to the sentence creation unit 1030.

On the other hand, when a determination is made that the maximum value is less than the second threshold value in step S1022 (step S1022: No), the determination unit 1020 determines whether or not there is two facial regions or more within the captured image (step S1040). When a determination is made that there is two facial regions or more within the captured image (step S1040: Yes), the determination unit 1020 calculates a standard deviation of the ratios calculated in step S1014 (step S1042), and determines whether or not the standard deviation is less than the third threshold value (step S1044). When a determination is made that the standard deviation is less than the third threshold value (step S1044: Yes), the determination unit 1020 makes the process proceed to step S1030.

On the other hand, when a determination is made that there is no facial region within the captured image in step S1012 (step S1012: No), a determination is made that the maximum value is less that the first threshold value in step S1020 (step S1020: No), or a determination is made that there is only one facial region within the captured image in step S1040 (step S1040: No), the determination unit 1020 determines that the captured image is a scenery image (step S1050). Following step S1050, the determination unit 1020 outputs the determination result (image determination-result information indicating a determination result of being a scenery image) to the sentence creation unit 1030.

Note that step S1040 described above is a process used to prevent a captured image having one facial region from being always determined to be a person image. In addition, in step S1040 described above, there is a possibility that the captured image is determined to be a person image, if there are an extremely large number of facial regions having a very small and uniform size within the captured image in addition to a facial region having a maximum of a ratio, the ratio being the size of the facial region to the size of the captured image, since the standard deviation becomes small. Therefore, the determination unit 1020 may determine whether or not there are two facial regions or more having a predetermined size such that a determination such as the above-described case is made as little as possible. For example, the determination unit 1020 may determine whether or not there are two facial regions or more having an aforementioned ratio which is the first threshold value or more.

Following step S1032 or step S1050, the sentence creation unit 1030 reads out a sentence template which is any one of the person image template and the scenery image template from the storage unit 1090 depending on a determination result obtained from the determination unit 1020, inserts a word according to the characteristic attribute or the imaging condition of the captured image into the blank portion of the sentence template which is read out, and creates a sentence for the captured image (step S1100).

FIG. 6 shows the detail of step S1100. In FIG. 6, the sentence creation unit 1030 determines whether or not the captured image is a person image (step S1102). Specifically, the sentence creation unit 1030 determines that the captured image is a person image when the sentence creation unit 1030 obtained image determination-result information indicating a determination result of being a person image from the determination unit 1020 as the determination result, and determines that the captured image is not a person image when the sentence creation unit 1030 obtained image determination-result information indicating a determination result of being a scenery image.

When the sentence creation unit 1030 determines that the captured image is a person image (step S1102: Yes), the sentence creation unit 1030 reads out a person image template from the storage unit 1090 (step S1104). Specifically, the sentence creation unit 1030 reads out one person image template which is randomly selected from two types of person image templates stored in the storage unit 1090.

Following step S1104, the sentence creation unit 1030 inserts a word according to the number of persons in the imaged object into (number of persons) which is a blank portion of the person image template (step S1110). Specifically, the sentence creation unit 1030 obtains the number of persons in the imaged object from the number-of-persons determination-result information, reads out a word stored in connection with the number of persons (word relating to the number of persons) from the storage unit 1090, and inserts the word into {number of persons} which is a blank portion of the person image template.

Following step S1110, the sentence creation unit 1030 inserts a word according to the color combination pattern of the captured image (person image) into {adjective} which is a blank portion of the person image template (step S1120). Specifically, the sentence creation unit 1030 extracts the color combination pattern of the central region of the captured image (person image), reads out a word stored in connection with the color combination pattern (adjective for the person image) from the storage unit 1090, and inserts the word into {adjective}which is a blank portion of the person image template.

On the other hand, in step S1102, when the sentence creation unit 1030 determines that the captured image is a scenery image (step S1102: No), the sentence creation unit 1030 reads out a scenery image template from the storage unit 1090 (step S1106). Specifically, the sentence creation unit 1030 reads out one scenery image template which is randomly selected from two types of scenery image templates stored in the storage unit 1090.

Following step S1106, the sentence creation unit 1030 inserts a word according to the color combination pattern of the captured image (scenery image) into {adjective} which is a blank portion of the scenery image template (step S1130). Specifically, the sentence creation unit 1030 extracts the color combination pattern of the upper region of the captured image (scenery image), reads out a word stored in connection with the color combination pattern (adjective for the scenery image) from the storage unit 1090, and inserts the word into {adjective} which is a blank portion of the scenery image template.

Following step S1120 or step S1130, the sentence creation unit 1030 determines whether or not there is {date} which is a blank portion in the sentence template which is read out (step S1132). In the case of the example of the present embodiment, as is shown in FIGS. 2A to 2D, there is {date} which is a blank portion in the scenery image template of FIG. 2C, but there is not {date} which is a blank portion in the person image templates of FIGS. 2A and 2B and the scenery image template of FIG. 2D. Therefore, the sentence creation unit 1030 determines that there is {date} which is a blank portion in the case that the scenery image template of FIG. 2C is read out in step S1106, and determines that there is not {date} which is a blank portion in the case that the person image template of FIG. 2A or FIG. 2B is read out in step S1104 or in the case that the scenery image template of FIG. 2D is read out in step S1106.

When a determination is made that there is {date} which is a blank portion in the sentence template which is read out (step S1132: Yes), the sentence creation unit 1030 inserts a word according to the imaging condition (date) of the captured image into {date} which is a blank portion of the sentence template (step S1140). Specifically, the sentence creation unit 1030 obtains a image capture date from the additional information of the captured image (scenery image), reads out a word stored in connection with the image capture date (word relating to the date) from the storage unit 1090 and inserts the word into {date} which is a blank portion of the scenery image template. On the other hand, when a determination is made that there is not {date} which is a blank portion in the sentence template which is read out (step S1132: No), the sentence creation unit 1030 makes the process skip step S1140 and proceed to step S1142.

Following step S1132 (No) or step S1140, the sentence creation unit 1030 determines whether or not there is {location} which is a blank portion in the sentence template which is read out (step S1142). In the case of the example of the present embodiment, as is shown in FIGS. 2A to 2D, there is (location) which is a blank portion in the scenery image template of FIG. 2D, but there is not {location} which is a blank portion in the person image templates of FIGS. 2A and 2B and the scenery image template of FIG. 2C. Therefore, the sentence creation unit 1030 determines that there is {location} which is a blank portion in the case that the scenery image template of FIG. 2D is read out in step S1106, and determines that there is not {location} which is a blank portion in the case that the person image template of FIG. 2A or FIG. 2B is read out in step S1104 or in the case that the scenery image template of FIG. 2C is read out in step S1106.

When a determination is made that there is (location) which is a blank portion in the sentence template which is read out (step S1142: Yes), the sentence creation unit 1030 inserts a word according to the imaging condition (location) of the captured image into {location}which is a blank portion of the sentence template (step S1150). Specifically, the sentence creation unit 1030 obtains a image capture location from the additional information of the captured image (scenery image), reads out a word stored in connection with the image capture location (word relating to the location) from the storage unit 1090 and inserts the word into {location} which is a blank portion of the scenery image template. Then, the routine finishes the flowchart shown in FIG. 6 and returns to the flowchart shown in FIG. 5. On the other hand, when a determination is made that there is not {location} which is a blank portion in the sentence template which is read out (step S1142: No), the sentence creation unit 1030 makes the process skip step S1150 and return to the flowchart shown in FIG. 5.

In FIG. 5, the sentence creation unit 1030, which has created the sentence, outputs the created sentence and the captured image to the sentence addition unit 1040. The sentence addition unit 1040 obtains the sentence and the captured image from the sentence creation unit 1030. The sentence addition unit 1040 adds (superimposes) the sentence obtained from the sentence creation unit 1030 to the captured image obtained from the sentence creation unit 1030. Then, the routine finishes the flowchart shown in FIG. 5.

FIGS. 7A to 7E shows an example of a captured image to which a sentence is added by the sentence addition unit 1040. The captured image of FIG. 7A is determined to be a person image since a face of one person is widely imaged. In other words, a determination that the maximum value of the ratio of the size of the facial region to the size of the captured image (the ratio of this one facial region) is the second threshold value or more is made to this captured image (step S1022 (Yes)). The captured image of FIG. 7B is determined to be a person image since faces of two persons are widely imaged. In other words, a determination that the maximum value of the ratio of the size of the facial region to the size of the captured image is the second threshold value or more is made to this captured image (step S1022 (Yes)).

The captured image of FIG. 7C is determined to be a person image, since faces having a moderate size are imaged and the faces are uniformly sized. In other words, a determination that the maximum value of the ratio of the size of the facial region to the size of the captured image is the first threshold value or more and less than the second threshold value (step S1022 (No)), but the standard deviation is less than the third threshold value, is made to this captured image (step S1044 (Yes)).

The captured image of FIG. 7D is determined to be a scenery image, since faces having a moderate size are imaged but the faces are not uniformly sized. In other words, a determination that the maximum value of the ratio of the size of the facial region to the size of the captured image is the first threshold value or more and less than the second threshold value (step S1022 (No)), but the standard deviation is the third threshold value or more, is made to this captured image (step S1044 (No)). The captured image of FIG. 7E is determined to be a scenery image since no face is imaged (step S1012 (No)).

As described above, according to the image processing apparatus 1001, it is possible to add character information more flexibly to a captured image. In other words, the image processing apparatus 1001 categorizes a captured image as a person image or a scenery image, creates a sentence for the person image by using a prestored person image template for the person image, creates a sentence for the scenery image by using a prestored scenery image template for the scenery image, and thereby can add character information more flexibly depending on the content of the captured image.

Note that, the above-identified embodiment is described using an example in which at the time of input of a captured image, the image input unit 1010 outputs the captured image to the determination unit 1020, but that the aspect of the invention in which the determination unit 1020 obtains a captured image is not limited thereto. For example, the image input unit 1010 may store, at the time of input of a captured image, the captured image in the storage unit 1090, and the determination unit 1020 may read out and obtain an intended captured image from the storage unit 1090 as needed.

Note that, the above-identified embodiment is described using an example which uses five colors of color 1 to color 5 as the number of colors of the first color constituting the color combination pattern. However, the example is for convenience of explanation, and six colors or more may be used. This is similar for the second color and the third color. In addition, in the above-described embodiment, an explanation is made as an example which uses the color combination pattern constituted by three colors of the first color to the third color; however, the number of colors constituting the color combination pattern is not limited thereto. For example, a color combination pattern consisting of two colors, or four colors or more, may be used.

Note that, the above-identified embodiment is described using an example in which, when the captured image is a person image, the sentence creation unit 1030 reads out one person image template which is randomly selected from two types of person image templates stored in the storage unit 1090; however, the aspect of the invention that selects one which is read out from two types of person image templates is not limited thereto. For example, the sentence creation unit 1030 may select one person image template which is designated by a user via an operation unit (not shown in the drawings). Similarly, the sentence creation unit 1030 may select one scenery image template which is designated by a user via a designation reception unit.

In addition, the above-identified embodiment is described using an example in which a word that should be inserted into the blank portion of the selected template can be always obtained from the storage unit 1090; however, when a word that should be inserted into the blank portion of the selected template cannot be obtained from the storage unit 1090, another template may be re-selected. For example, when the scenery image template of FIG. 2D which includes (location) which is a blank portion is selected for creation of a sentence for a certain captured image but the image capture location cannot be obtained from the additional information of this captured image, the scenery image template of FIG. 2C which does not have {location} which is a blank portion may be re-selected.

In addition, the above-identified embodiment is described using an example in which the image processing apparatus 1001 stores the person image template which has {number of persons} which is a blank portion and {adjective} which is a blank portion in the storage unit 1090, however, the number of the blank portion and the type of the blank portion, which the person image template has, are not limited thereto. For example, the person image template may have any one of or both of {date} which is a blank portion and {location} which is a blank portion, in addition to {number of persons} which is a blank portion and {adjective} which is a blank portion. In addition, in the case that the image processing apparatus 1001 includes a variety of sensors, the person image template may have a blank portion in which a word according to a imaging condition (illumination intensity) of the captured image is inserted {{illumination intensity} which is a blank portion), a blank portion in which a word according to a imaging condition (temperature) of the captured image is inserted {{temperature} which is a blank portion), and the like.

In addition, the person image template may not necessarily have {number of persons} which is a blank portion. An example of a case where the person image template does not have {number of persons} which is a blank portion is a case where a sentence including the word according to the number of persons in the imaged object is not created for a person image. In the case that a sentence including the word according to the number of persons in the imaged object is not created for a person image, it is obviously not necessary for the image processing apparatus 1001 to store a person image template which has {number of persons} which is a blank portion in the storage unit 1090.

Another example of a case where the person image template does not have {number of persons} which is a blank portion is a case where a plurality of person image templates according to the number of persons in the imaged object are stored in the storage unit 1090. In the case that a plurality of person image templates according to the number of persons in the imaged object are stored in the storage unit 1090, the image processing apparatus 1001 does not create a sentence including the word according to the number of persons in the imaged object for a person image by inserting the word according to the number of persons in the imaged object into {number of persons} which is a blank portion, but creates a sentence including the word according to the number of persons in the imaged object by reading out a person image template according to the number of persons in the imaged object from the storage unit 1090.

In addition, the above-identified embodiment is described using an example in which the image processing apparatus 1001 stores the scenery image template which has {date} which is a blank portion and {adjective} which is a blank portion, and the scenery image template which has {location} which is a blank portion and {adjective} which is a blank portion in the storage unit 1090, however, the number of the blank portion and the type of the blank portion, which the scenery image template has, are not limited thereto. For example, in the case that the image processing apparatus 1001 includes a variety of sensors, the scenery image template may have {illumination intensity} which is a blank portion described above, {temperature} which is a blank portion described above, and the like.

In addition, the above-identified embodiment is described using an example in which the image processing apparatus 1001 stores two types of person image templates in the storage unit 1090, however, the image processing apparatus 1001 may store one type of person image template or three types or more of person image templates in the storage unit 1090. Similarly, the image processing apparatus 1001 may store one type of scenery image template or three types or more of scenery image templates in the storage unit 1090.

In addition, the above-identified embodiment is described using an example in which the image processing apparatus 1001 adds, when a sentence for a captured image is created, the sentence to this captured image; however, the image processing apparatus 1001 may store, when a sentence for a captured image is created, the sentence in the storage unit 1090 while connecting the sentence to this captured image.

In addition, the storage unit 1090 may store a first syntax which is a syntax of a sentence used for an image of a first category (for example, portrait) and a second syntax which is a syntax of a sentence used for an image of a second category (for example, scene).

In the case that the first syntax and the second syntax are stored in the storage unit 1090, the sentence creation unit 1030 may create a sentence of the first syntax using a predetermined text when the determination unit 1020 determines that the captured image is an image of the first category (namely, when the determination unit 1020 determines that the captured image is a person image), and may create a sentence of the second syntax using a predetermined text when the determination unit 1020 determines that the captured image is an image of the second category (namely, when the determination unit 1020 determines that the captured image is a scenery image).

In addition, the image processing apparatus 1001 may include a decision unit (not shown in the drawings) that determines a text corresponding to at least any one of the characteristic attribute of the captured image and the imaging condition of the captured image (a text according to the characteristic attribute of the captured image and/or the imaging condition of the captured image). For example, when the image input unit 1010 inputs (obtains) a captured image, the decision unit determines a text according to the characteristic attribute of the captured image and/or the imaging condition of the captured image, as the predetermined text used to create a document. More specifically, for example, the storage unit 1090 preliminarily stores a plurality of texts while connecting the texts to the characteristic attribute and the imaging condition, and the decision unit selects a text according to the characteristic attribute and/or the imaging condition from the plurality of texts in the storage unit 1090.

In other words, the sentence creation unit 1030 creates a sentence of the first syntax using the text determined by the decision unit as described above when the determination unit 1020 determines that the captured image is an image of the first category, and creates a sentence of the second syntax using the text determined by the decision unit as described above when the determination unit 1020 determines that the captured image is an image of the second category.

### Second Embodiment

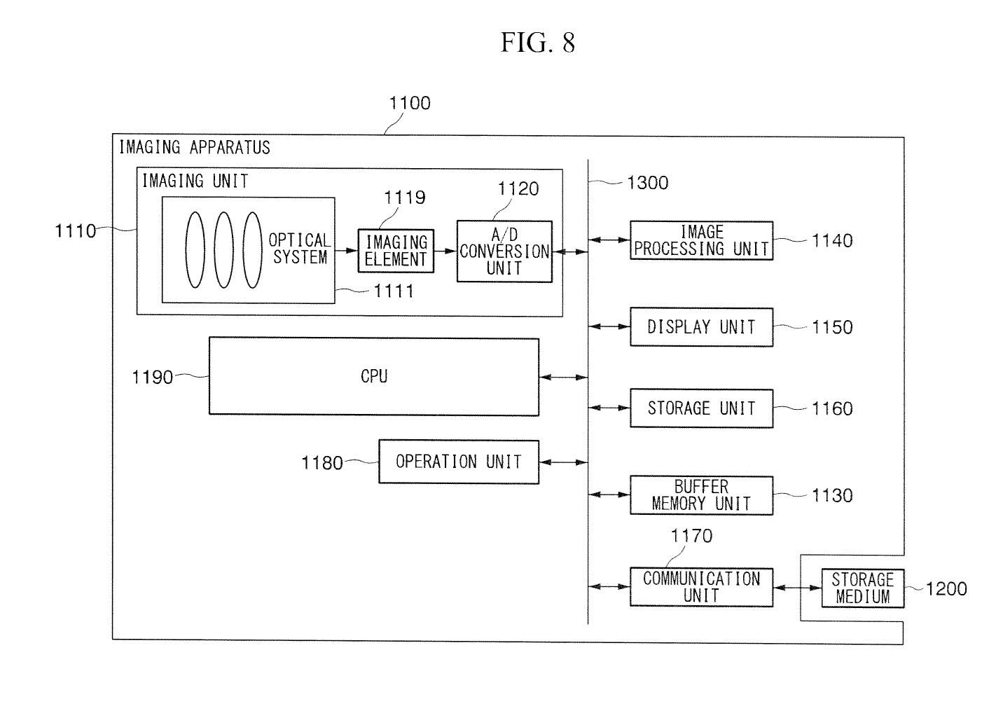

Hereinafter, a second embodiment of the present invention will be described with reference to the accompanying drawings. FIG. 8 is an example of a functional block diagram of an imaging apparatus 1100 according to the second embodiment of the present invention.

The imaging apparatus 1100 according to the present embodiment includes, as is shown in FIG. 8, an imaging unit 1110, a buffer memory unit 1130, an image processing unit (image processing apparatus) 1140, a display unit 1150, a storage unit 1160, a communication unit 1170, an operation unit 1180, a CPU (Central processing unit) 1190, and a bus 1300.

The imaging unit 1110 includes an optical system 1111, an imaging element 1119, and an A/D (Analog to Digital) conversion unit 1120. The optical system 1111 includes one lens, or two or more lenses.

The imaging element 1119, for example, converts an optical image formed on a light receiving surface into an electric signal and outputs the electric signal to the A/D conversion unit 1120.

In addition, the imaging element 1119 outputs image data (electric signal), which is obtained when a still-image capture command is accepted via the operation unit 1180, to the A/D conversion unit 1120 as captured image data (electric signal) of a captured still image. Alternatively, the imaging element 1119 stores the image data in a storage medium 1200 via the A/D conversion unit 1120 and the image processing unit 1140.

In addition, the imaging element 1119 outputs image data (electric signal) of a moving image which is continuously captured with a predetermined interval, the image data being obtained when a moving-image capture command is accepted via the operation unit 1180, to the A/D conversion unit 1120 as captured image data (electric signal) of a captured moving image. Alternatively, the imaging element 1119 stores the image data in the storage medium 1200 via the A/D conversion unit 1120 and the image processing unit 1140.

In addition, the imaging element 1119 outputs image data (electric signal), which is continuously obtained, for example, in a state where no capture command is accepted via the operation unit 1180, to the A/D conversion unit 1120 as through image data (captured image) (electric signal). Alternatively, the imaging element 1119 outputs the image data continuously to the display unit 1150 via the A/D conversion unit 1120 and the image processing unit 1140.

Note that, the optical system 1111 may be attached to and integrated with the imaging apparatus 1100, or may be detachably attached to the imaging apparatus 1100.

The A/D conversion unit 1120 applies an analog/digital conversion to the electric/electronic signal (analog signal) of the image converted by the imaging element 1119, and outputs captured image data (captured image) as a digital signal obtained by this conversion.

The imaging unit 1110 is controlled by the CPU 1190 on the basis of the content of the command accepted from a user via the operation unit 1180 or the set imaging condition, forms an optical image via the optical system 1111 on the imaging element 1119, and generates a captured image on the basis of this optical image converted into the digital signal by the A/D conversion unit 1120.

Note that, the imaging condition is a condition which defines the condition at the time of image capture, for example, such as an aperture value or an exposure value.

The imaging condition, for example, can be stored in the storage unit 1160 and referred to by the CPU 1190.

The image data output from the A/D conversion unit 1120 is input to one or more of, for example, the image processing unit 1140, the display unit 1150, the buffer memory unit 1130, and the storage medium 1200 (via the communication unit 1170), on the basis of a set image processing flow condition.

Note that, the condition of the flow (steps) used to process image data, for example, such as a flow in which the image data that is output from the A/D conversion unit 1120 is output via the image processing unit 1140 to the storage medium 1200, is defined as the image processing flow condition. The image processing flow condition, for example, can be stored in the storage unit 1160 and referred to by the CPU 1190.

Specifically, in the case that the imaging element 1119 outputs an electric signal of the image, which is obtained when a still-image capture command is accepted via the operation unit 1180, to the A/D conversion unit 1120 as an electric signal of the captured still image, a flow which causes the image data of the still image that is output from the A/D conversion unit 1120 to pass through the image processing unit 1140 and to be stored in the storage medium 1200, or the like, is performed.

In addition, in the case that the imaging element 1119 outputs an electric signal of the moving image, which is obtained when a moving-image capture command is accepted via the operation unit 1180 and which is continuously captured with a predetermined interval, to the A/D conversion unit 1120 as an electric signal of the captured moving image, a flow which causes the image data of the moving image that is output from the A/D conversion unit 1120 to pass through the image processing unit 1140 and to be stored in the storage medium 1200, or the like, is performed.

In addition, in the case that the imaging element 1119 outputs an electric signal of the image, which is continuously obtained in a state where no capture command is accepted via the operation unit 1180, to the A/D conversion unit 1120 as an electric signal of the through image, a flow which causes the image data of the through image that is output from the A/D conversion unit 1120 to pass through the image processing unit 1140 and to be continuously output to the display unit 1150, or the like, is performed.

Note that, as the configuration which causes the image data that is output from the A/D conversion unit 1120 to pass through the image processing unit 1140, for example, a configuration in which the image data that is output from the A/D conversion unit 1120 is input directly to the image processing unit 1140 may be used, or a configuration in which the image data that is output from the A/D conversion unit 1120 is stored in the buffer memory unit 1130 and this image data that is stored in the buffer memory unit 1130 is input to the image processing unit 1140 may be used.

The image processing unit 1140 applies an image processing to the image data, which is stored in the buffer memory unit 1130, on the basis of the image processing condition which is stored in the storage unit 1160. The detail of the image processing unit 1140 will be described later. Note that, the image data which is stored in the buffer memory unit 1130 is the image data which is input to the image processing unit 1140, for example, is the above-described captured image data, through image data, or the captured image data which is read out from the storage medium 1200.

The image processing unit 1140 applies a predetermined image processing to the image data which is input.

The image data which is input to the image processing unit 1140 is, as an example, the image data which is output from the A/D conversion unit 1120. As another example, the image data which is stored in the buffer memory unit 1130 can be read out so as to be input to the image processing unit 1140, or as an alternative example, the image data which is stored in the storage medium 1200 can be read out via the communication unit 1170 so as to be input to the image processing unit 1140.

The operation unit 1180 includes, for example, a power switch, a shutter button, a cross key, an enter button, and other operation keys. The operation unit 1180 is operated by a user and thereby accepts an operation input from the user, and outputs the operation input to the CPU 1190.

The display unit 1150 is, for example, a liquid crystal display, or the like, and displays image data, an operation screen, or the like. For example, the display unit 1150 displays a captured image to which a sentence is added by the image processing unit 1140.

In addition, for example, the display unit 1150 can input and display the image data to which a predetermined image processing is applied by the image processing unit 1140. In addition, the display unit 1150 can input and display the image data which is output from the A/D conversion unit 1120, the image data which is read out from the buffer memory unit 1130, or the image data which is read out from the storage medium 1200.

The storage unit 1160 stores a variety of information.

The buffer memory unit 1130 temporally stores the image data which is captured by the imaging unit 1110.

In addition, the buffer memory unit 1130 temporally stores the image data which is read out from the storage medium 1200.

The communication unit 1170 is connected to the storage medium 1200 from which a card memory or the like can be removed, and performs writing of captured image data on this storage medium 1200 (a process to cause the data to be stored), reading-out of image data from this storage medium 1200, or erasing of image data that is stored in this storage medium 1200.

The storage medium 1200 is a storage unit that is detachably connected to the imaging apparatus 1100. For example, the storage medium 1200 stores the image data which is generated by the imaging unit 1110 (captured/photographed image data).

The CPU 1190 controls each constituting unit which is included in the imaging apparatus 1100. The bus 1300 is connected to the imaging unit 1110, the CPU 1190, the operation unit 1180, the image processing unit 1140, the display unit 1150, the storage unit 1160, the buffer memory unit 1130, and the communication unit 1170. The bus 1300 transfers the image data which is output from each unit, the control signal which is output from each unit, or the like.

Note that, the image processing unit 1140 of the imaging apparatus 1100 corresponds to the determination unit 1020, the sentence creation unit 1030, and the sentence addition unit 1040 of the image processing apparatus 1001 according to the first embodiment.

In addition, the storage unit 1160 of the imaging apparatus 1100 corresponds to the storage unit 1090 of the image processing apparatus 1001 according to the first embodiment.

For example, the image processing unit 1140 performs the process of the determination unit 1020, the sentence creation unit 1030, and the sentence addition unit 1040 of the image processing apparatus 1001 according to the first embodiment.

In addition, specifically, the storage unit 1160 stores at least information which is stored by the storage unit 1090 of the image processing apparatus 1001 according to the first embodiment.

In addition, a variety of above-described processes according to each process of the above-identified image processing apparatus 1001 may be implemented by recording a program for performing each process of the image processing apparatus 1001 according to the first embodiment described above into a computer readable recording medium, causing the program recorded in this recording medium to be read by a computer system, and executing the program. Note that, the “computer system” includes hardware such as an OS (Operating System) and a peripheral device. Furthermore, when the computer system is available to connect to networks such as the internet (WWW system), the “computer system” may include a home page providing circumstance (or a home page displaying circumstance). Further, the “computer readable recording medium” may include a flexible disc, an optical magnetic disc, a ROM (Read Only Memory), a recordable non-volatile memory such as a flash memory, a movable medium such as a CD (Compact Disc)-ROM, a USB memory that is connected via a USB (Universal Serial Bus) I/F (interface), and a storage device such as a hard disk drive built in the computer system.

Furthermore, the “computer readable recording medium” may include a medium which stores a program for a certain period of time, such as a volatile memory (for example, a DRAM (Dynamic Random Access Memory)) included in the computer system which becomes a server PC or a client PC when a program is transmitted via networks such as the Internet or telecommunication lines such as telephone lines. In addition, the program described above may be transmitted from the computer system which stores this program in the storage device or the like to other computer systems via a transmission medium or by transmitted waves in a transmission medium. The “transmission medium” via which a program is transmitted is a medium having a function to transmit information, such as networks (communication network) like the Internet or telecommunication lines (communication wire) like telephone lines. In addition, the program described above may be used to achieve part of the above-described functions or a particular part. Moreover, the program may be a program which can perform the above-described functions by combining the program with other programs which are already recorded in the computer system, namely, a so-called differential file (differential program).

### Third Embodiment

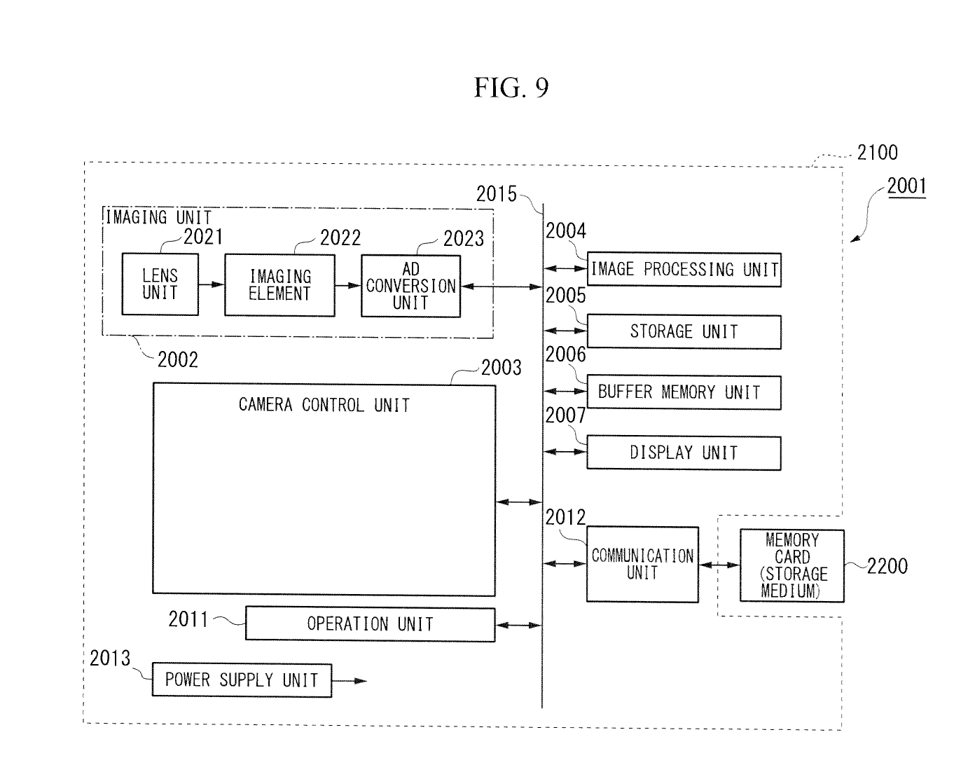

FIG. 9 is a schematic block diagram which shows a configuration of an imaging system 2001 according to the present embodiment.

An imaging apparatus 2100 shown in FIG. 9 includes an imaging unit 2002, a camera control unit 2003, an image processing unit 2004, a storage unit 2005, a buffer memory unit 2006, a display unit 2007, an operation unit 2011, a communication unit 2012, a power supply unit 2013, and a bus 2015.

The imaging unit 2002 includes a lens unit 2021, an imaging element 2022, and an AD conversion unit 2023. The imaging unit 2002 captures an imaged object and generates image data. This imaging unit 2002 is controlled by the camera control unit 2003 on the basis of the imaging condition (for example, aperture value, exposure value, or the like) which is set, and forms an optical image of the imaged object which is input via the lens unit 2021 on an image capture surface of the imaging element 2022. In addition, the imaging unit 2002 converts an analog signal which is output from the imaging element 2022 into a digital signal in the AD conversion unit 2023 and generates the image data.

Note that, the lens unit 2021 described above may be attached to and integrated with the imaging apparatus 2100, or may be detachably attached to the imaging apparatus 2100.

The imaging element 2022 outputs an analog signal which is obtained by a photoelectric conversion of the optical image formed on the image capture surface to the AD conversion unit 2023. The AD conversion unit 2023 converts the analog signal which is input from the imaging element 2022 into a digital signal, and outputs this converted digital signal as image data.

For example, the imaging unit 2002 outputs image data of a captured still image in response to a still-image capture operation in the operation unit 2011. In addition, the imaging unit 2002 outputs image data of a moving image which is captured continuously at a predetermined time interval in response to a moving-image capture operation in the operation unit 2011. The image data of the still image captured by the imaging unit 2002 and the image data of the moving image captured by the imaging unit 2002 are recorded on the storage medium 2200 via the buffer memory unit 2006 or the image processing unit 2004 by the control of the camera control unit 2003. In addition, when the imaging unit 2002 is in a capture standby state where no capture operation is performed in the operation unit 2011, the imaging unit 2002 outputs image data which is obtained continuously at a predetermined time interval as through image data (through image). The through image data obtained by the imaging unit 2002 is displayed in the display unit 2007 via the buffer memory unit 2006 or the image processing unit 2004 by the control of the camera control unit 2003.

The image processing unit 2004 applies an image processing to the image data which is stored in the buffer memory unit 2006 on the basis of the image processing condition which is stored in the storage unit 2005. The image data which is stored in the buffer memory unit 2006 or the storage medium 2200 is, for example, the image data of a still image which is captured by the imaging unit 2002, the through image data, the image data of a moving image, or the image data which is read out from the storage medium 2200.

In the storage unit 2005, predetermined conditions used to control the imaging apparatus 2100, such as an imaging condition, an image processing condition, a play control condition, a display control condition, a record control condition, and an output control condition are stored. For example, the storage unit 2005 is a ROM.

Note that, the image data of a captured moving image and the image data of a still image may be recorded on the storage unit 2005. In this case, for example, the storage unit 2005 may be a flash memory or the like.

The buffer memory unit 2006 is used as a working area when the camera control unit 2003 controls the imaging apparatus 2100. The image data of a still image which is captured by the imaging unit 2002, the through image data, the image data of a moving image, or the image data which is read out from the storage medium 2200 is temporally stored in the buffer memory unit 2006 in the course of the image processing which is controlled by the camera control unit 2003. The buffer memory unit 2006 is, for example, a RAM (Random Access Memory).

The display unit 2007 is, for example, a liquid crystal display and displays an image on the basis of the image data which is captured by the imaging unit 2002, an image on the basis of the image data which is read out from the storage medium 2200, a menu screen, information regarding the operation state or the setting of the imaging apparatus 2100, or the like.

The operation unit 2011 is provided with an operation switch which is used by an operator to input an operation to the imaging apparatus 2100. For example, the operation unit 2011 includes a power switch, a release switch, a mode switch, a menu switch, an up-and-down and right-and-left select switch, an enter switch, a cancel switch, and other operation switches. Each of the above-described switches which are included in the operation unit 2011, in response to being operated, outputs an operation signal corresponding to each operation, to the camera control unit 2003.

The storage medium 2200 such as a card memory, which is detachable, is inserted into the communication unit 2012.

Writing of image data on this storage medium 2200, reading-out, or erasing is performed via the communication unit 2012.

The storage medium 2200 is a storage unit that is detachably connected to the imaging apparatus 2100. For example, the image data which is captured and generated by the imaging unit 2002 is recorded on the storage medium 2200. Note that, in the present embodiment, the image data which is recorded on the storage medium 2200 is, for example, a file in an Exif (Exif) format.

The power supply unit 2013 supplies electric power to each unit which is included in the imaging apparatus 2100. The power supply unit 2013, for example, includes a battery and converts the voltage of the electric power which is supplied from this battery into the operation voltage of each unit described above. The power supply unit 2013 supplies the electric power having the converted operation voltage, on the basis of the operation mode (for example, image capture operation mode, or sleep mode) of the imaging apparatus 2100, to each unit described above by the control of the camera control unit 2003.

The bus 2015 is connected to the imaging unit 2002, the camera control unit 2003, the image processing unit 2004, the storage unit 2005, the buffer memory unit 2006, the display unit 2007, the operation unit 2011, and the communication unit 2012. The bus 2015 transfers the image data which is output from each unit, the control signal which is output from each unit, or the like.

The camera control unit 2003 controls each unit which is included in the imaging apparatus 2100.

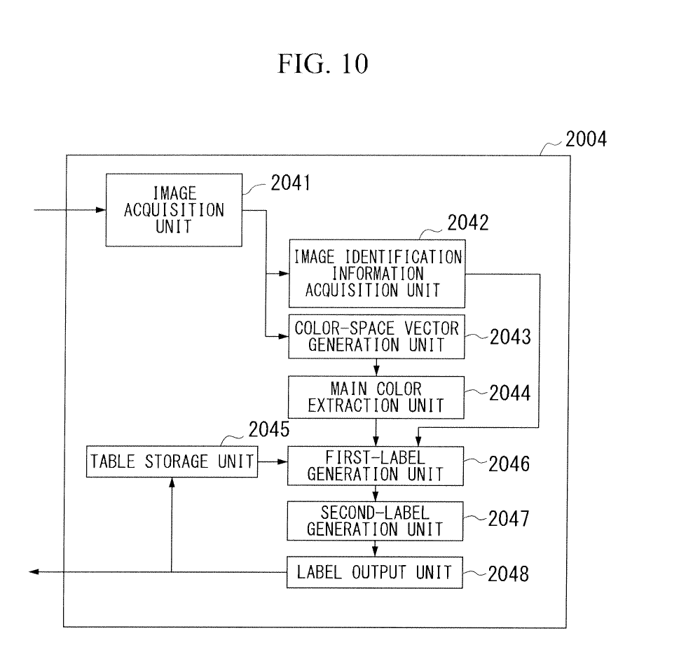

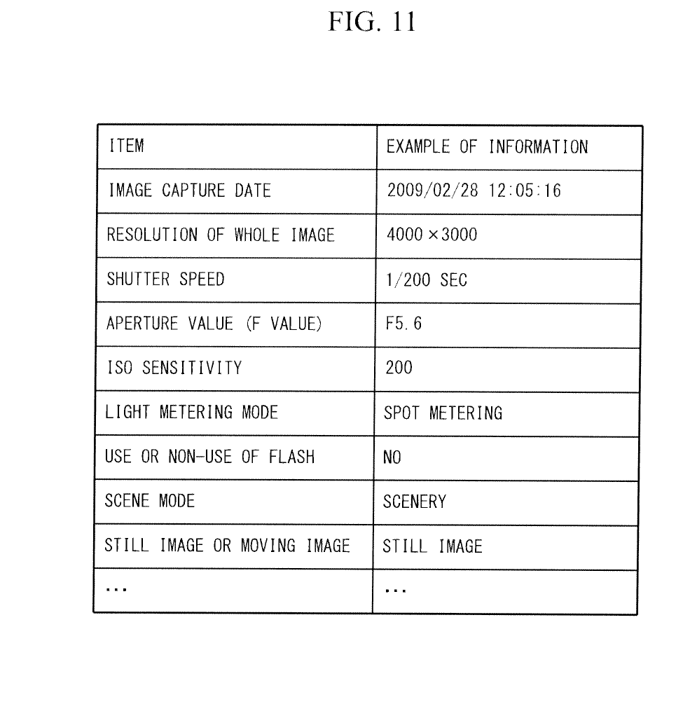

FIG. 10 is a block diagram of the image processing unit 2004 according to the present embodiment.

As is shown in FIG. 10, the image processing unit 2004 includes an image acquisition unit 2041, an image identification information acquisition unit 2042 (scene determination unit), a color-space vector generation unit 2043, a main color extraction unit 2044, a table storage unit 2045, a first-label generation unit 2046, a second-label generation unit 2047, and a label output unit 2048.

The image acquisition unit 2041 reads out the image data which is captured by the imaging unit 2002 and the image identification information which is stored while being related to the image data, from the storage medium 2200 via the bus 2015. The image data which is read out by the image acquisition unit 2041 is image data which is selected via the operation of the operation unit 2011 by the user of the imaging system 2001. The image acquisition unit 2041 outputs the acquired image data to the color-space vector generation unit 2043. The image acquisition unit 2041 outputs the acquired image identification information to the image identification information acquisition unit 2042.

FIG. 11 is a diagram showing an example of the image identification information which is stored, while being related to image data, in the storage medium 2200 according to the present embodiment.

In FIG. 11, examples of an item are shown in the left-side column and examples of information are shown in the right-side column. As is shown in FIG. 11, the item which is stored while being related to the image data is an image capture date, resolution of the whole image, a shutter speed, an aperture value (F value), an ISO sensitivity, a light metering mode, use or non-use of a flash, a scene mode, a still image or a moving image, or the like. The image identification information is information which is set by the image capture person using the operation unit 2011 of the imaging system 2001 at the time of image capture, or information which is set automatically by the imaging apparatus 2100. In addition, information regarding the Exif standard which is stored while being related to the image data may be used as the image identification information.

In the item, “scene” (also referred to as image capture mode) is a combination pattern of the shutter speed, the F value, the ISO sensitivity, a focal distance, and the like, which are preliminarily set in the imaging apparatus 2100. The combination pattern is preliminarily set in accordance with the object to be captured, stored in the storage medium 2200, and manually selected from the operation unit 2011 by the user. The scene is, for example, a portrait, scenery, a sport, a night-scene portrait, a party, a beach, a snow, a sunset, a night scene, a closeup, a dish, a museum, fireworks, backlight, a child, a pet, or the like.

With reference back to FIG. 10, the image identification information acquisition unit 2042 extracts image capture information which is set in the captured image data from the image identification information which is output by the image acquisition unit 2041 and outputs the extracted image capture information to the first-label generation unit 2046. Note that, the image capture information is information which is required for the first-label generation unit 2046 to generate a first label and is, for example, a scene, an image capture date, or the like.

The color-space vector generation unit 2043 converts image data, which is output from the image acquisition unit 2041, into a vector of a predetermined color space. The predetermined color space is, for example, HSV (Hue (Hue), Saturation (Saturation), and Brightness (Brightness)).

The color-space vector generation unit 2043 categorizes all the pixels of image data into any one of color vectors, detects the frequency of each color vector, and generates frequency distribution of the color vector. The color-space vector generation unit 2043 outputs the information indicating the generated frequency distribution of the color vector to the main color extraction unit 2044.

Note that, in the case that the image data is in HSV, the color vector is represented by the following expression (4).

$$\begin{matrix}[ Equation 2 ] & \\ ( \begin{matrix}H \\ S \\ V\end{matrix} ) = ( \begin{matrix}i \\ j \\ k\end{matrix} ) & ( 4 )\end{matrix}$$

Note that, in the expression (4), each of i, j, and k is a natural number from 0 to 100 in the case that the hue is normalized into 0 to 100%.

The main color extraction unit 2044 extracts three colors in descending order of frequency as the main color from the information indicating the frequency distribution of the color vector which is output from the color-space vector generation unit 2043 and outputs the information indicating the extracted main color to the first-label generation unit 2046. Note that, the color with high frequency is a color having a large number of pixels of the same color vector. In addition, the information indicating the main color is the color vector in expression (4), and this frequency (the number of pixels) of each color vector.

Note that, in the present embodiment, the main color extraction unit 2044 may be configured by the color-space vector generation unit 2043 and the main color extraction unit 2044.

The first label is preliminarily stored in the table storage unit 2045 (storage unit) while being related to each scene and each combination of the main colors.

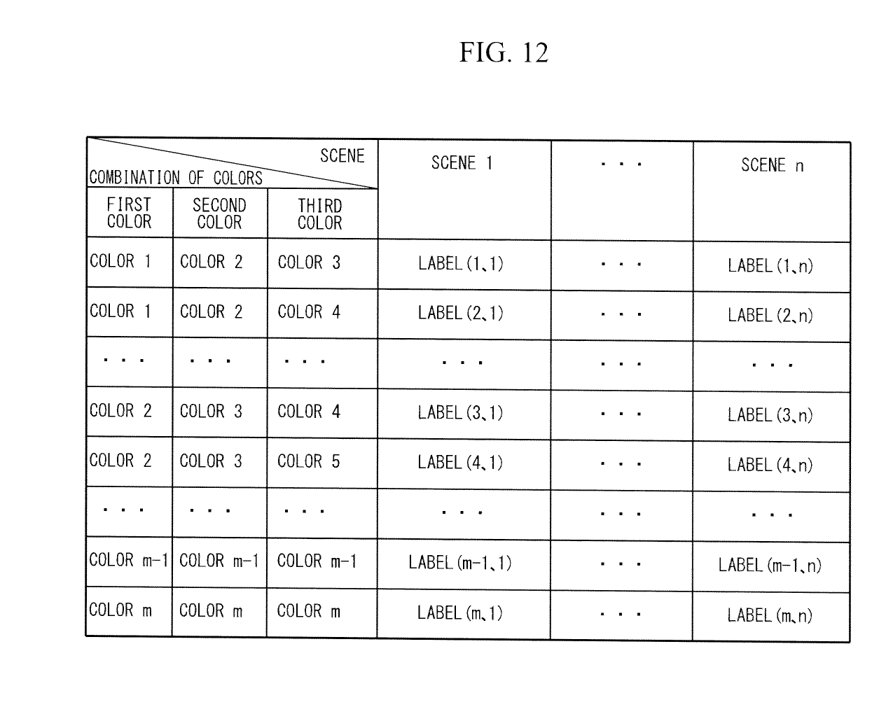

FIG. 12 is a diagram showing an example of the first label and the combination of the main colors, which is stored in the table storage unit 2045 according to the present embodiment.

As is shown in FIG. 12, the first label is preliminarily defined for each scene and for each combination of three colors which are, of the main colors extracted from the image data, a first color having the highest frequency, a second color having the highest frequency next to the first color, a third color having the highest frequency next to the second color, and stored in the table storage unit 2045. For example, in the combination in which the first color is color 1, the second color is color 2, and the third color is color 3, the first label for scene 1 is a label (1, 1), and the label for scene n is a label (1, n). Similarly, in the combination in which the first color is color m, the second color is color m, and the third color is color m, the first label for scene 1 is a label (m, 1), and the label for scene n is a label (m, n).

As described above, the label for each scene and for each combination of main three colors is made to be preliminarily defined by an experiment, a questionnaire, or the like and to be stored in the table storage unit 2045. Note that, the ratio of the frequency of the first color, the second color, and the third color is 1:1:1.

In FIG. 10, the first-label generation unit 2046 reads out a first label which is stored in association with image capture information that is output from the image identification information acquisition unit 2042 and information indicating a main color that is output from the main color extraction unit 2044, from the table storage unit 2045. The first-label generation unit 2046 outputs the information indicating the first label that is read out and the information indicating the main color that is output from the main color extraction unit 2044, to the second-label generation unit 2047. In addition, the first-label generation unit 2046, for example, performs scene determination by using information which is included in the Exif that is the image capture information, or the like.

The second-label generation unit 2047 extracts the frequency of each color vector from the information indicating the main color that is output from the main color extraction unit 2044, normalizes the frequencies of three color vectors by using the extracted frequency, and calculates the ratio of the three main colors. The second-label generation unit 2047 generates a modification label (third label) which qualifies the first label on the basis of the calculated ratio of the three main colors, modifies the first label by causing the generated modification label to qualify the first label that is output from the first-label generation unit 2046, and generates a second label with respect to the image data. The second-label generation unit 2047 outputs information indicating the generated second label to the label output unit 2048.

The label output unit 2048 stores the information indicating the second label that is output from the second-label generation unit 2047 in association with the image data, in the table storage unit 2045. Alternatively, the label output unit 2048 stores the information indicating the label that is output from the second-label generation unit 2047 in association with the image data, in the storage medium 2200.

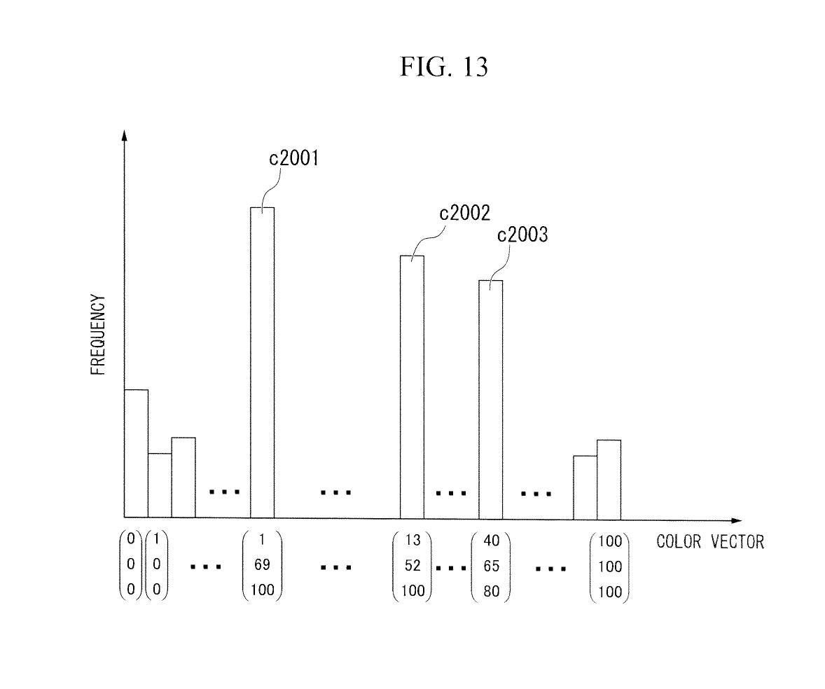

FIG. 13 is a diagram showing an example of a main color of image data according to the present embodiment.

In FIG. 13, the horizontal axis indicates a color vector, and the vertical axis indicates a frequency of the color vector (color information).

The example shown in FIG. 13 is a graph of frequency distribution of the color vector (HSV=(iₘ, jₘ, kₘ); m is a natural number from 0 to 100) which is obtained after the color-space vector generation unit 2043 applies an HSV separation to the image data. In FIG. 13, the color vectors are schematically arranged in order such that a color vector of H (Hue)=0, S (Saturation)=0, and V (Value)=0 is on the left-side end, and a color vector of H=100, S=100, and V=100 is on the right-side end. In addition, the calculated result of the frequency of each color vector is schematically represented. In the example shown in FIG. 13, the first color c2001 having the highest frequency is a rose color (rose) of which vector is HSV=(i₁, j₆₉, k₁₀₀). Moreover, the second color c2002 having the highest frequency next to the first color is a pale yellow color (sulfur yellow) of which vector is HSV=(i₁₃, j₅₂, k₁₀₀). Furthermore, the third color c2003 having the highest frequency next to the second color is an emerald color (emerald) of which vector is HSV=(i₄₀, j₆₅, k₈₀).

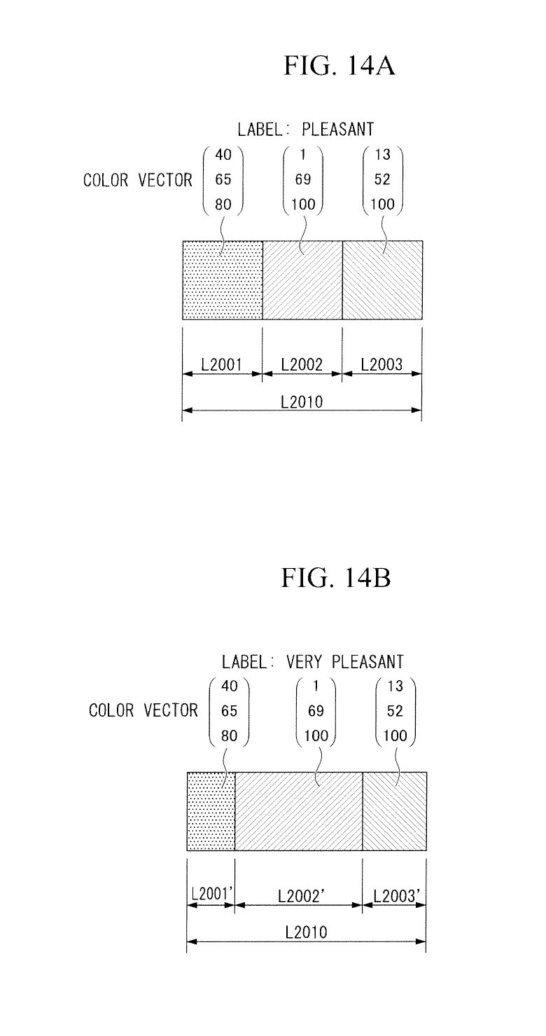

FIGS. 14A and 14B are diagrams showing an example of the labeling of the main color which is extracted in FIG. 13. Note that, the color vectors in FIG. 13 and FIGS. 14A and 14B will be described regarding image data of which the scene mode is a portrait.

FIG. 14A is an example of the first color, the second color, and the third color, which are extracted in FIG. 13. As is shown in FIG. 14A, the color vectors are schematically represented to be arranged from the left side in the order of the color vector as shown in FIG. 13. The first-label generation unit 2046 reads out a first label which is stored in association with the combination of the first color, the second color, and the third color which are extracted by the main color extraction unit 2044, from the table storage unit 2045. In this case, the first label in association with the combination of the first color, the second color, and the third color is stored as “pleasant”. In addition, as is shown in FIG. 14A, each width of the first color, the second color, and the third color before normalization is L2001, L2002, and L2003, and lengths of a width L2001, L2002, and L2003 are equal one another. In addition, a length L2010 is the sum of the width L2001, L2002, and L2003.

FIG. 14B is a diagram after the first color, the second color, and the third color which are extracted are normalized by frequency, and each width of the first color, the second color, and the third color is adjusted to be L2001′, L2002′, and L2003′. A sum L2010 of the widths is the same as that in FIG. 14A. In the example shown in FIG. 14B, because the frequency of the first color is greater than the frequencies of the second color and the third color, the second-label generation unit 2047 generates, with respect to the first label “pleasant” which is read out by the first-label generation unit 2046, a modification label “very” which qualifies the first label “pleasant”, on the basis of a predetermined rule. The predetermined rule is a rule in which, in the case that the first color has a frequency which is greater than a predetermined threshold value and is greater than other frequencies of the second color and the third color, the second-label generation unit 2047 generates the modification label “very”, modifies the first label by making the generated modification label to qualify the first label “pleasant”, and generates the second label “very pleasant”. Note that, the modification label is, for example, a word which emphasizes the first label.

Next, an example of the modification label will be described.

As is shown in FIG. 14A, before normalization, the widths or areas of the three colors which are extracted by the main color extraction unit 2044 is 1:1:1. Then, after being normalized on the basis of the frequency of the color vector, the widths or areas of the three colors are adjusted as shown in FIG. 14B. For example, in the case that the ratio of the first color is greater than about 67% of the entire L2010, the second-label generation unit 2047 makes “very” as the modification label to qualify the first label and thereby modifies the first label to obtain the second label. In addition, in the case that the ratio of the first color is about between 50% and 67% of the entire L2010, the second-label generation unit 2047 determines that no modification label is added. In other words, the second-label generation unit 2047 makes the first label to be the second label without modification. In addition, in the case that the ratio of the first color is about 33% of the entire L2010, the second-label generation unit 2047 makes “a little” as the modification label to qualify the first label and thereby modify the first label to obtain the second label.

As described above, the second-label generation unit 2047 generates a modification label to qualify the first label depending on the first label. For example, modification labels which are capable of qualifying the first label may be preliminarily stored in association with each first label in the table storage unit 2045.

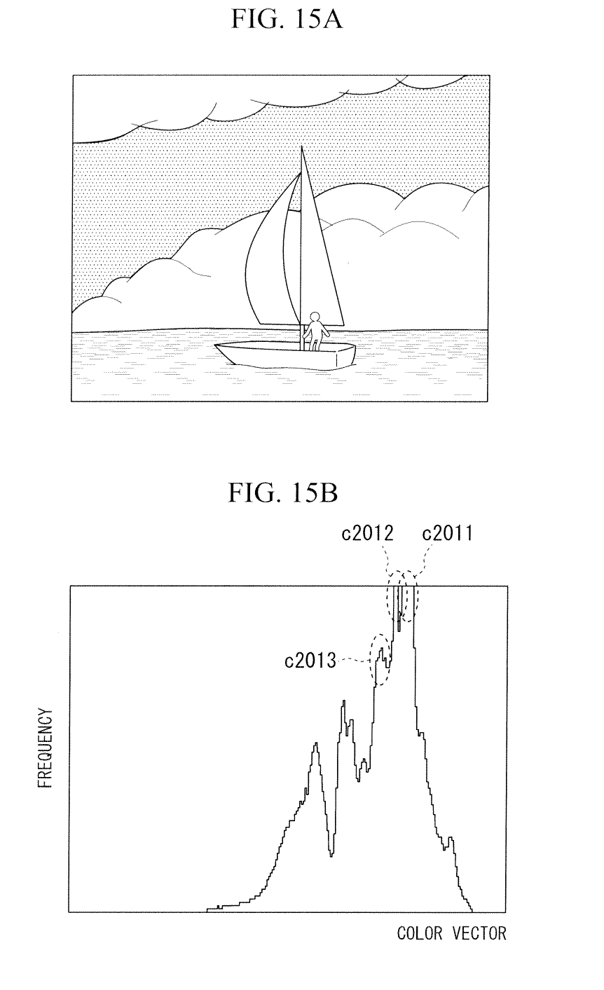

Next, an example of the main color of each scene will be described with reference to FIG. 15A to FIG. 17B.

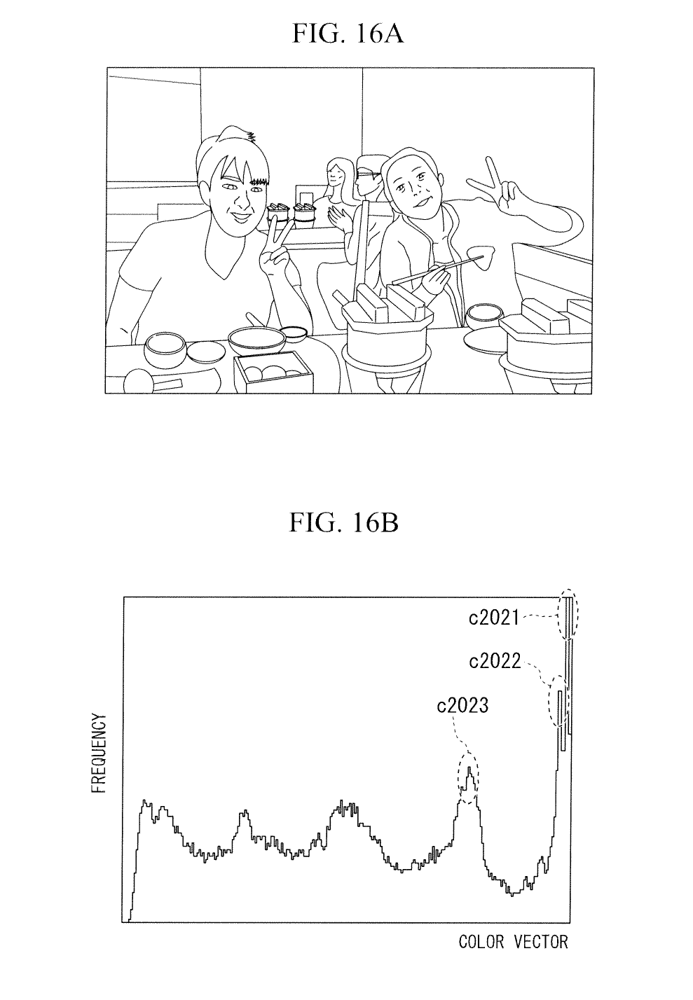

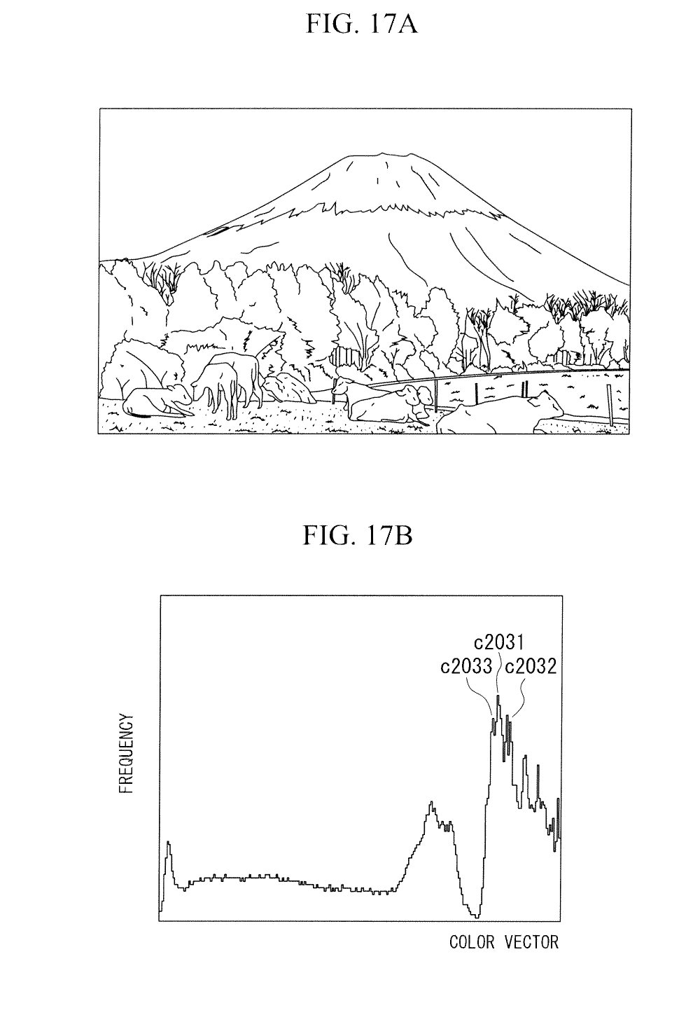

FIGS. 15A and 15B are diagrams of image data of a sport and a color vector according to the present embodiment. FIG. 15A is the image data of the sport, and FIG. 15B is a graph of the color vector of the sport. FIGS. 16A and 16B are diagrams of image data of a portrait and a color vector according to the present embodiment. FIG. 16A is the image data of the portrait, and FIG. 16B is a graph of the color vector of the portrait. FIGS. 17A and 17B are diagrams of image data of scenery and a color vector according to the present embodiment. FIG. 17A is the image data of the scenery, and FIG. 17B is a graph of the color vector of the scenery. In FIG. 15B, FIG. 16B, and FIG. 17B, the horizontal axis indicates a color vector, and the vertical axis indicates a frequency (number of pixels).

As is shown in FIG. 15A and FIG. 15B, by separating each pixel of the image data in FIG. 15A into the color vector and graphing the frequency (number of pixels) of each color vector, the graph as shown in FIG. 15B is obtained. The main color extraction unit 2044 extracts, for example, three colors c2011, c2012, and c2013 having a large number of pixels from such information of the color vector.

As is shown in FIG. 16A and FIG. 16B, by separating each pixel of the image data in FIG. 16A into the color vector and graphing the frequency (number of pixels) of each color vector, the graph as shown in FIG. 16B is obtained. The main color extraction unit 2044 extracts, for example, three colors c2021, c2022, and c2023 having a large number of pixels from such information of the color vector.

As is shown in FIG. 17A and FIG. 17B, by separating each pixel of the image data in FIG. 17A into the color vector and graphing the frequency (number of pixels) of each color vector, the graph as shown in FIG. 17B is obtained. The main color extraction unit 2044 extracts, for example, three colors c2031, c2032, and c2033 having a large number of pixels from such information of the color vector.

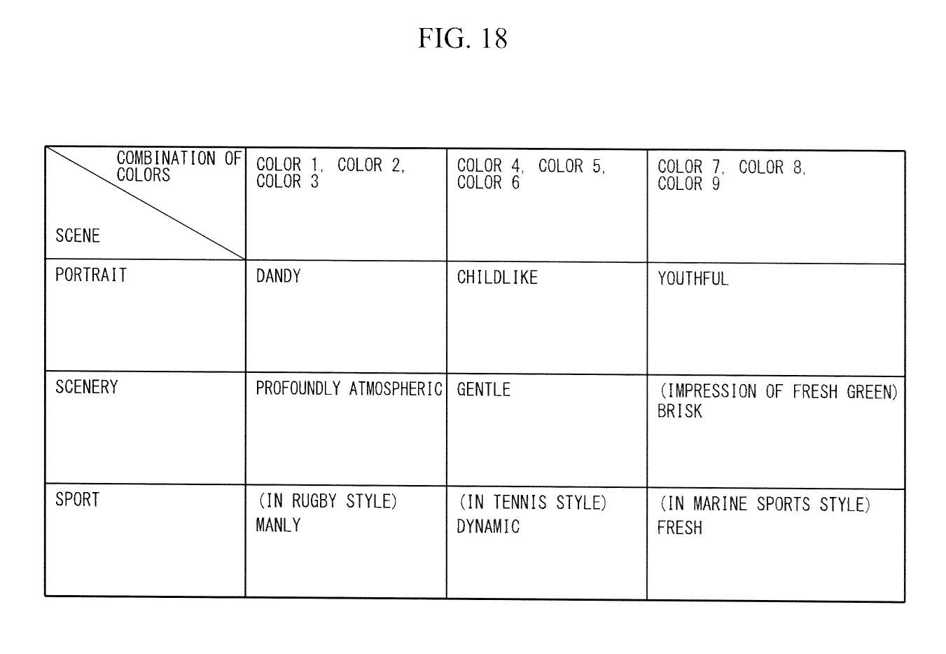

FIG. 18 is a diagram showing an example of a first label depending on the combination of main colors for each scene according to the present embodiment. In FIG. 18, the row represents a scene, and the column represents a color vector.

In FIG. 18, in the case that the image data is in HSV, hue, saturation, and intensity in HSV of each color of the color combination (color 1, color 2, color 3) are, for example, (94, 100, 25) for color 1 (chestnut color, marron), (8, 100, 47) for color 2 (cigarette color, coffee brown), and (81, 100, 28) for color 3 (grape color, dusky violet).

In addition, hue, saturation, and intensity in HSV of each color of the color vector (color 4, color 5, color 6) are, for example, (1, 69, 100) for color 4 (rose color, rose), (13, 25, 100) for color 5 (ivory color, ivory), and (52, 36, 91) for color 6 (water color, aqua blue).

In addition, hue, saturation, and intensity in HSV of each color of the color vector (color 7, color 8, color 9) are, for example, (40, 65, 80) for color 7 (emerald color, emerald), (0, 0, 100) for color 8 (white color, white), and (59, 38, 87) for color 9 (salvia color, salvia blue).

As is shown in FIG. 18, for example, in the case that the color combination is (color 1, color 2, color 3), it is stored in the table storage unit 2045 that the first label for the scene of the portrait is “dandy”. Even in the case of the same color combination (color 1, color 2, color 3), it is stored in the table storage unit 2045 that the first label for the scene of the scenery is “profoundly atmospheric”. In addition, even in the case of the same color combination (color 1, color 2, color 3), it is stored in the table storage unit 2045 that the first label for the scene of the sport is “(in rugby style) manly”.

In addition, as is shown in FIG. 18, for example, in the case that the color combination is (color 4, color 5, color 6), it is stored in the table storage unit 2045 that the first label for the scene of the portrait is “childlike”. Even in the case of the same color combination (color 4, color 5, color 6), it is stored in the table storage unit 2045 that the first label for the scene of the scenery is “gentle”. In addition, even in the case of the same color combination (color 4, color 5, color 6), it is stored in the table storage unit 2045 that the first label for the scene of the sport is “(in tennis style) dynamic”.

In addition, as is shown in FIG. 18, for example, in the case that the color combination is (color 7, color 8, color 9), it is stored in the table storage unit 2045 that the first label for the scene of the portrait is “youthful”. Even in the case of the same color combination (color 7, color 8, color 9), it is stored in the table storage unit 2045 that the first label for the scene of the scenery is “(impression of fresh green) brisk”.

In addition, even in the case of the same color combination (color 7, color 8, color 9), it is stored in the table storage unit 2045 that the first label for the scene of the sport is “(in marine sports style) fresh”.

Moreover, as is shown in FIG. 18, the information which is stored in the table storage unit 2045 may be stored in association with not only the color combination and the first label such as an adjective or an adverb but also a word which represents impression. Note that, the word which represents impression is, for example, “in rugby style”, “impression of fresh green”, or the like.

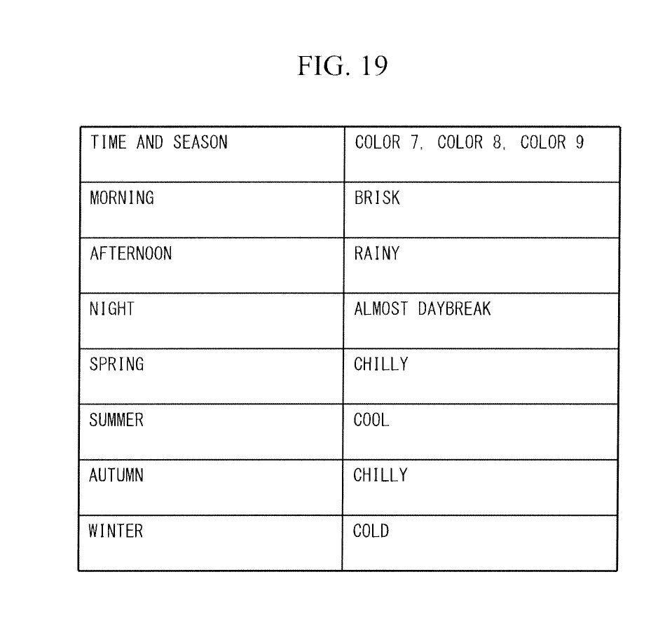

FIG. 19 is a diagram showing an example of a first label depending on time, a season, and a color vector according to the present embodiment. In FIG. 19, the color vector, of which the image data is in HSV, is the color combination (color 7, color 8, color 9) which is described in FIG. 18. In FIG. 19, the column represents the time and the season, and the label for each time and season with respect to the color combination (color 7, color 8, color 9) is presented in the row.

As is shown in FIG. 19, it is stored in the table storage unit 2045 that the first label for the color combination (color 7, color 8, color 9) is “brisk” in the case that the time is morning, “rainy” in the case that the time is afternoon, and “almost daybreak” in the case that the time is night.

As is shown in FIG. 19, it is stored in the table storage unit 2045 that the first label for the color combination (color 7, color 8, color 9) is “chilly” in the case that the season is spring, “cool” in the case that the season is summer, “chilly” in the case that the season is autumn, and “cold” in the case that the season is winter.

Regarding such information relating to time and a season, the first-label generation unit 2046 reads out the first label from the table storage unit 2045 on the basis of an image capture date which is included in the image identification information acquired by the image identification information acquisition unit 2042.

In addition, as is shown in FIG. 19, the first label of spring may be the same as the first label of autumn with respect to the same color combination (color 7, color 8, color 9).

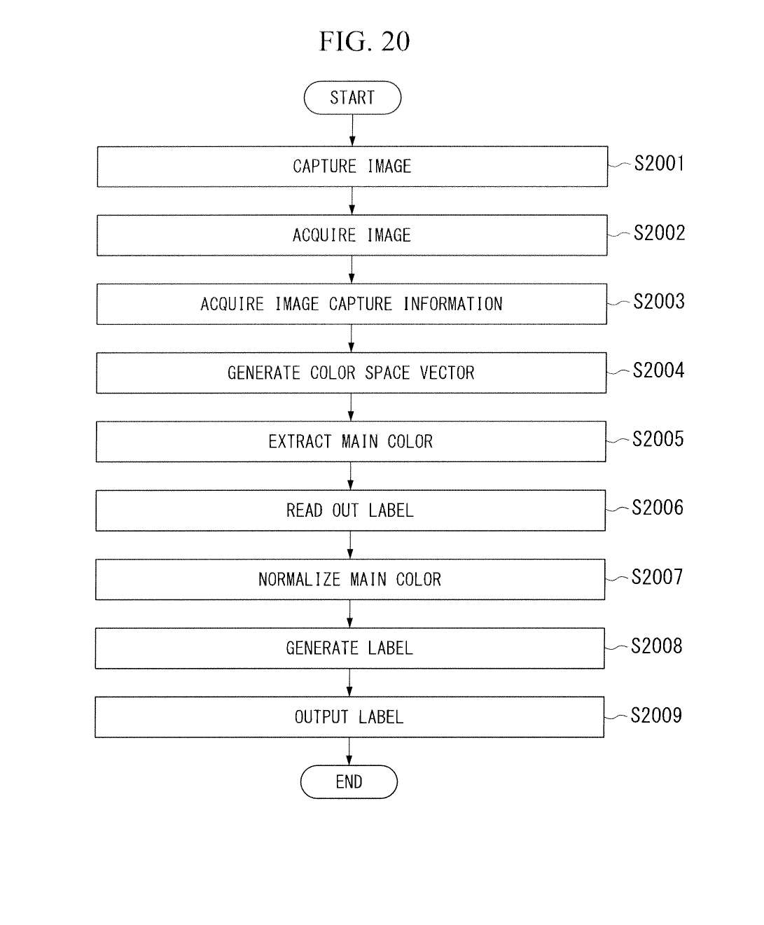

Next, a label generation process which is performed by the imaging apparatus 2100 will be described with reference to FIG. 20. FIG. 20 is a flowchart of the label generation performed by the imaging apparatus 2100 according to the present embodiment.

(Step S2001) The imaging unit 2002 of the imaging apparatus 2100 captures an image on the basis of the control of the camera control unit 2003. Then, the imaging unit 2002 converts the captured image data into digital data via the AD conversion unit 2023, and stores the converted image data in the storage medium 2200.

Next, the camera control unit 2003 stores the image identification information including the imaging condition which is set or selected via the operation unit 2011 by the user at the time of image capture, information which is set or acquired automatically by the imaging apparatus 2100 at the time of image capture, and the like, in the storage medium 2200 in association with the captured image data. After finishing step S2001, the routine proceeds to step S2002.

(Step S2002) Next, the image acquisition unit 2041 of the image processing unit 2004 reads out the image data which is captured by the imaging unit 2002 and the image identification information which is stored in association with the image data via the bus 2015 from the storage medium 2200. Note that, the image data which is read out by the image acquisition unit 2041 is the image data which is selected via the operation of operation unit 2011 by the user of the imaging system 2001.

Then, the image acquisition unit 2041 outputs the captured image data to the color-space vector generation unit 2043. Next, the image acquisition unit 2041 outputs the acquired image identification information to the image identification information acquisition unit 2042. After finishing step S2002, the routine proceeds to step S2003.

(Step S2003) Next, the image identification information acquisition unit 2042 extracts image capture information which is set in the captured image data from the image identification information which is output by the image acquisition unit 2041 and outputs the extracted image capture information to the first-label generation unit 2046. After finishing step S2003, the routine proceeds to step S2004.

(Step S2004) Next, the color-space vector generation unit 2043 converts image data which is output by the image acquisition unit 2041, into a vector of a predetermined color space. The predetermined color space is, for example, HSV. Then, the color-space vector generation unit 2043 categorizes all the pixels of image data into any one of the generated color vectors, detects the frequency of each color vector, and generates frequency distribution of the color vector. Next, the color-space vector generation unit 2043 outputs the information indicating the generated frequency distribution of the color vector to the main color extraction unit 2044. After finishing step S2004, the routine proceeds to step S2005.

(Step S2005) Next, the main color extraction unit 2044 extracts three colors in descending order of frequency as the main color from the information indicating the frequency distribution of the color vector which is output from the color-space vector generation unit 2043 and outputs the information indicating the extracted main color to the first-label generation unit 2046. After finishing step S2005, the routine proceeds to step S2006.

(Step S2006) Next, the first-label generation unit 2046 reads out a first label which is stored in association with the image capture information that is output by the image identification information acquisition unit 2042 and the information indicating the main color that is output by the main color extraction unit 2044, from the table storage unit 2045. Then, the first-label generation unit 2046 outputs the information indicating the first label that is read out and the information indicating the main color that is output by the main color extraction unit 2044, to the second-label generation unit 2047.

In addition, in the case that the first label which is stored in association with the image capture information that is output by the image identification information acquisition unit 2042 and the information indicating the main color that is output by the main color extraction unit 2044 is not stored in the table storage unit 2045, the first-label generation unit 2046, for example, determines whether or not a first label for another scene with respect to the same main color is stored. When the first-label generation unit 2046 determines that a first label for another scene with respect to the same main color is stored, the first-label generation unit 2046 may read out the first label for another scene with respect to the same main color from the table storage unit 2045. On the other hand, when the first-label generation unit 2046 determines that a first label for another scene with respect to the same main color is not stored, the first-label generation unit 2046 may read out a label which is stored in association with a color vector that is for the same scene and is closest to the main color with respect to the distance of the color vector, from the table storage unit 2045.

After finishing step S2006, the routine proceeds to step S2007.

(Step S2007) Next, the second-label generation unit 2047 normalizes the frequency of each color vector by using the information indicating the main color that is output by the main color extraction unit 2044, and calculates the ratio of three main colors. After finishing step S2007, the routine proceeds to step S2008.

(Step S2008) Next, the second-label generation unit 2047 generates a modification label which qualifies the first label that is output by the first-label generation unit 2046 on the basis of the calculated ratio of the three main colors, modifies the first label by causing the generated modification label to qualify the first label, and generates a second label. Then, the second-label generation unit 2047 outputs the information indicating the generated second label to the label output unit 2048. After finishing step S2008, the routine proceeds to step S2009.

(Step S2009) Next, the label output unit 2048 stores the information indicating the second label that is output by the second-label generation unit 2047 in association with the image data, in the table storage unit 2045.

Note that, in step S2006, in the case that the first label which is stored in association with the information indicating the scene and the information indicating the main color is not stored in the table storage unit 2045, the label output unit 2048 may relate the first label that is output in step S2006 to the extracted main color, and cause the first label that is related to the main color to be newly stored in the table storage unit 2045.

Then, the label generation process performed by the image processing unit 2004 is finished.

As described above, the imaging apparatus 2100 of the present embodiment can extract a main color which is a characteristic attribute of image data with less calculation quantity in comparison with the related art. Moreover, the imaging apparatus 2100 of the present embodiment performs scene determination by using the information which is included in the Exif or the like, and selects a table for each scene that is stored in the table storage unit 2045 on the basis of the determination result. Therefore, it is possible to determine a scene with less calculation quantity. As a result, the imaging apparatus 2100 of the present embodiment can perform more label generation with less calculation processing and less need of choice with respect to the image data in comparison with the related art.

In other words, the image processing unit 2004 extracts three main colors with a high frequency from the color vectors obtained by converting the image data into a color space, and extracts the first label which is preliminarily stored in connection with the extracted main colors. As is shown in FIG. 18 and FIG. 19, because a first label is preliminarily stored in connection with the main color for each scene, time, and each season, the image processing unit 2004 can generate a first label which is different for each scene, time, and each season even in the case that the main color which is extracted from the image data is the same. Therefore, a label which is the most appropriate to the image data for each scene can be generated.

Moreover, the image processing unit 2004 normalizes the frequency of the three main colors, generates a modification label that qualifies the generated first label depending on the ratio of the first color with the highest frequency, and modifies the first label by causing the generated modification label to qualify the first label, thereby generating a second label.

As a result, because the image processing unit 2004 is configured to generate the second label by causing the modification label to qualify the first label and modifying the first label on the basis of the ratio of color combination of the main colors in the image data, it is possible to generate a label which is much more suitable to the image data for each scene in comparison with the case where a label is generated by extracting the main color from the image data.

Note that, the present embodiment is described using an example in which the color-space vector generation unit 2043 generates a color vector in a color space of the HSV from the image data. However, a color space such as RGB (Red, Green, and Blue), YCrCb or YPbPr using a brightness signal and two color difference signals, HLS using hue, saturation, and brightness, Lab which is a type of a complementary color space, and a color space on the basis of the PCCS (PCCS; Practical Color Co-ordinate System) may be used.

In addition, the present embodiment is described using an example in which the color-space vector generation unit 2043 generates the frequency distribution of the color vector, and outputs the information indicating the generated frequency distribution of the color vector to the main color extraction unit 2044. However, the color-space vector generation unit 2043 may be configured to detect the frequency of each color vector and to output the information indicating the detected frequency of each color vector to the main color extraction unit 2044. Even in this case, for example, each quantity of RGB which is made to be stored in the table storage unit 2045 may be a color which is selected from quantities having an interval of one, ten, or the like, by a person who generates the table.

In addition, the present embodiment is described using an example in which the label output unit 2048 stores the information indicating a label in the table storage unit 2045 in association with the image data. However, a label which is output by the second-label generation unit 2047 may be superimposed on the image data which is selected by the user as the data according to character information (text) and displayed on the display unit 2007.

In addition, the present embodiment is described using an example in which the first label and the second label are an adjective or an adverb. However, the first label and the second label may be, for example, a noun. In this case, the first label is, for example, “refreshing”, “rejuvenation”, “dandy”, or the like.

In addition, the present embodiment is described using an example in which the main color is calculated from the image data. However, the main color extraction unit 2044 may extract three colors of which adjacent color vectors are separated by a predetermined distance. The adjacent color vectors are the color vector (50, 50, 50) and the color vector (50, 50, 51) in FIG. 15B, for example, in the case that the image data is in HSV. The distance between adjacent colors may be set on the basis of a known threshold value at which a person can visually distinguish colors. For example, WEB 256 colors which is recommended to use in the WEB, monotone 256 colors which can be presented by white and black, or the like, may be used.

In addition, the main color extraction unit 2044 may perform smoothing process by using a publicly known method with respect to the frequency distribution of the color vector which is generated by the color-space vector generation unit 2043 before the calculation of the main color. Alternatively, the main color extraction unit 2044 may perform color reduction process by using a publicly known method before the color-space vector generation unit 2043 generates the color space vector. For example, the color-space vector generation unit 2043 may reduce the number of colors of the image data to the number of WEB colors.

In addition, the present embodiment is described using an example in which the main color extraction unit 2044 extracts three colors with a high frequency from the image data as the main colors. However, the number of the extracted colors is not limited to three, but may be two or more.

In addition, the present embodiment is described using an example in which HSV is used as the color vector. In the case that the combination of three colors is stored in the table storage unit 2045 as is shown in FIG. 12, the person who generates the table may select from HSV=(0, 0, 0), (1, 0, 0), (1, 1, 0) . . . (100, 100, 99), and (100, 100, 100), of which each quantity of HSV is set with an interval of one. Alternatively, the person who generates the table may select from HSV=(0, 0, 0), (10, 0, 0), (10, 10, 0) . . . (100, 100, 90), and (100, 100, 100), of which each quantity of HSV is set with an interval of ten. Thus, by setting the interval of each quantity in the color vector to a predetermined quantity such as ten, the volume which is stored in the table storage unit 2045 can be made to be small. Moreover, the calculation quantity can be reduced.

### Fourth Embodiment

The third embodiment is described using an example in which the scene of the image data which is selected by the user is determined on the basis of the image identification information which is stored in the storage medium 2200 in association with the image data. The present embodiment is described using an example in which an image processing apparatus determines a scene using the selected image data, and generates a label on the basis of the determined result.

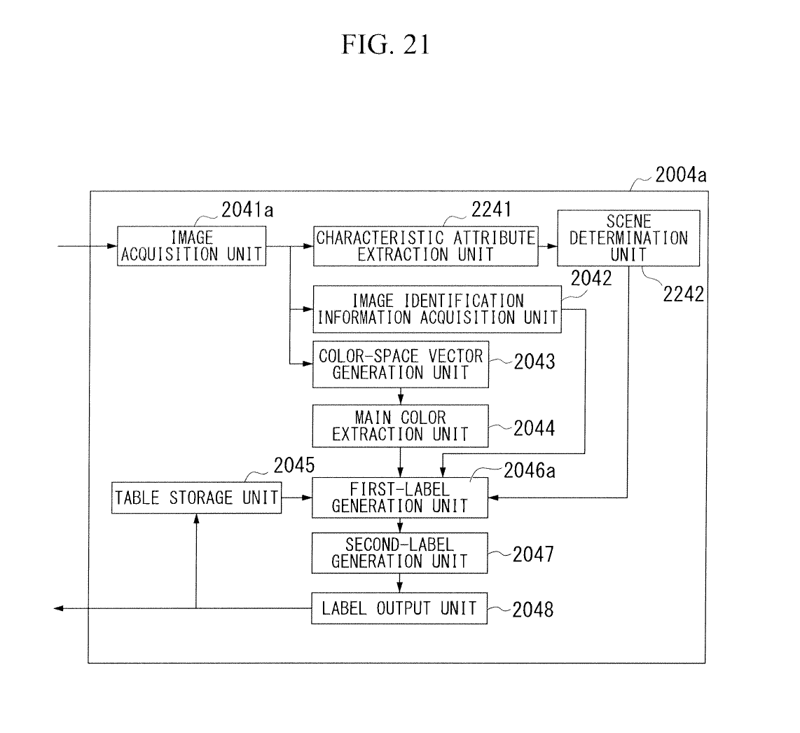

FIG. 21 is a block diagram of an image processing unit 2004a according to the present embodiment.

As is shown in FIG. 21, the image processing unit 2004a includes an image acquisition unit 2041a, an image identification information acquisition unit 2042, a color-space vector generation unit 2043, a main color extraction unit 2044, a table storage unit 2045, a first-label generation unit 2046a, a second-label generation unit 2047, a label output unit 2048, a characteristic attribute extraction unit 2241, and a scene determination unit 2242. Note that, the same reference numeral is used and the description is omitted with respect to a function unit having the same function as that of the third embodiment.

The image acquisition unit 2041a reads out the image data which is captured by the imaging unit 2002 and the image identification information which is stored in association with the image data, from the storage medium 2200 via the bus 2015. The image acquisition unit 2041a outputs the acquired image data to the color-space vector generation unit 2043 and the characteristic attribute extraction unit 2241. The image acquisition unit 2041a outputs the acquired image identification information to the image identification information acquisition unit 2242.

The characteristic attribute extraction unit 2241 extracts a characteristic attribute by using a publicly known method from the image data which is output by the image acquisition unit 2041a. As the publicly known method, for example, a method such as image binarization, smoothing, edge detection, or contour detection, is used. The characteristic attribute extraction unit 2241 outputs information indicating the extracted characteristic attribute to the scene determination unit 2242.

The scene determination unit 2242 determines a scene of the image data which is acquired by the image acquisition unit 204 a by using a publicly known method on the basis of the information indicating the characteristic attribute which is output by the characteristic attribute extraction unit 2241. Note that, the publicly known method which is used for the scene determination is, for example, the related art disclosed in Patent Document 2, in which the scene determination unit 2242 divides the image data into a predetermined plurality of regions, and determines whether a person is imaged in the image data, the sky is imaged in the image data, or the like, on the basis of the characteristic attribute of each of the regions. Then, the scene determination unit 2242 determines the scene of the image data on the basis of the determination result.

The scene determination unit 2242 outputs the information indicating the determined scene to the first-label generation unit 2046a.

Note that, in the present embodiment, the scene determination unit 2242 may be configured by the characteristic attribute extraction unit 2241 and the scene determination unit 2242.

The first-label generation unit 2046a reads out a first label which is stored in association with the information indicating the scene that is output by the scene determination unit 2242 and the information indicating the main color that is output by the main color extraction unit 2044, from the table storage unit 2045. The first-label generation unit 2046a outputs the information indicating the first label that is read out and the information indicating the main color that is output by the main color extraction unit 2044, to the second-label generation unit 2047.

Next, a label generation process which is performed by the image processing unit 2004a of the imaging apparatus 2100 will be described with reference to FIG. 20. The imaging apparatus 2100 performs step S2001 and step S2002 in the same manner as the third embodiment.

(Step S2003) Next, the characteristic attribute extraction unit 2241 extracts a characteristic attribute by using a publicly known method from the image data which is output by the image acquisition unit 2041a, and outputs the information indicating the extracted characteristic attribute to the scene determination unit 2242.

Then, the scene determination unit 2242, by using a publicly known method, extracts and acquires a scene which is image capture information of the image data that is acquired by the image acquisition unit 2041a on the basis of the information indicating the characteristic attribute that is output by the characteristic attribute extraction unit 2241, and outputs the information indicating the acquired scene to the first-label generation unit 2046a. After finishing step S2003, the routine proceeds to step S2004.

The image processing unit 2004a performs step S2004 and step S2005 in the same manner as the third embodiment. After finishing step S2005, the routine proceeds to step S2006.

(Step S2006) Next, the first-label generation unit 2046a reads out a first label which is stored in association with the information indicating the scene that is output by the scene determination unit 2242 and the information indicating the main color that is output by the main color extraction unit 2044, from the table storage unit 2045. Then, the first-label generation unit 2046a outputs the information indicating the first label that is read out and the information indicating the main color that is output by the main color extraction unit 2044, to the second-label generation unit 2047. After finishing step S2006, the image processing unit 2004a performs steps S2007 to S2009 in the same manner as the third embodiment.

As described above, the image processing unit 2004a is configured to perform scene determination with respect to the captured image data by using a predetermined method and to generate a label on the basis of the determined scene and three main colors which are extracted from the image data, in the same manner as the third embodiment. As a result, the image processing unit 2004a can generate a label which is the most appropriate to the image data even in the case that image identification information is not stored in association with the image data in the storage medium 2200.

Note that, the present embodiment is described using an example in which the image processing unit 2004a generates the label on the basis of the scene which is determined by the image data and the extracted main color. However, the scene determination may be performed by additionally using image capture information in the same manner as the third embodiment. The image processing unit 2004a, for example, may extract information indicating the captured date from the image identification information, and generate the label on the basis of the extracted captured date and the scene which is determined by the image data. More specifically, in the case that the scene is “scenery”, and the captured date is “autumn”, the image processing unit 2004a may read out first labels which are stored in association with the scene of “scenery”, “autumn”, and the main color, and generate the label on the basis of two first labels which are read out.

Alternatively, the main color and the first label for the scene of “autumn scenery” may be stored in the table storage unit 2045.

### Fifth Embodiment

The third embodiment and the fourth embodiment are described using an example in which the label is generated on the basis of the main color which is extracted from the entire image data that is selected by the user. The present embodiment is described using an example in which a scene is determined by using the selected image data, a main color is extracted in a predetermined region of the image data on the basis of the determined scene, and a label is generated using the extracted main color.

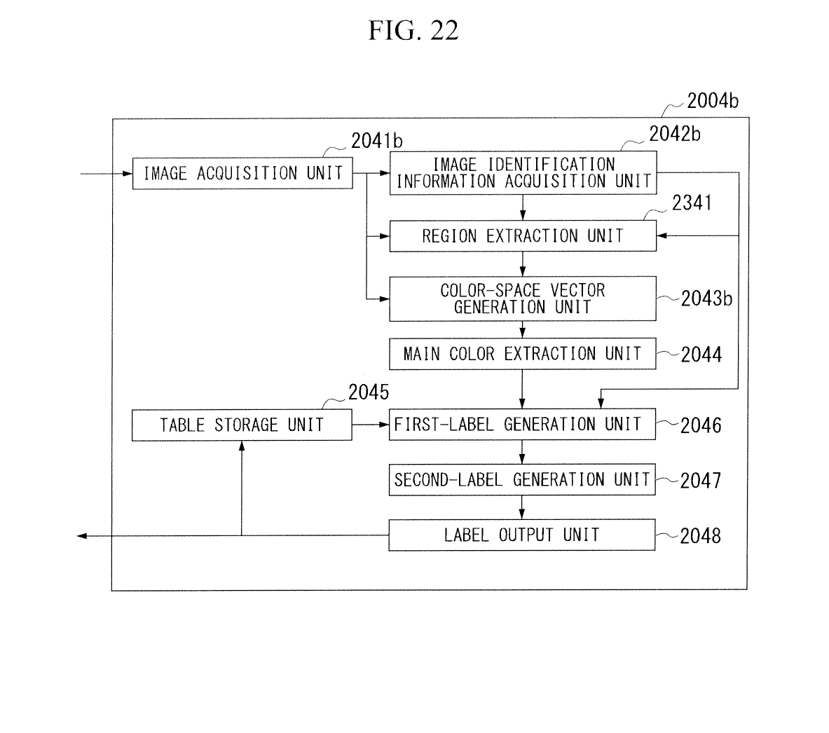

FIG. 22 is a block diagram of an image processing unit 2004b according to the embodiment according to the present embodiment.

As is shown in FIG. 22, the image processing unit 2004b includes an image acquisition unit 2041b, an image identification information acquisition unit 2042b, a color-space vector generation unit 2043b, a main color extraction unit 2044, a table storage unit 2045, a first-label generation unit 2046, a second-label generation unit 2047, a label output unit 2048, and a region extraction unit 2341. Note that, the same reference numeral is used and the description is omitted with respect to function units having the same function as that of the third embodiment.

The image acquisition unit 2041b reads out the image data that is captured by the imaging unit 2002 and the image identification information that is stored in association with the image data, from the storage medium 2200 via the bus 2015. The image acquisition unit 2041b outputs the acquired image data to the region extraction unit 2341 and the color-space vector generation unit 2043b. The image acquisition unit 2041b outputs the acquired image identification information to the image identification information acquisition unit 2042b.

The image identification information acquisition unit 2042b extracts the image capture information which is set in the captured image data from the image identification information that is output by the image acquisition unit 2041b and outputs the extracted image capture information to the first-label generation unit 2046 and to the region extraction unit 2341.

The region extraction unit 2341 extracts a region from which a main color is extracted, by a predetermined method from the image data which is output by the image identification information acquisition unit 2042b on the basis of the image capture information which is output by the image identification information acquisition unit 2042b. The region extraction unit 2341 extracts the image data of the extracted region from which the main color is extracted, from the image data which is output by the image identification information acquisition unit 2042b, and outputs the image data of the extracted region to the color-space vector generation unit 2043b.

Note that, as the predetermined method for extracting the region from which the main color is extracted, for example, a region which is extracted from the entire image may be preliminarily set for each scene. Examples of the regions are a two-thirds region from the top of the image data in the case that the scene is “scenery”, a region having a predetermined size in the center of the image data in the case that the scene is a “portrait”, and the like.

Alternatively, in combination with the fourth embodiment, the region from which the characteristic attribute is extracted on the basis of the characteristic attribute which is extracted from the image data may be extracted as the region from which the main color is extracted. In this case, there may be a plurality of regions which are extracted from the image data. For example, in the case that a determination that the scene of the captured image data is a portrait is made, the scene determination unit 2242 in FIG. 21 performs face detection by using a method such as characteristic attribute extraction. Then, in the case that there are a plurality of detected facial regions, the scene determination unit 2242 detects the main color from each of the detected plurality of regions. Then, the first-label generation unit 2046 and the second-label generation unit 2047 may generate a plurality of labels for each detected main color. Alternatively, the scene determination unit 2242 may output the determination result to the main color extraction unit 2044 such that a region including all the detected facial regions is used as the region from which the main color is extracted.

In FIG. 22, the color-space vector generation unit 2043b converts the image data which is output by the region extraction unit 2341 into a vector of a predetermined color space. The predetermined color space is, for example, HSV. The color-space vector generation unit 2043b categorizes all the pixels of the image data into each of the generated color vectors, detects the frequency of each color vector, and generates frequency distribution of the color vector.

The color-space vector generation unit 2043b outputs the information indicating the generated frequency distribution of the color vector to the main color extraction unit 2044.

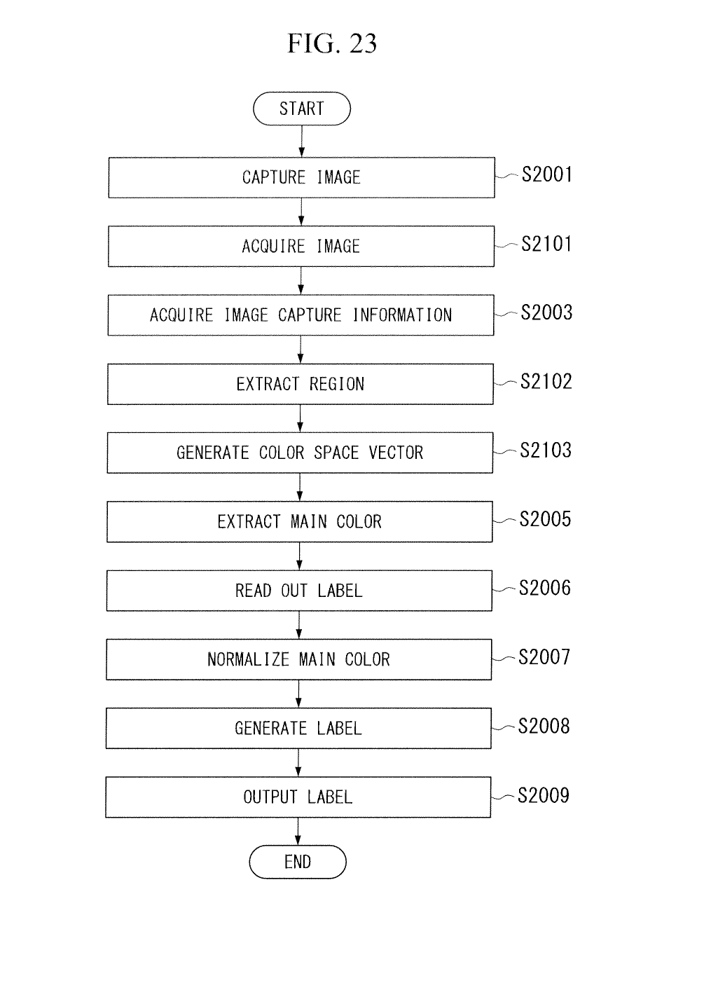

Next, a label generation process which is performed by the image processing unit 2004b of the imaging apparatus 2100 will be described with reference to FIG. 23. FIG. 23 is a flowchart of the label generation which is performed by the imaging apparatus 2100 according to the present embodiment. The imaging apparatus 2100 performs step S2001 in the same manner as the third embodiment. After finishing step S2001, the routine proceeds to step S2101.

(Step S2101) Next, the image acquisition unit 2041b of the image processing unit 2004b reads out the image data that is captured by the imaging unit 2002 and the image identification information that is stored in association with the image data, via the bus 2015 from the storage medium 2200.

Next, the image acquisition unit 2041b outputs the acquired image data to the region extraction unit 2341 and to the color-space vector generation unit 2043b. Then, the image acquisition unit 2041b outputs the acquired image identification information to the image identification information acquisition unit 2042b. After finishing step S2101, the routine proceeds to step S2003.

(Step S2003) The image processing unit 2004b performs step S2003 in the same manner as the third embodiment. After finishing step S2003, the routine proceeds to step S2102.

(Step S2102) Next, the region extraction unit 2341 extracts a region from which a main color is extracted, by a predetermined method from the image data which is output by the image identification information acquisition unit 2042b on the basis of the image capture information which is output by the image identification information acquisition unit 2042b.

Then, the region extraction unit 2341 extracts the image data of the extracted region from which the main color is extracted, from the image data which is output by the image identification information acquisition unit 2042b, and outputs the image data of the extracted region to the color-space vector generation unit 2043b. After finishing step S2102, the routine proceeds to step S2103.

(Step S2103) Next, the color-space vector generation unit 2043b converts the image data of the region which is output by the region extraction unit 2341 into a vector of a predetermined color space. Then, the color-space vector generation unit 2043b categorizes all the pixels of the image data into each of the generated color vectors, detects the frequency of each color vector, and generates frequency distribution of the color vector. Then, the color-space vector generation unit 2043b outputs the information indicating the generated frequency distribution of the color vector to the main color extraction unit 2044. After finishing step S2103, the routine proceeds to step S2005.

Then, the image processing unit 2004b performs steps S2005 to S2009 in the same manner as the third embodiment.

As described above, the image processing unit 2004b extracts the region from which the main color is extracted, from the captured image data on the basis of the image capture information such as the scene. Then, the image processing unit 2004b generates the label on the basis of the three main colors which are extracted from the image data of the region from which the main color is extracted, in the same manner as the third embodiment. As a result, because the image processing unit 2004b is configured to extract the main color from the image data of the region in accordance with the scene and to generate the label on the basis of the main color of the extracted region, it is possible to generate a label which is the most appropriate to the image data which conforms to the scene better in comparison with the third embodiment and the fourth embodiment.

### Sixth Embodiment

The third embodiment to the fifth embodiment are described using an example in which three colors are selected as the main colors from the image data which is selected by the user. The present embodiment is described using an example in which three or more colors are selected from the selected image data. Note that, a case in which the configuration of the image processing unit 2004 is the same as that of the third embodiment (FIG. 10) will be described.

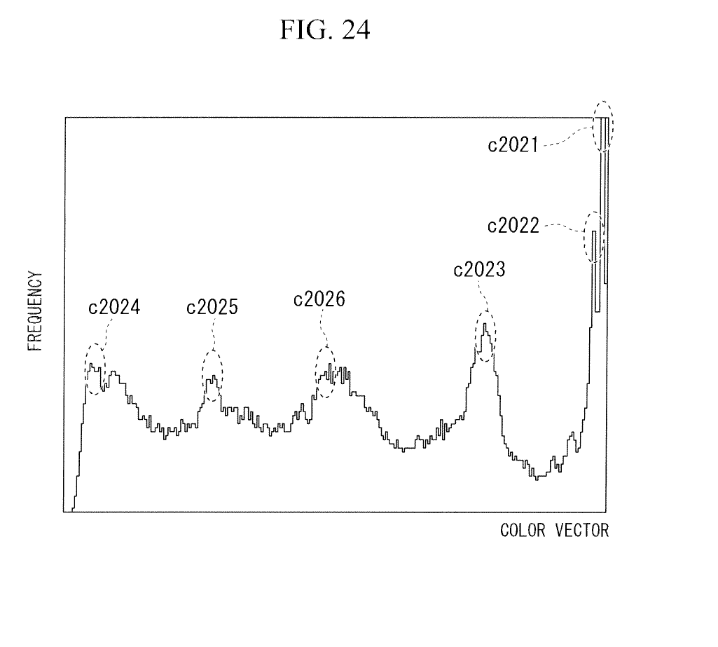

FIG. 24 is a diagram showing an example in which a plurality of color vectors are extracted from image data according to the present embodiment. In FIG. 24, the horizontal axis indicates a color vector, and the vertical axis indicates a frequency.

In FIG. 24, a case in which the main color extraction unit 2044 has extracted a color vector c2021 of the first color, a color vector c2022 of the second color, and a color vector c2023 of the third color in the same manner as FIG. 16B, is described.

In FIG. 24, in the case that the frequencies of color vectors c2024, c2025, and c2026 are within a predetermined range, the main color extraction unit 2044 extracts the color vectors c2024, c2025, and c2026 as a fourth main color. In this case, a label for each scene including the fourth color or the like other than the first color to the third color which are described in FIG. 12, is made to be stored in the table storage unit 2045.

Then, in the case that the fourth color is extracted, the main color extraction unit 2044 reads out the first label of the combination of the first color to the fourth color which is stored in the table storage unit 2045, and extracts the stored first label. In the case that a plurality of first labels of the combination of the first color to the fourth color are stored, the main color extraction unit 2044, for example, may select a first label which is firstly read out from the table storage unit 2045, or may select a first label randomly.

In addition, the main color extraction unit 2044 may select three colors as the main colors from the extracted four colors. In this case, the main color extraction unit 2044 may calculate a degree of similarity of the extracted four colors and calculate three colors having a low degree of similarity as the main colors. Regarding the degree of similarity of colors, for example, a case in FIG. 24 is described in which four color vectors of the color vectors c2022 to c2025 are supposed to be extracted as the first color to the fourth color. The main color extraction unit 2044 reduces the number of colors of the extracted four colors from an eight-bit color space to, for example, seven-bit color space. After the color reduction is performed, for example, in the case that the color vectors c2024 and c2025 are determined to the same color, the main color extraction unit 2044 determines the color vectors c2024 and c2025 as the similar colors. Then, the main color extraction unit 2044 selects any one of the color vectors c2024 and c2025 as the third main color. In this case, in the frequency distribution of FIG. 24, the main color extraction unit 2044 may select one color vector having a greater distance away in the horizontal axis direction from the color vector c2022 of the first color and the color vector c2023 of the second color, or may select one randomly.

In addition, in the case that the four vectors remains separated even after the color reduction into the seven-bit color space, the color-space vector generation unit 2043 performs the color reduction until the four color vectors are integrated as three color vectors.

As described above, because the image processing unit 2004 is configured such that a first label and four or more main colors for each scene which is the image capture information are preliminarily stored in the table storage unit 2045 and is configured to extract four or more main colors from the image data and to generate a label on the basis of the extracted main colors and the scene, it is possible generate a label which is the most appropriate to the image data better in comparison with the third embodiment to the fifth embodiment.

In other words, in the present embodiment, the image processing unit 2004 extracts four colors with a high frequency from the color vectors obtained by converting the image data into a color space, and extracts a first label which is preliminarily stored in connection with the extracted four colors. Because the first label is preliminarily stored in connection with the extracted four main color vectors for each image capture information such as each scene, time, or each season, the image processing unit 2004 can generate a first label which is different for each scene, time, and each season even in the case that the main colors which are extracted from the image data are the same. In addition, the image processing unit 2004 normalizes the frequency of the four main colors and generates a label by adding a second label which emphasizes the first label to the generated first label depending on the ratio of the first color with the highest frequency. As a result, the image processing unit 2004 can generate a label which is the most appropriate to the image data on the basis of the four main colors better in comparison with the third embodiment to the fifth embodiment.

Moreover, the image processing unit 2004 extracts three main colors by the color reduction or the like from the extracted four main colors and applies the label generation process to the extracted three main colors in the same manner as the third embodiment. As a result, the image processing unit 2004 can generate a label which is the most appropriate to the image data even for the image data having a small difference between the frequencies of the color vectors.

In addition, the present embodiment is described using an example in which four main colors are extracted from the image data. However, the number of the extracted main colors is not limited to four, but may be four or more. In this case, a first label which corresponds to the number of colors of the extracted main colors may be stored in the table storage unit 2045. In addition, for example, in the case that five colors are extracted as the main colors, as described above, the main color extraction unit 2044 may again extract three main colors from the extracted main colors by performing color reduction and integration into similar colors. In addition, for example, in the case that six colors are extracted as the main colors, firstly, the main color extraction unit 2044 separates the colors, in descending order of frequency, into a first group of the first color to the third color and a second group of the remaining fourth color to the sixth color. Note that, the number of pixels of the fourth color is smaller than that of third color and is greater than that of the fifth color. The number of pixels of the fifth color is smaller than that of the fourth color.

Then, the first-label generation unit 2046 extracts a first label corresponding to the first group and a first label corresponding to the second group. Then, the first-label generation unit 2046 may modify the two first labels which are extracted in such a way and generate a plurality of labels by making a modification label to qualify the first label depending on the frequency of the first color or the fourth color in the same manner as the third embodiment. Alternatively, the second-label generation unit 2047 may integrate the plurality of labels which are generated in such a way and generate one label. Specifically, in the case that the label according to the first group is “very fresh” and that the label according to the second group is “a little childish”, the second-label generation unit 2047 may generate a label, “very fresh and a little childish”. In such a case that two labels are generated, the second-label generation unit 2047 may include, within the second-label generation unit 2047, a process function unit which performs language analysis process (not shown in the drawings) that is used to confirm which one of the two labels should be arranged ahead in order to generate a suitable label.

In addition, the third embodiment to the sixth embodiment are described using an example in which one label is generated for one image data. However, the number of the generated labels may be two or more. In this case, the color-space vector generation unit 2043 (including 2043b), for example, divides the image data of FIG. 17A into an upper half portion and a lower half portion and generates frequency distribution of the color vector for each divided region. The main color extraction unit 2044 extracts three main colors for each divided region from the frequency distribution of the color vector for each divided region. Then, the first-label generation unit 2046 may extract the label for each region from the table storage unit 2045. Then, the label output unit 2048 may relate the plurality of labels which are generated in such a way to the image data and store the labels in association with the image data in the storage medium 2200.

Note that, the third embodiment to the fifth embodiment are described using an example in which three main colors and a first label are related for each scene and stored in the table storage unit 2045. However, for example, a single color and a first label may be related for each scene and stored in the table storage unit 2045. In this case, as is described in the third embodiment, the table storage unit 2045 may store three main colors in association with a first label for each scene, and further store a single color in association with a first label for each scene.

By using such a process, a suitable label can be generated for the image data from which only one main color can be extracted because the image data is monotone. In this case, for example, the image processing unit 2004 (2004a, 2004b) may detect four colors as the main colors in the same manner as the sixth embodiment, and read out a label from the table storage unit 2045 on the basis of the first group of the first color to the third color and only the remaining fourth color as the single color.

In addition, in the case that only two colors can be extracted as the main colors because the tone of the image data is monotonic, for example, the first-label generation unit 2046 reads out each first label for each of the extracted two main colors (the first color and the second color). Next, the second-label generation unit 2047 may normalize the two main colors on the basis of the frequencies of the extracted two main colors, generate a modification label with respect to the label for the first color on the basis of the ratio of the first color, and modify the first label for the first color by qualifying the first label for the first color with the generated modification label, thereby generating a second label for the first color. Alternatively, the second-label generation unit 2047 may generate two labels which are the first label for the first color and the first label for the second color, which are generated as described above, or may generate one label by integrating the first label for the first color and the first label for the second color.

In addition, the third embodiment to the sixth embodiment are described using an example in which the image data that is selected by the user is read out from the storage medium 2200. However, when RAW (RAW) data and JPEG (Joint Photographic Experts Group) data are stored in the storage medium 2200 as the image data which is used for the label generation process, any one of the RAW data and the JPEG data may be used. In addition, in the case that thumbnail (thumbnail) image data which is reduced in size for display on the display unit 2007 is stored in the storage medium 2200, a label may be generated by using this thumbnail image data. In addition, when the thumbnail image data is not stored in the storage medium, the color-space vector generation unit 2043 (including 2043b) may generate image data which is obtained by reducing the resolution of the image data that is output by the image acquisition unit 2041 (including 2041a and 2041b) to a predetermined resolution, and extract the frequency of the color vector and the main color from this reduced image data.

In addition, the process of each unit may be implemented by storing a program for performing each function of the image processing unit 2004 shown in FIG. 10, the image processing unit 2004a shown in FIG. 21, or the image processing unit 2004b shown in FIG. 22 of the embodiment in a recording medium which is capable of being read by a computer, causing the program recorded in this recording medium to be read by a computer system, and executing the program. In addition, the program described above may be configured to implement a part of the function described above. Furthermore, the program may be configured to implement the function described above in combination with a program already recorded in the computer system.

### Seventh Embodiment

The functional block diagram of the imaging apparatus according to the present embodiment is the same as the one which is shown in FIG. 8 according to the second embodiment.

Hereinafter, a part which is different from the second embodiment will be described in detail.

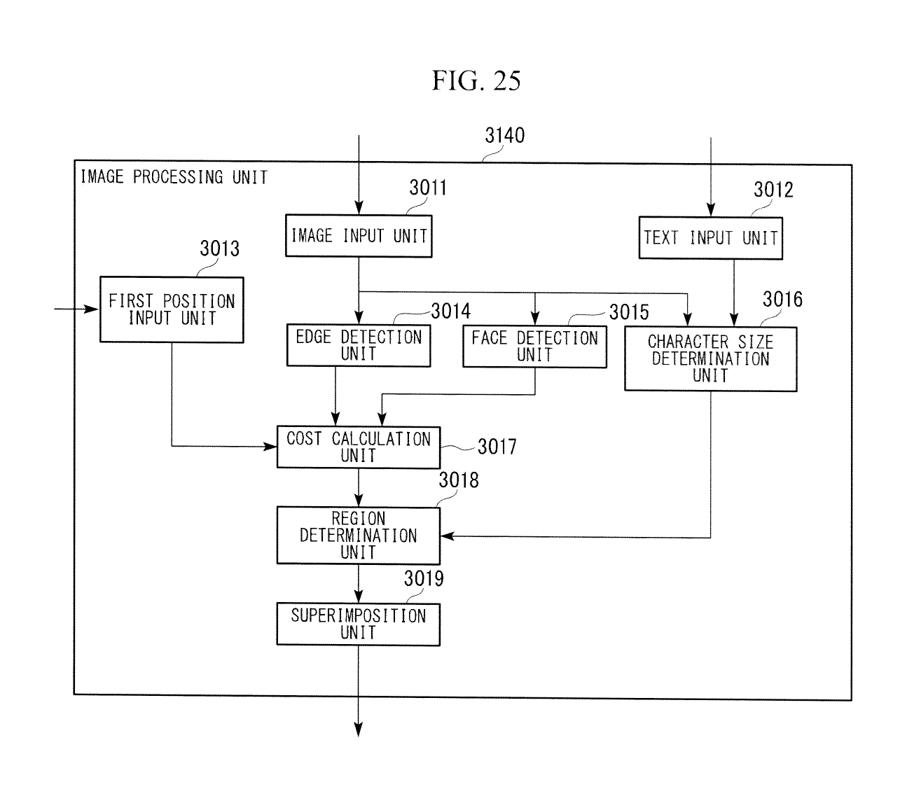

FIG. 25 is a block diagram showing a functional configuration of an image processing unit 3140 (image processing unit 1140 in FIG. 8) according to the present embodiment.

The image processing unit (image processing apparatus) 3140 is configured to include an image input unit 3011, a text input unit 3012, a first position input unit 3013, an edge detection unit 3014, a face detection unit 3015, a character size determination unit 3016, a cost calculation unit 3017, a region determination unit 3018, and a superimposition unit 3019.

The image input unit 3011 inputs image data of a still image or image data of a moving image. The image input unit 3011 outputs the input image data to the edge detection unit 3014 and the character size determination unit 3016. Note that, the image input unit 3011, for example, may input the image data via a network or a storage medium. Hereinafter, an image which is presented by the image data that is input to the image input unit 3011 is referred to as an input image. In addition, an X-Y coordinate system is defined by setting the width direction of the square image format of the input image as the X-axis direction and setting the direction which is perpendicular to the X-axis direction (the height direction) as the Y-axis direction.

The text input unit 3012 inputs text data corresponding to the input image. The text data corresponding to the input image is data relating to a text which is superimposed on the input image and includes a text, an initial character size, a line feed position, the number of rows, the number of columns, and the like. The initial character size is an initial value of a character size of a text and is a character size which is designated by a user. The text input unit 3012 outputs the text data which is input, to the character size determination unit 3016.

The first position input unit 3013 accepts an input of a position of importance (hereinafter, referred to as an important position (a first position)) in the input image. For example, the first position input unit 3013 displays the input image on the display unit 1150 and sets a position which is designated by the user via a touch panel that is provided in the display unit 1150, as the important position. Alternatively, the first position input unit 3013 may accept an input of a coordinate value (x₀, y₀) of the important position directly. The first position input unit 3013 outputs the coordinate value (x₀, y₀) of the important position to the cost calculation unit 3017. Note that, the first position input unit 3013 sets a predetermined position which is preliminarily set (for example, the center of the input image) as the important position in the case that there is no input of the important position from the user.

The edge detection unit 3014 detects an edge in the image data which is input from the image input unit 3011 by using, for example, a Canny algorithm. Then, the edge detection unit 3014 outputs the image data and data indicating the position of the edge which is detected from this image data, to the cost calculation unit 3017. Note that, in the present embodiment, the edge is detected by using the Canny algorithm, however, for example, an edge detection method using a differential filter, a method of detecting an edge on the basis of the high-frequency component of the results which are obtained by performing two-dimensional Fourier transform, or the like, may be used.

The face detection unit 3015 detects a face of a person in the image data which is input from the image input unit 3011 by using pattern matching or the like. Then, the face detection unit 3015 outputs the image data and the data indicating the position of the face of the person which is detected from this image data, to the cost calculation unit 3017.

The character size determination unit 3016 determines the character size of the text data on the basis of the image size (width and height) of the image data which is input from the image input unit 3011 and the number of rows and the number of columns of the text data which is input from the text input unit 3012. Specifically, the character size determination unit 3016 sets “f” which satisfies the following expression (5) as the character size such that all the texts in the text data can be superimposed on the image data.

[Equation 3]

f×m<w AND f{l+(l−1)L}<h (5)

Where, “m” is the number of columns of the text data, and “1” is the number of rows of the text data. In addition, “L” (≧0) is a parameter indicating the ratio of the line space to the size of the character. In addition, “w” is the width of the image region in the image data, and “h” is the height of the image region in the image data. Expression (5) indicates that the width of the text is smaller than the width of the image region in the image data, and that the height of the text is smaller than the height of the image region in the image data.

For example, in the case that the initial character size which is included in the text data does not satisfy expression (5), the character size determination unit 3016 gradually reduces the character size until expression (5) is satisfied. On the other hand, in the case that the initial character size which is included in the text data satisfies expression (5), the character size determination unit 3016 sets the initial character size which is included in the text data to the character size of the text data. Then, the character size determination unit 3016 outputs the text data and the character size of the text data to the region determination unit 3018.

The cost calculation unit 3017 calculates the cost of each coordinate position (x, y) in the image data on the basis of a position of an edge, a position of a face of a person, and an important position in the image data. The cost represents the degree of importance in the image data. For example, the cost calculation unit 3017 calculates the cost of each position such that the cost of the position, where the edge which is detected by the edge detection unit 3014 is positioned, is set to be high. In addition, the cost calculation unit 3017 sets the cost to be higher as the position is closer to the important position and sets the cost to be lower as the position is farther from the important position. In addition, the cost calculation unit 3017 sets the cost of the region where the face of the person is positioned to be high.

Specifically, firstly, the cost calculation unit 3017, for example, generates a global cost image c_{g} (x, y) indicating a cost on the basis of the important position (x₀, y₀) by using a Gaussian function which is represented by the following expression (6).

$$\begin{matrix}[ Equation 4 ] & \\ {c}_{g} ( x , y ) = exp [ - \frac{1}{{S}_{1}} {( x - {x}_{0} )}^{2} - \frac{1}{{S}_{2}} {( y - {y}_{0} )}^{2} ] & ( 6 )\end{matrix}$$

Where, x₀ is an X-coordinate value of the important position, and y₀ is a Y-coordinate value of the important position. In addition, S₁ (>0) is a parameter which determines the way in which the cost is broadened in the width direction (X-axis direction), and S₂ (>0) is a parameter which determines the way in which the cost is broadened in the height direction (Y-axis direction). The parameter S and the parameter S₂ are, for example, settable by the user via a setting window or the like. By changing the parameter S₁ and the parameter S₂, it is possible to adjust the shape of distribution in the global cost image. Note that, in the present embodiment, the global cost image is generated by a Gaussian function. However, for example, the global cost image may be generated by using a function having distribution in which the value is greater as the position is closer to the center, such as a cosine function ((cos(πx)+1)/2, where −1≦x≦1), a function which is represented by a line having a triangular shape (pyramidal shape) and having a maximum value at the origin x=0, or a Lorentzian function (1/(ax²+1), a is a constant).

Next, the cost calculation unit 3017 generates a face cost image c_{f} (x, y) indicating a cost on the basis of the position of the face of the person using the following expression (7) and expression (8).

$$\begin{matrix}[ Equation 5 ] & \\ {c}_{f} ( x , y ) = \{ \begin{matrix}1 & {x}_{-}^{( i )} \leq x < {x}_{+}^{( i )} AND {y}_{-}^{( i )} \leq y < {y}_{+}^{( i )} \\ 0 & OTHERS\end{matrix} & ( 7 ) \\ [ Equation 6 ] & \\ {x}_{\pm } = {x}^{( i )} \pm \frac{{s}^{( i )}}{2} , \\ {y}_{\pm } = {y}^{( i )} \pm \frac{{s}^{( i )}}{2} & ( 8 )\end{matrix}$$

Where, (x⁽ⁱ⁾, y⁽ⁱ⁾) represents a center position of the i-th (1≦i≦n) face of the detected n faces, and s⁽ⁱ⁾ represents the size of the i-th face. In other words, the cost calculation unit 3017 generates a face cost image in which the pixel value in the region of the face of the person is set to “1”, and the pixel value in the region other than the face is set to “0”.

Next, the cost calculation unit 3017 generates an edge cost image cₑ (x, y) indicating a cost on the basis of the edge by using the following expression (9).

$$\begin{matrix}[ Equation 7 ] & \\ {c}_{e} ( x , y ) = \{ \begin{matrix}1 & EDGE PORTION \\ 0 & OTHERS\end{matrix} & ( 9 )\end{matrix}$$

Namely, the cost calculation unit 3017 generates an edge cost image in which the pixel value of the edge portion is set to “1”, and the pixel value in the region other than the edge is set to “0”. Note that, the edge portion may be a position where the edge is positioned or may be a region including the position where the edge is positioned and the neighboring part.

Then, the cost calculation unit 3017 generates a final cost image c (x, y) on the basis of the global cost image, the face cost image, and the edge cost image by using the following expression (10).

$$\begin{matrix}[ Equation 8 ] & \\ c ( x , y ) = \frac{{C}_{g} {c}_{g} ( x , y ) + {C}_{f} {c}_{f} ( x , y ) + {C}_{e} {c}_{e} ( x , y )}{{C}_{g} + {C}_{f} + {C}_{e}} & ( 10 )\end{matrix}$$

Where, Cₐ (≧0) is a parameter indicating a weighting coefficient of the global cost image, C_{f} (≧0) is a parameter indicating a weighting coefficient of the face cost image, and Cₑ (≧0) is a parameter indicating a weighting coefficient of the edge cost image. The ratio of the parameter C_{g}, the parameter Cₑ, and the parameter C_{f} is changeably settable by the user via a setting window or the like. In addition, the final cost image c (x, y) which is represented by expression (10) is normalized as 0≦c (x, y)≦1. The cost calculation unit 3017 outputs the image data and the final cost image of the image data to the region determination unit 3018. Note that, the parameter C_{g}, the parameter Cₑ, and the parameter C_{f}, may be one or less.

Note that, the image processing unit 3140 may be configured to change the ratio of the parameter C_{g}, the parameter Cₑ, and the parameter C_{f} automatically depending on the input image. For example, in the case that the input image is a scenery image, the parameter C_{g} is set to be greater than the other parameters. In addition, in the case that tie input image is a portrait (person image), the parameter C_{f} is set to be greater than the other parameters. In addition, in the case that the input image is a construction image in which a lot of constructions such as buildings are captured, the parameter Cₑ is set to be greater than the other parameters. Specifically, the cost calculation unit 3017 determines that the input image is a portrait in the case that a face of a person is detected by the face detection unit 3015, and sets the parameter C_{f} to be greater than the other parameters. On the other hand, the cost calculation unit 3017 determines that the input image is a scenery image in the case that a face of a person is not detected by the face detection unit 3015, and sets the parameter C_{g} to be greater than the other parameters. In addition, the cost calculation unit 3017 determines that the input image is a construction image in the case that the edge which is detected by the edge detection unit 3014 is greater than a predetermined value, sets the parameter Cₑ to be greater than the other parameters.

Alternatively, the image processing unit 3140 may have a mode of a scenery image, a mode of a portrait, and a mode of a construction image, and may change the ratio of the parameter C_{g}, the parameter Cₑ, and the parameter C_{f}, depending on the mode which is currently set in the image processing unit 3140.

In addition, in the case that the image data is a moving image, the cost calculation unit 3017 calculates an average value of the costs of a plurality of frame images which are included in the image data of the moving image for each coordinate position. Specifically, the cost calculation unit 3017 acquires the frame images of the moving image with a predetermined interval of time (for example, three seconds), and generates a final cost image for each acquired frame image. Then, the cost calculation unit 3017 generates an average final cost image which is obtained by averaging the final cost images of each frame image. The pixel value of each position in the average final cost image is an average value of the pixel values of each position in each final cost image.

Note that, in the present embodiment, an average value of the costs of a plurality of frame images is calculated, however, for example, a sum value may be calculated.

The region determination unit 3018 determines a superimposed region, on which a text is superimposed, in the image data on the basis of the final cost image which is input by the cost calculation unit 3017 and the character size of the text data which is input by the character size determination unit 3016. Specifically, firstly, the region determination unit 3018 calculates the width wₜₑₓₜ and the height hₜₑₓₜ of a text rectangular region which is a rectangular region where a text is displayed on the basis of the number of rows and the number of columns of the text data and the character size. The text rectangular region is a region which corresponds to the superimposed region. Next, the region determination unit 3018 calculates a summation c*ₜₑₓₜ (x, y) of the costs within the text rectangular region for each coordinate position (x, y) using the following expression (11).

$$\begin{matrix}[ Equation 9 ] & \\ {c}_{test}^{*} ( x , y ) = {\sum }_{u = 0}^{{w}_{text} - 1} {\sum }_{v = 0}^{{h}_{text} - 1} c ( x + u , y + v ) & ( 11 )\end{matrix}$$

Then, the region determination unit 3018 sets a coordinate position (x, y) where the summation c*ₜₑₓₜ (x, y) of the costs within the text rectangular region is minimum, to a superimposed position of the text. In other words, the region determination unit 3018 sets a text rectangular region of which the upper left vertex is set to a coordinate position (x, y) where the summation c*ₜₑₓₜ (x, y) of the costs within the text rectangular region is minimum, to a superimposed region of the text. The region determination unit 3018 outputs the image data, the text data, and the data indicating the superimposed region of the text, to the superimposition unit 3019. Note that, in the present embodiment, the region determination unit 3018 determines the superimposed region on the basis of the summation (sum value) of the costs within the text rectangular region. However, for example, a region of which an average value of the costs within the text rectangular region is the smallest may be set to the superimposed region. Alternatively, the region determination unit 3018 may set a region of which a weighting average value of the costs that is obtained by weighting the center of the text rectangular region is the smallest, to the superimposed region.

The superimposition unit 3019 inputs the image data, the text data, and the data indicating the superimposed region of the text. The superimposition unit 3019 generates and outputs image data of the superimposed image which is obtained by superimposing the text of the text data on the superimposed region of the image data.

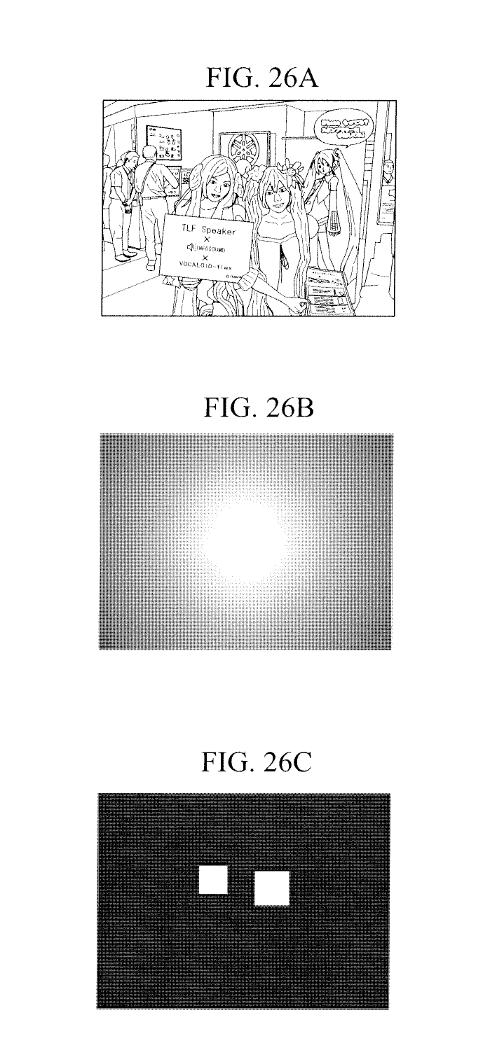

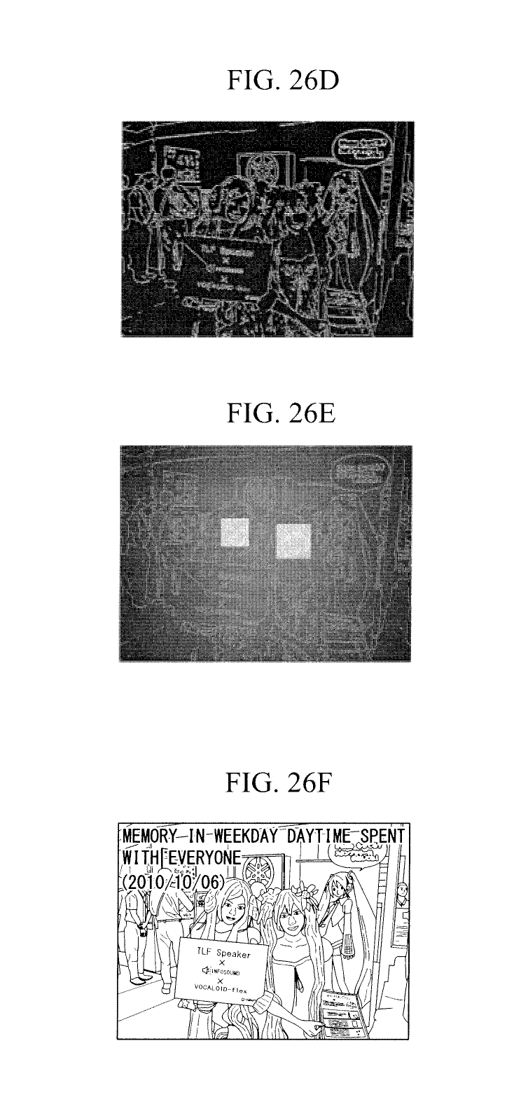

FIGS. 26A to 26F are image diagrams showing an example of the input image, the cost image, and the superimposed image according to the present embodiment.

FIG. 26A shows an input image. FIG. 26B shows a global cost image. In the example shown in FIG. 26B, the center of the input image is the important position. As is shown in FIG. 26B, the pixel value of the global cost image is closer to “1” as the position is closer to the center, and is closer to “0” as the position is farther from the center. FIG. 26C shows a face cost image. As is shown in FIG. 26C, the pixel value of the face cost image is “1” in the region of the face of the person, and is “0” in the region other than the face of the person. FIG. 26D shows an edge cost image. As is shown in FIG. 26D, the pixel value of the edge cost image is “1” in the edge portion, and is “0” in the region other than the edge portion.

FIG. 26E shows a final cost image which is the combination of the global cost image, the face cost image, and the edge cost image. FIG. 26F shows a superimposed image which is obtained by superimposing a text on the input image. As is shown in FIG. 26F, the text of the text data is superimposed on a region of which the summation of the costs in the final cost image is small.

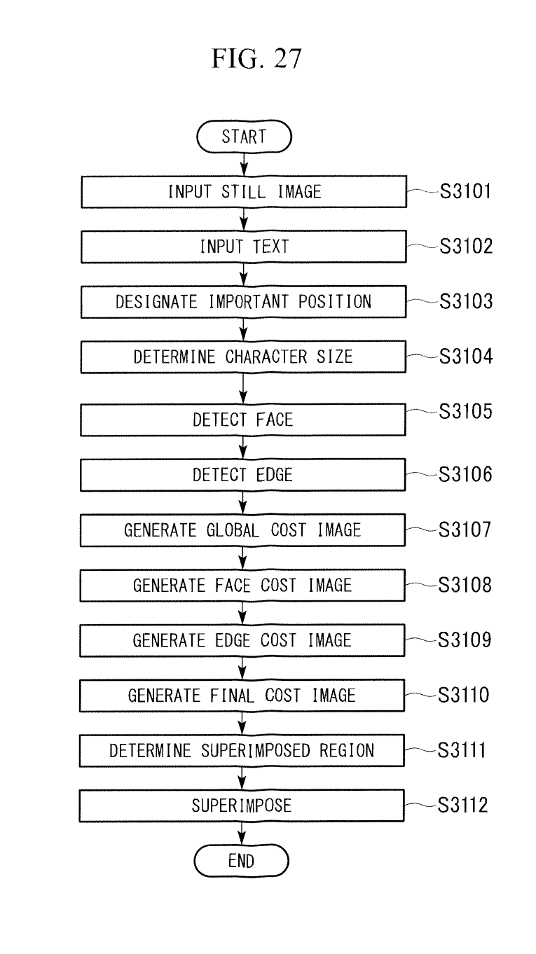

Next, with reference to FIG. 27, a superimposing process of a still image by the image processing unit 3140 will be described.

FIG. 27 is a flowchart showing a procedure of the superimposing process of the still image according to the present embodiment.

Firstly, in step S3101, the image input unit 3011 accepts an input of image data of a still image (hereinafter, referred to as still image data).

Next, in step S3102, the text input unit 3012 accepts an input of text data which corresponds to the input still image data.

Then, in step S3103, the first position input unit 3013 accepts an input of an important position in the input still image data.

Next, in step S3104, the character size determination unit 3016 determines the character size of the text data on the basis of the size of the input still image data and the number of rows and the number of columns of the input text data.

Next, in step S3105, the face detection unit 3015 detects the position of the face of the person in the input still image data.

Next, in step S3106, the edge detection unit 3014 detects the position of the edge in the input still image data.

Then, in step S3107, the cost calculation unit 3017 generates a global cost image on the basis of the designated (input) important position. In other words, the cost calculation unit 3017 generates a global cost image in which the cost is higher as the position is closer to the important position and the cost is lower as the position is farther from the important position.

Next, in step S3108, the cost calculation unit 3017 generates a face cost image on the basis of the position of the detected face of the person. In other words, the cost calculation unit 3017 generates a face cost image in which the cost in the region of the face of the person is high and the cost in the region other than the face of the person is low.

Next, in step S3109, the cost calculation unit 3017 generates an edge cost image on the basis of the position of the detected edge. In other words, the cost calculation unit 3017 generates an edge cost image in which the cost in the edge portion is high and the cost in the region other than the edge is low.

Then, in step S3110, the cost calculation unit 3017 generates a final cost image by combining the generated global cost image, the generated face cost image, and the generated edge cost image.

Next, in step S3111, the region determination unit 3018 determines the superimposed region of the text in the still image data on the basis of the generated final cost image and the determined character size of the text data.

Finally, in step S3112, the superimposition unit 3019 combines the still image data and the text data by superimposing the text of the text data on the determined superimposed region.

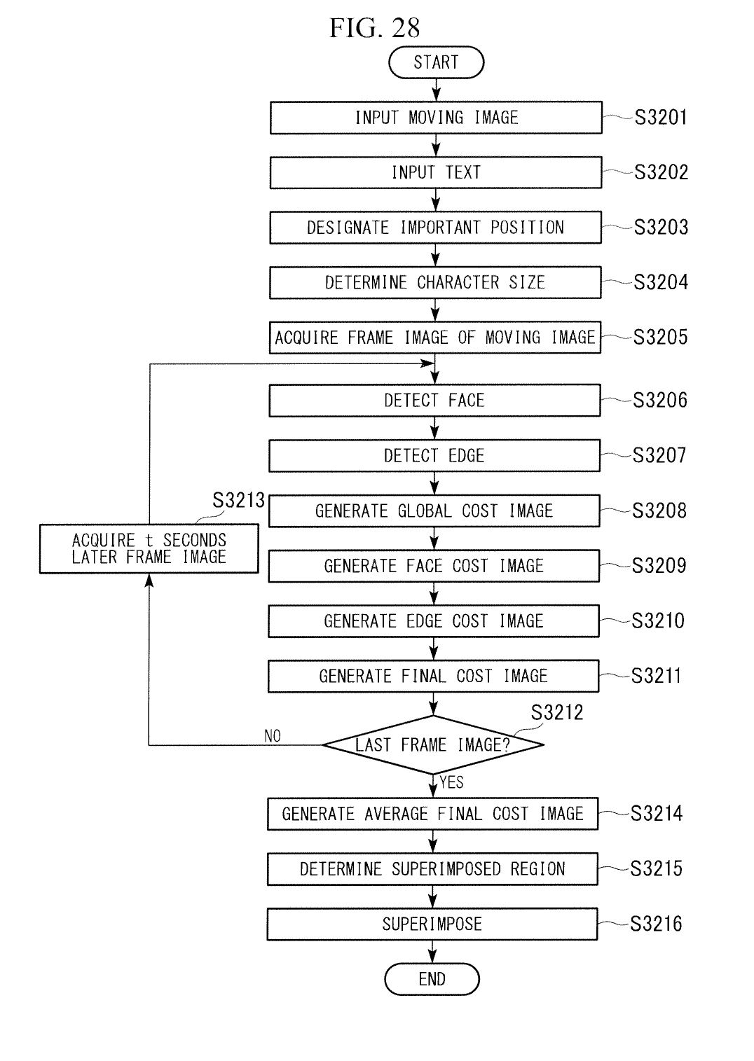

Next, with reference to FIG. 28, a superimposing process of a moving image by the image processing unit 3140 will be described. FIG. 28 is a flowchart showing a procedure of the superimposing process of the moving image according to the present embodiment.

Firstly, in step S3201, the image input unit 3011 accepts an input of image data of a moving image (hereinafter, referred to as moving image data).

Next, in step S3202, the text input unit 3012 accepts an input of text data which corresponds to the input moving image data.

Next, in step S3203, the first position input unit 3013 accepts a designation of an important position in the input moving image data.

Then, in step S3204, the character size determination unit 3016 determines the character size of the text data on the basis of the size of the moving image data and the number of rows and the number of columns of the text data.

Next, in step S3205, the cost calculation unit 3017 acquires an initial frame image from the moving image data.

Then, in step S3206, the face detection unit 3015 detects the position of the face of the person in the acquired moving frame image.

Next, in step S3207, the edge detection unit 3014 detects the position of the edge in the acquired frame image.

Then, in step S3208 to step S3211, the cost calculation unit 3017 performs a process which is the same as that in step S3107 to step S3110 to step S3110 in FIG. 27.

Next, in step S3212, the cost calculation unit 3017 determines whether or not the current frame image is the last frame image in the moving image data.

In the case that the current frame image is not the last frame image (step S3212: No), in step S3213, the cost calculation unit 3017 acquires a frame image which is a later frame image of the current frame image by a predetermined length of time: t seconds (for example, three seconds), from the moving image data. Then, the routine returns to step S3206.

On the other hand, in the case that the current frame image is the last frame in the moving image data (step S3212: Yes), in step S3214, the cost calculation unit 3017 generates an average final cost image which is obtained by averaging the final cost images of each frame image. The pixel value of each coordinate position in the average final cost image is an average value of the pixel values of each coordinate position in each of the final cost images of each frame image.

Next, in step S3215, the region determination unit 3018 determines the superimposed region of the text in the moving image data on the basis of the generated average final cost image and the determined character size of the text data.

Finally, in step S3216, the superimposition unit 3019 combines the moving image data and the text data by superimposing the text of the text data on the determined superimposed region.

Note that, in the present embodiment, the superimposed region in the entire moving image data is determined on the basis of the average final cost image. However, the superimposed region may be determined for each predetermined length of time of the moving image data. For example, the image processing unit 3140 determines a superimposed region r₁ on the basis of the initial frame image to the superimposed region of the frame images from 0 second to t−1 second, determines a superimposed region r₂ on the basis of the frame image of t second to the superimposed region of the frame images from t second to 2t−1 second, and subsequently determines a superimposed region of each frame image in the same manner. As a consequence, the text can be superimposed on the best position in accordance with the movement of the object in the moving image data.

As is described above, according to the present embodiment, the image processing unit 3140 determines the superimposed region on which the text is superimposed on the basis of the edge cost image which indicates the cost regarding the edge in the image data. Therefore, it is possible to superimpose the text on a region having a small number of edges (namely, a region in which a complex texture does not exist). Thereby, because it is possible to prevent the outline of the font which is used to display the text from overlapping the edge of the texture, it is possible to superimpose the text within the input image such that the text is easy for a viewer to read.

In addition, in the case that the position where the text is displayed is fixed, the proper impression of the input image may be degraded because the text overlaps with the imaged object or the person, the object, or the background of attention, or the like, depending on the content of the input image or the quantity of the text. Because the image processing unit 3140 according to the present embodiment determines the superimposed region on which the text is superimposed on the basis of the face cost image which indicates the cost regarding the face of the person in the image data, it is possible to superimpose the text on the region other than the face of the person. In addition, because the image processing unit 3140 determines the superimposed region on which the text is superimposed on the basis of the global cost image which indicates the cost regarding the important position in the image data, it is possible to superimpose the text on the region away from the important position. For example, in most images, because the imaged object is positioned at the center portion, it is possible to superimpose the text on the region other than the imaged object, by setting the center portion to the important position. Moreover, because in the image processing unit 3140 according to the present embodiment, the important position can be designated by the user, it is possible to change the important position for each input image, for example, by setting a center portion to the important position for an input image A and setting an edge portion to the important position for an input image B, or the like.

In addition, according to the present embodiment, because the image processing unit 3140 determines the superimposed region on which the text is superimposed on the basis of the final cost image which is the combination of the global cost image, the face cost image, and the edge cost image, it is possible to superimpose the text on the comprehensively best position.

In the case that the character size is fixed, there may be a case in which the relative size of the text with respect to the image data is drastically changed depending on the image size of the input image and therefore the display of the text becomes inappropriate to a viewer. For example, in the case that the character size of the text data is great relative to the input image, there may be a case in which the entire text does not fall within the input image and therefore it is impossible to read the sentence. According to the present embodiment, because the image processing unit 3140 changes the character size of the text data in accordance with the image size of the input image, it is possible to accommodate the entire text within the input image.

In addition, according to the present embodiment, the image processing unit 3140 is capable of superimposing a text on the image data of a moving image. Thereby, for example, the present invention is applicable to a service in which a comment from the user is dynamically displayed in the image when the moving image is distributed via the broadcast, the internet, and the like, and is played, or the like. In addition, because the image processing unit 3140 determines the superimposed region by using the average final cost image of a plurality of frame images, it is possible to superimpose the text on the comprehensively best region while taking the movement of the imaged object in the whole moving image into account.

### Eighth Embodiment

Next, an image processing unit (image processing apparatus) 3140a according to an eighth embodiment of the present invention will be described.

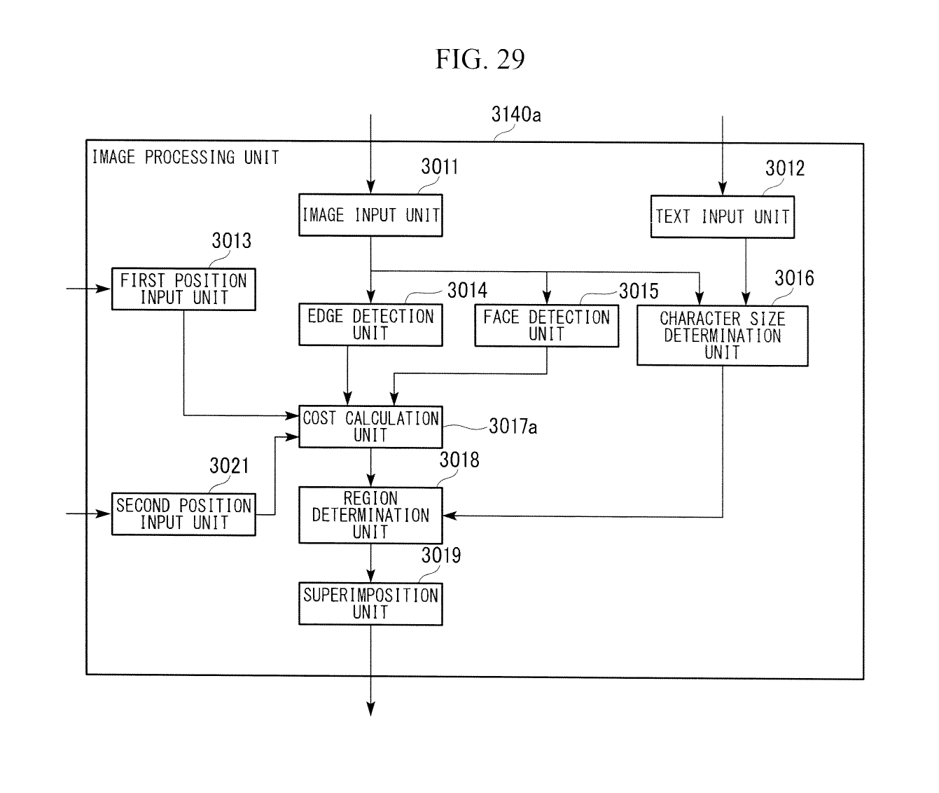

FIG. 29 is a block diagram showing a functional configuration of the image processing unit 3140a according to the present embodiment. In the present figure, units which are the same as those in the image processing unit 3140 shown in FIG. 25 are denoted by the same reference numerals, and explanation thereof will be omitted. The image processing unit 3140a includes a second position input unit 3021 in addition to the configuration of the image processing unit 3140 shown in FIG. 25.

The second position input unit 3021 accepts an input of a position where the text is superimposed in the image data (hereinafter, referred to as a text position (second position)). For example, the second position input unit 3021 displays the image data which is input to the image input unit 3011 on the display unit 1150 and sets the position which is designated by the user via the touch panel that is provided in the display unit 1150, to the text position. Alternatively, the second position input unit 3021 may directly accept an input of a coordinate value (x₁, y₁) of the text position. The second position input unit 3021 outputs the coordinate value (x₁, y₁) of the text position to the cost calculation unit 3017a.

The cost calculation unit 3017a calculates the cost of each coordinate position (x, y) in the image data on the basis of the text position (x₁, y₁) which is input by the second position input unit 3021, the position of the edge in the image data, the position of the face of the person, and the important position. Specifically, the cost calculation unit 3017a generates a final cost image by combining a text position cost image which indicates the cost on the basis of the text position (x₁, y₁), the global cost image, the face cost image, and the edge cost image. The method of generating the global cost image, the face cost image, and the edge cost image is the same as that of the seventh embodiment.

The cost calculation unit 3017a generates the text position cost image cₜ (x, y) by using the following expression (12).

$$\begin{matrix}[ Equation 10 ] & \\ {c}_{t} ( x , y ) = 1 - exp [ - \frac{1}{{S}_{3}} {( x - {x}_{1} )}^{2} - \frac{1}{{S}_{4}} {( y - {y}_{1} )}^{2} ] & ( 12 )\end{matrix}$$

Where, S₃ (>0) is a parameter which determines the way in which the cost is broadened in the width direction (X-axis direction), and S₄ (>0) is a parameter which determines the way in which the cost is broadened in the height direction (Y-axis direction). The text position cost image is an image in which the cost is lower as the position is closer to the text position (x₁, y₁) and the cost is higher at positions further from the text position.

Then, the cost calculation unit 3017a generates a final cost image c (x, y) by using the following expression (13).

$$\begin{matrix}[ Equation 11 ] & \\ c ( x , y ) = \frac{{C}_{g} {c}_{g} ( x , y ) + {C}_{f} {c}_{f} ( x , y ) + {C}_{e} {c}_{e} ( x , y ) + {C}_{t} {c}_{t} ( x , y )}{{C}_{g} + {C}_{f} + {C}_{e} + {C}_{t}} & ( 13 )\end{matrix}$$

Where, Cₜ (≧0) is a parameter of a weighting coefficient of the text position cost image.

Expression (13) is an equation in which Cₜ is added to the denominator of expression (10) and Cₜcₜ (x, y) is added to the numerator. Note that, in the case that the text position is not designated by the second position input unit 3021, the cost calculation unit 3017a does not generate the text position cost image and generates the final cost image by using the above-described expression (10). Alternatively, in the case that the text position is not designated by the second position input unit 3021, the cost calculation unit 3017a sets the parameter Cₜ as Cₜ=0.

In addition, in the case that the image data is a moving image, the cost calculation unit 3017a calculates an average value of the costs of a plurality of frame images which are included in the image data of the moving image for each coordinate position. Specifically, the cost calculation unit 3017a acquires the frame images of the moving image with a predetermined interval of time (for example, three seconds), and generates a final cost image for each acquired frame image. Then, the cost calculation unit 3017a generates an average final cost image which is obtained by averaging the final cost images of each frame image.

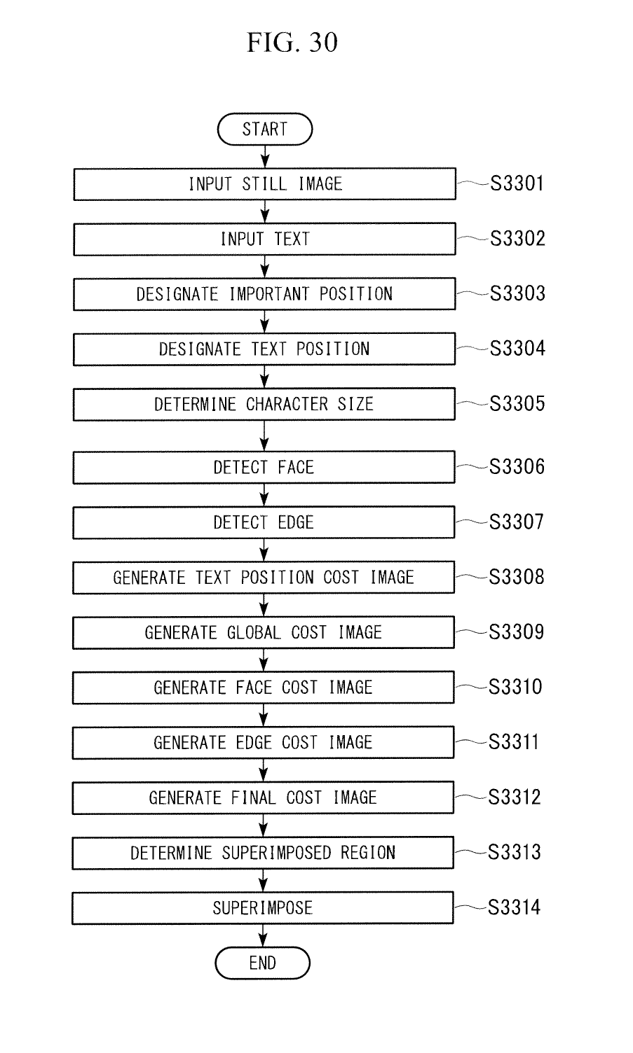

Next, with reference to FIG. 30, a superimposing process by the image processing unit 3140a will be described. FIG. 30 is a flowchart showing a procedure of the superimposing process according to the present embodiment.

The processes shown in steps S3301 to S3303 are the same as the processes shown in above-described steps S3101 to S3103.

Following step S3303, in step S3304, the second position input unit 3021 accepts a designation of the text position in the input image data.

The processes shown in steps S3305 to S3307 are the same as the processes shown in above-described steps S3104 to S3106.

Following step S3307, in step S3308, the cost calculation unit 3017a generates a text position cost image on the basis of the designated text position.

The processes shown in steps S3309 to S3311 are the same as the processes shown in above-described steps S3107 to S3109.

Following step S3311, in step S3312, the cost calculation unit 3017a combines the text position cost image, the global cost image, the face cost image, and the edge cost image, and generates a final cost image.

Next, in step S3313, the region determination unit 3018 determines the superimposed region of the text in the image data on the basis of the generated final cost image and the determined character size of the text data.

Finally, in step S3314, the superimposition unit 3019 combines the image data and the text data by superimposing the text of the text data on the determined superimposed region.

Note that, in the present embodiment, the text position is designated in the second position input unit 3021. However, for example, a region on which the user wants to superimpose the text may be designated. In this case, the cost calculation unit 3017a generates a text position cost image in which the pixel value of the designated region is set to “0” and the pixel value of the region other than the designated region is set to “1”. In other words, the cost calculation unit 3017a sets the cost of the designated region to be low.

As is described above, according to the present embodiment, the user can designate the position where the text is superimposed, and the image processing unit 3140a sets the cost of the designated text position to be low and determines the superimposed region. Thereby, in addition to the same effect as the seventh embodiment, it is possible to select the position which is designated by the user preferentially as the superimposed region of the text data.

### Ninth Embodiment

Next, an image processing unit (image processing apparatus) 31140b according to a ninth embodiment of the present invention will be described.

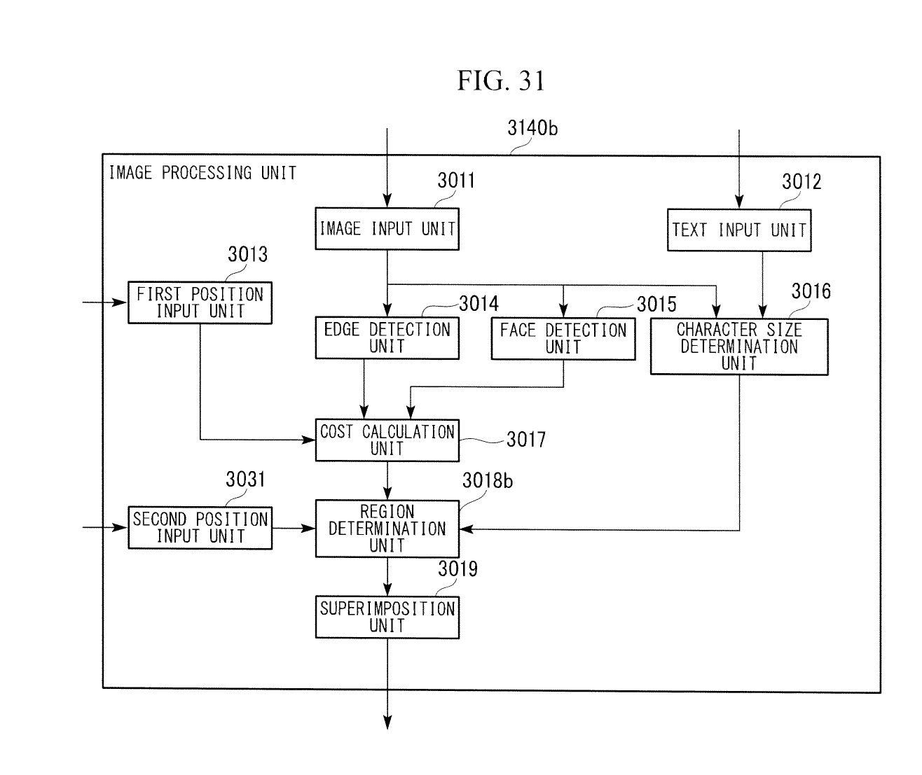

FIG. 31 is a block diagram showing a functional configuration of the image processing unit 3140b according to the present embodiment. In the present figure, units which are the same as those in the image processing unit 3140 shown in FIG. 25 are denoted by the same reference numerals, and an explanation thereof will be omitted here. The image processing unit 3140b includes a second position input unit 3031 in addition to the configuration of the image processing unit 3140 shown in FIG. 25.

The second position input unit 3031 accepts an input of a text position (second position) in any one of the X-axis direction (width direction) and the Y-axis direction (height direction). The text position is a position where a text is superimposed in the image data. For example, the second position input unit 3031 displays the image data which is input to the image input unit 3011 on the display unit 1150 and sets the position which is designated by the user via the touch panel that is provided in the display unit 1150, as the text position. Alternatively, the second position input unit 3031 may accept an input of an X-coordinate value x₂ or a Y-coordinate value y₂ of the text position directly. The second position input unit 3031 outputs the X-coordinate value x₂ or the Y-coordinate value y₂ of the text position to the region determination unit 3018b.

In the case where a position x₂ in the width direction is designated via the second position input unit 3031, the region determination unit 3018b calculates the Y-coordinate value yₘᵢₙ at which c*ₜₑₓₜ (x₂, y) is minimized while fixing the X-coordinate value to x₂ in the above-described expression (11). Then, the region determination unit 3018b sets the position (x₂, yₘᵢₙ) to the superimposed position.

In addition, in the case that a position Y₂ in the height direction is designated via the second position input unit 3031, the region determination unit 3018b calculates xₘᵢₙ where c*ₜₑₓₜ (x, y₂) is minimized while fixing the Y-coordinate value to y₂ in the above-described expression (11). Then, the region determination unit 3018b sets the position (xₘᵢₙ, y₂) to the superimposed position.

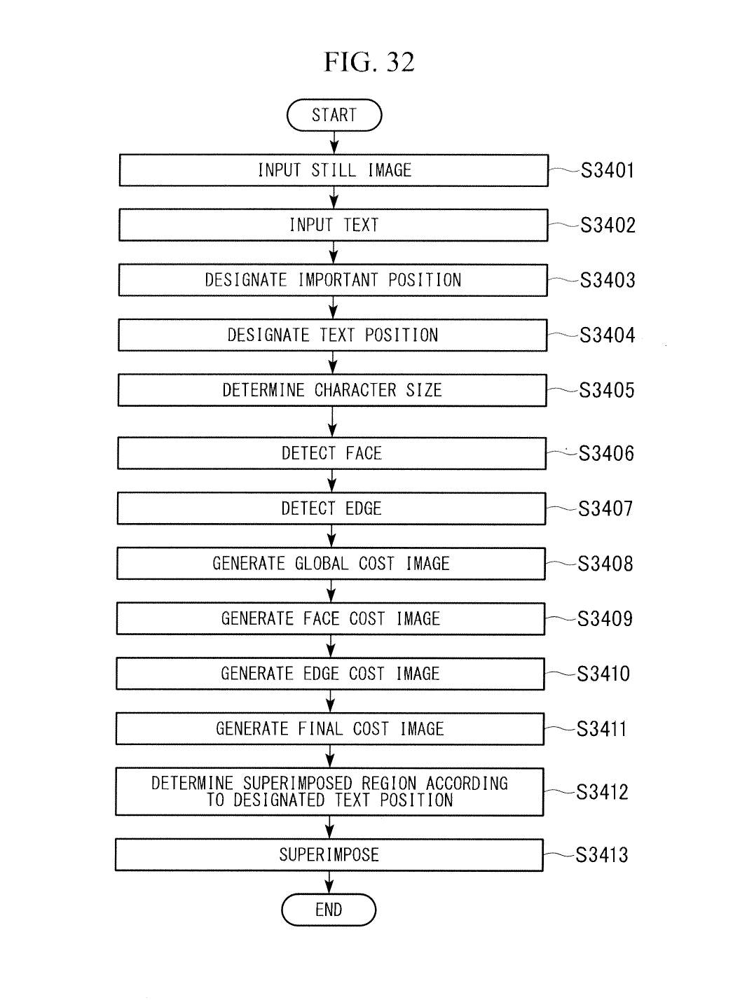

Next, with reference to FIG. 32, a superimposing process by the image processing unit 3140b will be described. FIG. 32 is a flowchart showing a procedure of the superimposing process according to the present embodiment.

The processes of steps S3401 to S3403 are the same as the processes of steps S3101 to S3103 described above.

Following step S3403, in step S3404, the second position input unit 3031 accepts an input of an X-coordinate value x₂ or a Y-coordinate value y₂ of the text position.

The processes of steps S3405 to S3411 are the same as the processes of steps S3104 to S3110 described above.

Following step S3411, in step S3412, the region determination unit 3018b determines the superimposed region of the text in the image data on the basis of the designated X-coordinate value x₂ or Y-coordinate value y₂ of the text position, the character size of the text data, and the final cost image.

Finally, in step S3413, the superimposition unit 3019 combines the image data and the text data by superimposing the text of the text data on the determined superimposed region.

As is described above, according to the present embodiment, the coordinate in the width direction or in the height direction of the position where a text is superimposed can be designated. The image processing unit 3140b sets the best region of the designated position in the width direction or in the height direction on the basis of the final cost image, to the superimposed region. Thereby, it is possible to superimpose the text on a region which is requested by the user and is the most appropriate region (for example, a region which can provide a high readability of the text, a region in which there is no face of a person, or a region other than an important position).

In addition, a process in which the image data and the text data are combined may be implemented by recording a program for performing each step which is shown in FIG. 27, FIG. 28, FIG. 30, or FIG. 32 into a computer readable recording medium, causing the program recorded in this recording medium to be read by a computer system, and executing the program.

In addition, the program described above may be transmitted from the computer system which stores this program in the storage device or the like to other computer systems via a transmission medium or by transmitted waves in a transmission medium.

In addition, the program described above may be used to achieve part of the above-described functions or a particular part.

Moreover, the program may be a program which can perform the above-described functions by combining the program with other programs which are already recorded in the computer system, namely, a so-called differential file (differential program).

In addition, in the above-described embodiment, the whole region in the image data is set as a candidate for the superimposed region. However, in consideration of the margin of the image data, a region other than the margin may be set as the candidate for the superimposed region. In this case, the character size determination unit 3016 sets “f” which satisfies the following expression (14) as the character size.

[Equation 12]

f×m<w−2Mₗ AND f{l+(l−1)L}<h−2M₂ (14)

Where, “M₁” is a parameter indicating the size of the margin in the width direction, and “M₂” is a parameter indicating the size of the margin in the height direction. Note that, the parameter M₁ and the parameter M₂ may be the same (M₁=M₂=M). The cost calculation units 3017, 3017a generate a final cost image of the region excluding the margin in the image data. In addition, the region determination units 3018, 3018b select the superimposed region from the region excluding the margin (M₁<x<w−M₁, M₂<y<h−M₂).

In addition, in the present embodiment, an important position is input via the first position input unit 3013. However, a predetermined given position (for example, the center of the image data) may be set as the important position, and a global cost image may be generated. For example, in the case that the center of the image data is set to the important position, the cost calculation units 3017, 3017a generate a global cost image using the following expression (15).

$$\begin{matrix}[ Equation 13 ] & \\ {c}_{g} ( x , y ) = exp [ - \frac{1}{S} \{ {( x - \frac{w}{2} )}^{2} + {( y - \frac{h}{2} )}^{2} \} ] & ( 15 )\end{matrix}$$

Where, S (>0) is a parameter which determines the way in which the cost is broadened.

In addition, in the case that the important position is preliminarily determined, because a global cost image is determined depending on the image size, global cost images may be prepared for each image size in advance and may be stored in the storage unit 160. The cost calculation units 3017, 3017a read out a global cost image in accordance with the image size of the input image from the storage unit 1160 and generate a final cost image. Thereby, because it is not necessary to generate the global cost image for each process in which the text data is superimposed on the image data, the total process time is shortened.

In addition, in the above-described embodiment, a face cost image on the basis of the region of the face of a person is generated. However, a cost image on the basis of an arbitrary characteristic attribute (for example, an object, an animal, or the like) may be generated. In this case, the cost calculation units 3017, 3017a generate a characteristic attribute cost image in which the cost of the region of the characteristic attribute is high. For example, the cost calculation unit 3017, 3017a generate a characteristic attribute cost image in which the pixel value of the region of the characteristic attribute which is detected by object recognition or the like is set to “1” and the pixel value of the other region is set to “0”. Then, the cost calculation unit 3017 generates a final cost image on the basis of the characteristic attribute cost image.

In addition, the region determination units 3018, 3018b may preliminarily generate a differential image with respect to all the coordinate positions (x, y) by using the following expression (16) before calculating a summation c*ₜₑₓₜ (x, y) of the costs within the text rectangular region.

$$\begin{matrix}[ Equation 14 ] & \\ {c}^{′} ( x , y ) = {\sum }_{u = 0}^{x} {\sum }_{v = 0}^{y} c ( u , v ) & ( 16 )\end{matrix}$$

In this case, the region determination units 3018, 3018b calculate the summation c*ₜₑₓₜ (x, y) of the costs within the text rectangular region using the following expression (17).

[Equation 15]

c*ₜₑₓₜ(x,y)=c′(x+wₜₑₓₜ,y+hₜₑₓₜ)−c′(x+wₜₑₓₜ,y−c′(x,y+hₜₑₓₜ)−c′(x,y) (17)

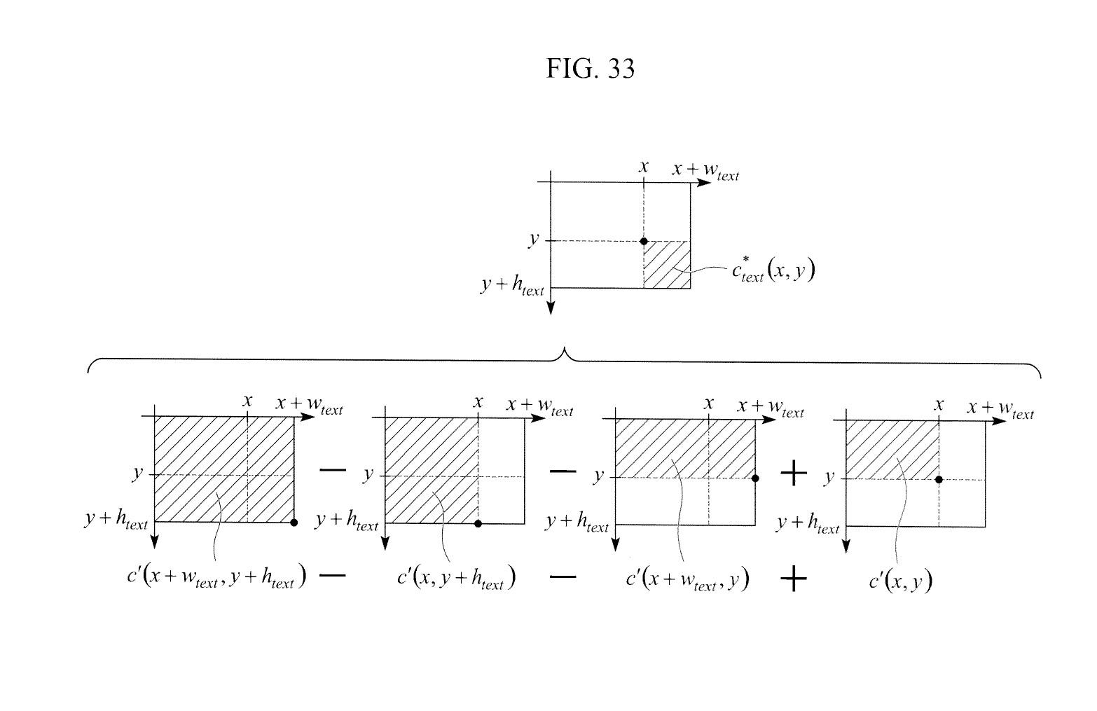

FIG. 33 is an image diagram showing a calculation method of the summation of the costs within a text rectangular region.

As is shown in the present figure, it is possible to calculate the summation c*ₜₑₓₜ (x, y) of the costs within the text rectangular region by four times of operations when expression (17) is used. Thereby, the process time can be shortened in comparison with the case in which the summation c*ₜₑₓₜ (x, y) of the costs within the text rectangular region is calculated using the above-described expression (11).

### Tenth Embodiment

The functional block diagram of the imaging apparatus according to the present embodiment is the same as that shown in FIG. 8 according to the second embodiment.

Hereinafter, units which are different from those of the second embodiment will be described in detail.

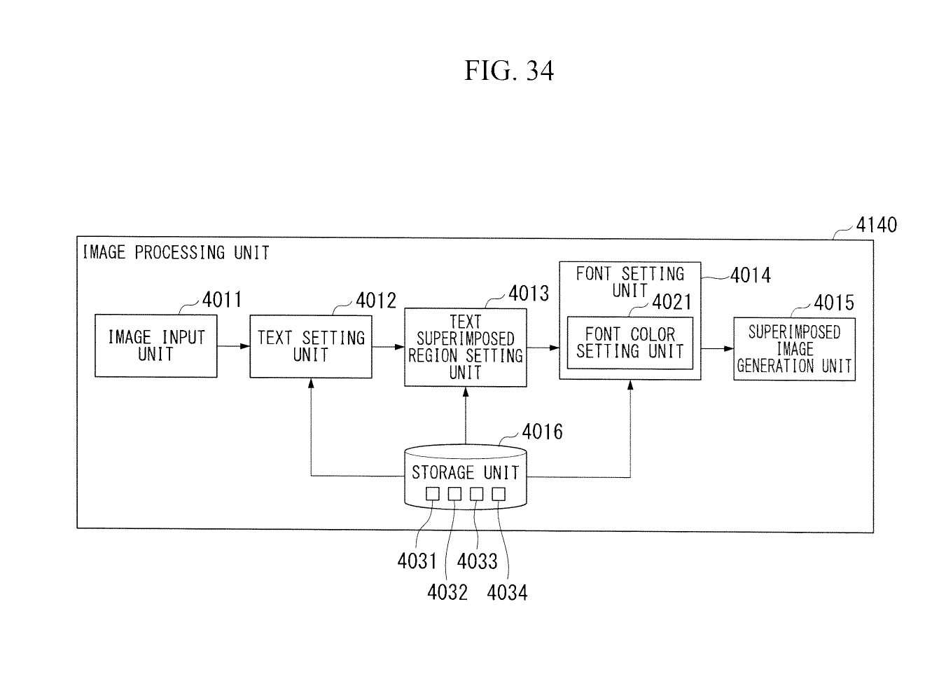

FIG. 34 is a block diagram showing a functional configuration of an image processing unit (image processing apparatus) 4140 (image processing unit 1140 in FIG. 8) according to the tenth embodiment of the present invention.

As is shown in FIG. 34, the image processing unit 4140 according to the present embodiment is configured to include an image input unit 4011, a text setting unit 4012, a text superimposed region setting unit 4013, a font setting unit 4014, a superimposed image generation unit 4015, and a storage unit 4016.

The font setting unit 4014 is configured to include a font color setting unit 4021.

The image input unit 4011 inputs image data of a still image, a moving image, or a through image. The image input unit 4011 outputs the input image data to the text setting unit 4012.

The image input unit 4011 inputs, for example, image data which is output from the A/D conversion unit 1120, image data which is stored in the buffer memory unit 1130, or image data which is stored in the storage medium 1200.

Note that, as another example, a configuration in which the image input unit 4011 inputs the image data via a network (not shown in the drawings) may be used.

The text setting unit 4012 inputs the image data from the image input unit 4011 and sets text data which is superimposed (combined) on this image data. The text setting unit 4012 outputs this image data and the set text data to the text superimposed region setting unit 4013.

Note that, in this text data, for example, information indicating the size of the character which constitutes the text, or the like, may be included.

As a method of setting, to the image data, text data which is superimposed on this image data, an arbitrary method may be used.

As an example, the setting may be performed by storing fixedly determined text data in the storage unit 4016 in advance and reading out the text data from the storage unit 4016 by the text setting unit 4012.

As another example, the setting may be performed in the way in which the text setting unit 4012 detects the text data which is designated via the operation of the operation unit 1180 by the user.

In addition, as another example, the setting may be performed in the way in which a rule by which the text data is determined on the basis of the image data is stored in the storage unit 4016, and the text setting unit 4012 reads out the rule from the storage unit 4016 and determines the text data from the image data in accordance with the rule. As this rule, for example, a rule which determines a correspondence relationship between the text data and a predetermined characteristic, a predetermined characteristic attribute, or the like, which is included in the image data, can be used. In this case, the text setting unit 4012 detects the predetermined characteristic, the predetermined characteristic attribute, or the like, with respect to the image data, and determines the text data which corresponds to this detection result in accordance with the rule (the correspondence relationship).

The text superimposed region setting unit 4013 inputs the image data and the set text data from the text setting unit 4012 and sets the region (text superimposed region), on which this text data is superimposed, of this image data. The text superimposed region setting unit 4013 outputs this image data, the set text data, and information which specifies the set text superimposed region to the font setting unit 4014.

As a method for setting, to the image data, a region on which the text data is superimposed (text superimposed region), an arbitrary method may be used.

As an example, the setting may be performed by storing fixedly determined text superimposed region in the storage unit 4016 in advance and reading out the text superimposed region from the storage unit 4016 by the text superimposed region setting unit 4013.

As another example, the setting may be performed in the way in which the text superimposed region setting unit 4013 detects the text superimposed region which is designated via the operation of the operation unit 1180 by the user.

In addition, as another example, the setting may be performed in the way in which a rule by which the text superimposed region is determined on the basis of the image data is stored in the storage unit 4016, and the text superimposed region setting unit 4013 reads out the rule from the storage unit 4016 and determines the text superimposed region from the image data in accordance with the rule. As this rule, for example, a rule which determines the text superimposed region such that the text is superimposed on a non-important region in the image which is a region other than an important region in which a relatively important object is imaged, can be used. As a specific example, a configuration which classifies a region in which a person is imaged as the important region and superimposes the text on a region within the non-important region which does not include the center of the image can be used. In addition, other various rules may be used.

In addition, in the present embodiment, for example, when the size of the character of the preliminarily set text is large to such a degree that the entire set text cannot be accommodated within the text superimposed region, the text superimposed region setting unit 4013 performs a change operation by which the size of the character of the text is reduced such that the entire set text is accommodated within the text superimposed region.

As the text superimposed region, regions having a variety of shapes may be used. For example, an inner region which is surrounded by a rectangular frame such as a rectangle or a square can be used. As another example, an inner region which is surrounded by a frame that is constituted by a curved line in part or in whole may be used as the text superimposed region.

The font setting unit 4014 inputs the image data, the set text data, and the information which specifies the set text superimposed region, from the text superimposed region setting unit 4013, and on the basis of at least one of these data and information, sets a font (including at least a font color) of this text data. The font setting unit 4014 outputs this image data, the set text data, the information which specifies the set text superimposed region, and information which specifies the set font, to the superimposed image generation unit 4015.

In the present embodiment, the font setting unit 4014 sets the font color of the text data, mainly by the font color setting unit 4021. In the present embodiment, the font includes the font color as a font.

Therefore, in the present embodiment, fonts other than the font color may be arbitrary and, for example, may be fixedly set in advance.

The font color setting unit 4021 sets the font color of the text data which is input to the font setting unit 4014 from the text superimposed region setting unit 4013, on the basis of the image data and the text superimposed region, which are input to the font setting unit 4014 from the text superimposed region setting unit 4013.

Note that, when the font color is set by the font color setting unit 4021, for example, the text data which is input to the font setting unit 4014 from the text superimposed region setting unit 4013 may also be taken into account.

The superimposed image generation unit 4015 inputs the image data, the set text data, the information which specifies the set text superimposed region, and the information which specifies the set font, from the font setting unit 4014, and generates image data (data of a superimposed image) in which this text data is superimposed on this text superimposed region of this image data with this font (including at least the font color).

Then, the superimposed image generation unit 4015 outputs the generated data of the superimposed image to at least one of, for example, the display unit 1150, the buffer memory unit 1130, and the storage medium 1200 (via the communication unit 1170).

Note that, as another example, a configuration in which the superimposed image generation unit 4015 outputs the generated data of the superimposed image to a network (not shown in the drawings) may be used.

The storage unit 4016 stores a variety of information. For example, in the present embodiment, the storage unit 4016 stores information which is referred to by the text setting unit 4012, information which is referred to by the text superimposed region setting unit 4013, and information which is referred to by the font setting unit 4014 (including the font color setting unit 4021).

Next, a process which is performed in the font setting unit 4014 will be described in detail.

In the present embodiment, because only the font color is set as the font and other fonts may be arbitrary, a setting process of the font color which is performed by the font color setting unit 4021 will be described.

First, the PCCS color system (PCCS; Practical Color Coordinate System) which is one of the methods to present a color will be briefly described.

The PCCS color system is a color system in which hue, saturation, and brightness are defined on the basis of the human sensitivity.

In addition, there is a concept of tone (color tone) which is defined by saturation and brightness in the PCCS color system, and it is possible to present a color with two parameters, which are tone and hue.

Thus, in the PCCS color system it is also possible to define a concept of a tone and to present a color with a tone and a hue in addition to presenting a color by using three attributes of color (hue, saturation, and brightness).

Twelve levels of tones are defined with respect to a chromatic color, and five levels of tones are defined with respect to an achromatic color.

Twenty four levels or twelve levels of hues are defined according to a tone.

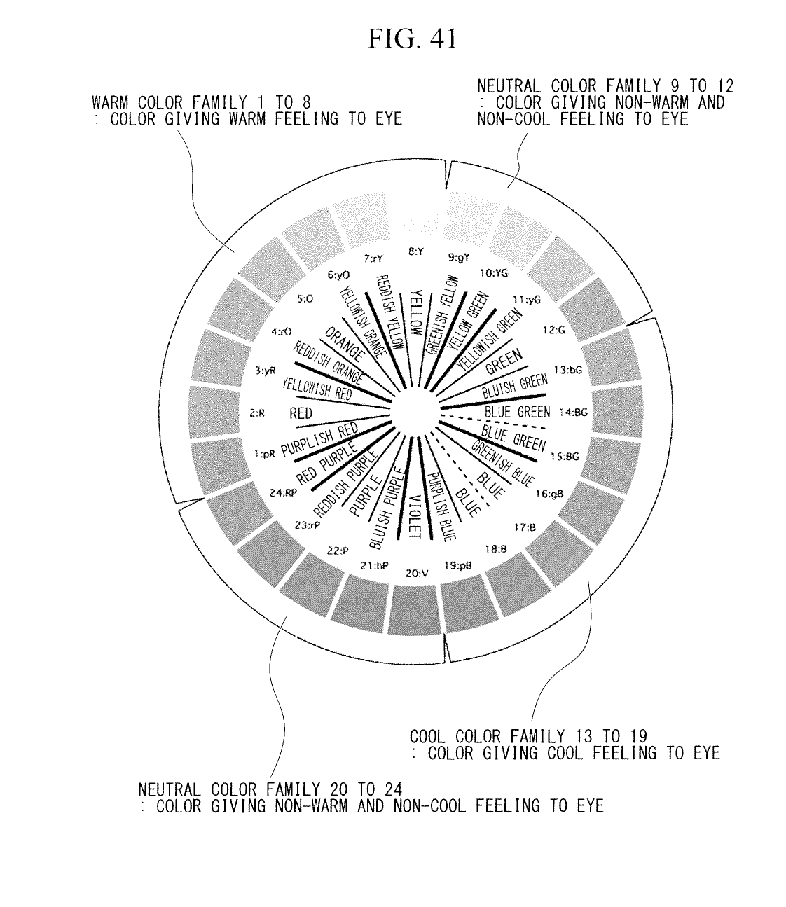

FIG. 41 is a diagram showing an example of a gray scale image of a hue circle of the PCCS color system.

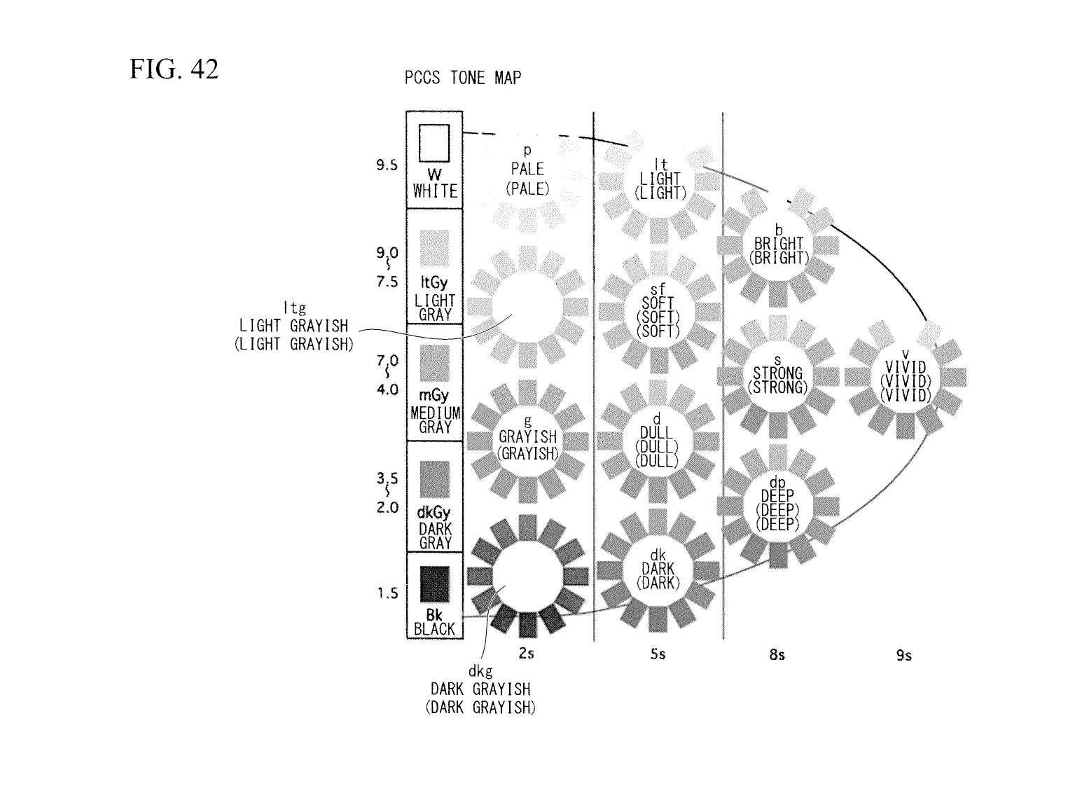

FIG. 42 is a diagram showing an example of a gray scale image of a tone of the PCCS color system. Generally, the horizontal axis of the tone corresponds to brightness, and the vertical axis of the tone corresponds to saturation.

Note that, color drawings of FIG. 41 and FIG. 42 are, for example, post on the website of DIC Color Design, Inc.

In the example of the hue circle shown in FIG. 41, twenty four levels of hues, which are a warm color family 1 to 8, a neutral color family 9 to 12, a cool color family 13 to 19, and a neutral color family 20 to 24, are defined.

In addition, in the example of the tone (PCCS tone map) shown in FIG. 42, twelve levels of tones are defined with respect to a chromatic color, and five levels of tones are defined with respect to an achromatic color. In addition, in this example, twelve levels of hues are defined for each tone of the chromatic color.

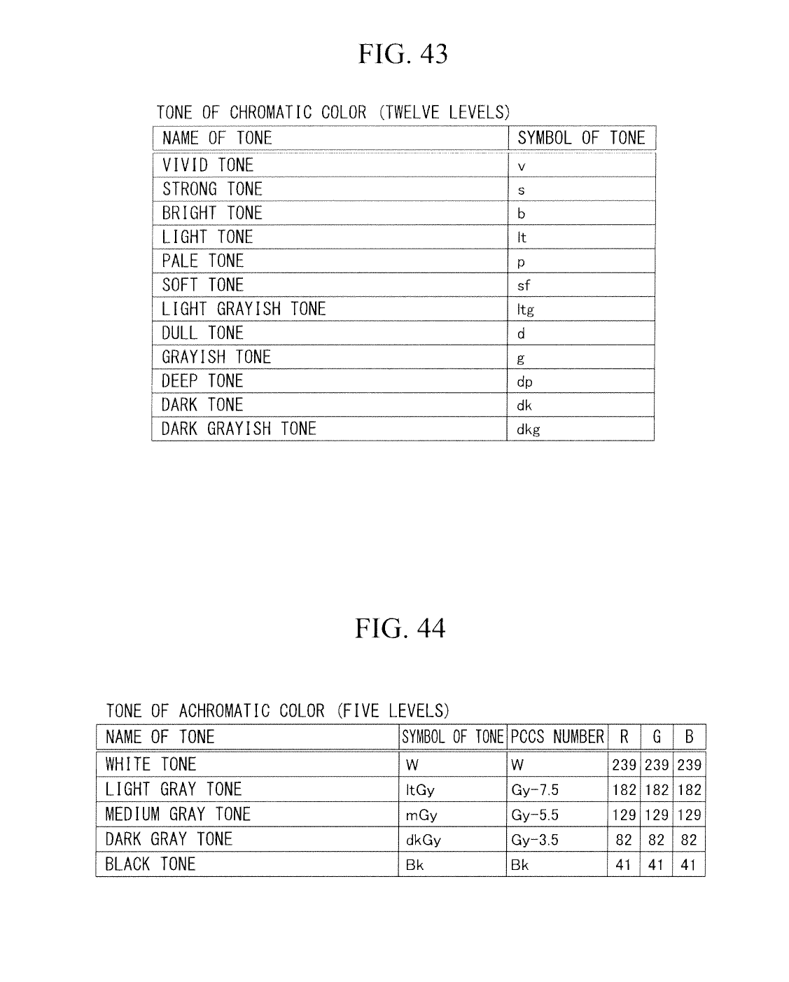

FIG. 43 is a diagram showing twelve levels of tones of a chromatic color.

In this example, the correspondence between the name of a tone and the symbol of the tone is shown.

Specifically, as is shown in FIG. 43, as the twelve levels of tones of the chromatic color, there are a vivid tone (vivid tone: symbol v), a strong tone (strong tone: symbol s), a bright tone (bright tone: symbol b), a light tone (light tone: symbol lt), a pale tone (pale tone: symbol p), a soft tone (soft tone: symbol sf), a light grayish tone (light grayish tone: symbol ltg), a dull tone (dull tone: symbol d), a grayish tone (grayish tone: symbol g), a deep tone (deep tone: symbol dp), a dark tone (dark tone: symbol dk), and a dark grayish tone (dark grayish tone: symbol dkg).

FIG. 44 is a diagram showing five levels of tones of an achromatic color.

In this example, the correspondence among the name of a tone, the symbol of the tone, a PCCS number, an R (red) value, a G (green) value, and a B (blue value) is shown.

Specifically, as is shown in FIG. 44, as the five levels of tones of the achromatic color, there are a white tone (white tone: symbol W), a light gray tone (light gray tone: symbol ltGy), a medium gray tone (medium gray tone: symbol mGy), a dark gray tone (dark gray tone: symbol dkGy), and a black tone (black tone: symbol Bk).

Note that, the correspondence between the number of the PCCS color system in the tone of an achromatic color and the RGB values conforms to a color table on the website “http://www.wsj21.net/ghp/ghp0c_{—}03.htm”.

Next, a process which is performed by the font color setting unit 4021 will be described.

The font color setting unit 4021 sets, on the basis of the PCCS color system, the font color of the text data which is input to the font setting unit 4014 from the text superimposed region setting unit 4013 on the basis of the image data and the text superimposed region, which are input to the font setting unit 4014 from the text superimposed region setting unit 4013.

In the present embodiment, when the font color with which the text is displayed in the image is set, an optimization of the position of the text which is displayed in the image (text superimposed region), or the like, is performed by the text superimposed region setting unit 4013, and the position in this image when the text is displayed in the image (text superimposed region) is defined.

The font color setting unit 4021, first, calculates an average color of this text superimposed region in this image data (average color of the image region where the text is displayed in the image), on the basis of the image data and the text superimposed region, which are input to the font setting unit 4014 from the text superimposed region setting unit 4013.

Specifically, the font color setting unit 4021 calculates an average value of the R values, an average value of the G values, and an average value of the B values, with respect to the pixels (pixel) inside this text superimposed region in this image data, on the basis of the image data and the text superimposed region which are input to the font setting unit 4014 from the text superimposed region setting unit 4013, and obtains the combination of these R, G, and B average values as an average color of the RGB. Then, the font color setting unit 4021 converts the obtained average color of the RGB into a tone and a hue of the PCCS color system on the basis of the information 4031 of a conversion table from the RGB system to the PCCS color system which is stored in the storage unit 4016, and sets the tone and the hue of the PCCS color system which are obtained by the conversion to an average color of the PCCS color system.

Each pixel inside the text superimposed region in the image data has an R value, a G value, and a B value (for example, a value of 0 to 255). With respect to all the pixels inside this text superimposed region, the values are added for each of the R value, the G value, and the B value, and the result obtained by dividing each addition result by the number of all the pixels is an average value for each of the R value, the G value, and the B value. The combination of these average values for the R value, the G value, and the B value is set as the average color of the RGB.

In addition, a conversion table which is specified by the information 4031 of the conversion table from the RGB system to the PCCS color system and which is referred to when the average color of the RGB is converted into the tone and the hue of the PCCS color system defines the correspondence between the average color of the RGB and the tone and the hue of the PCCS color system.

As such a conversion table, a variety of tables having different contents of conversion may be used. Because the number of values which is available of the RGB is commonly greater than the number of values which is available of the PCCS color system, the correspondence between the number of values of the RGB and the number of values of the PCCS color system becomes a many-to-one correspondence. In this case, some of different values of the RGB are converted into the same representative value of the PCCS color system.

Note that, in the present embodiment, the average color of the RGB is converted into the tone and the hue of the PCCS color system on the basis of the conversion table. However, as another example, a configuration may be used in which information of a conversion equation which specifies the content of conversion from the average color of the RGB to the tone and the hue of the PCCS color system is stored in advance in the storage unit 4016, the font color setting unit 4021 reads out this information of the conversion equation from the storage unit 4016 and performs the calculation of the conversion equation, and thereby the average color of the RGB is converted into the tone and the hue of the PCCS color system.

Next, the font color setting unit 4021 sets the font color (color) of the text data which is input to the font setting unit 4014 from the text superimposed region setting unit 4013 on the basis of the tone and the hue of the PCCS color system which are obtained as the average color of the PCCS color system.

Specifically, the font color setting unit 4021 sets, with respect to the tone and the hue of the PCCS color system which are obtained as the average color of the PCCS color system, the font color (color) of the text data which is input to the font setting unit 4014 from the text superimposed region setting unit 4013, by changing only the tone on the basis of information 4032 of a tone conversion table which is stored in the storage unit 4016 while maintaining the hue as is.

The information specifying the font color which is set as described above is included in information specifying the font by the font setting unit 4014 and is output to the superimposed image generation unit 4015.

When the tone (tone) and the hue (hue) of the PCCS color system as the average color of the PCCS color system which are obtained by the font color setting unit 4021 are set as “t” and “h”, the tone “t*” and the hue “h*” of the font color which are set by the font color setting unit 21 are represented by the expression ( ).

t*={a tone which is different from t}

h*=h (18)

In the present embodiment, the color of the image which is input and given by the image input unit 4011 has n gradations and n³ levels, and on the other hand, the font color has N levels (typically, N<n³) defined by the PCCS color system. Therefore, a color difference to a certain degree and an outline of the font to some extent can be obtained at this stage.

Note that, in the case of n=256 gradations which are used for a regular digital image, the color of the image has 256³=16777216 levels.

In addition, as an example, in the case that there are 24 levels in the hue for each one tone when estimated at most, the font color has N=12×24+5=293 levels.

As is described above, in the present embodiment, a font color with an unchanged hue and a changed tone of the PCCS color system with respect to the average color of the text superimposed region in which the text data is arranged in the image data is applied to this text data, and thereby, for example, it is possible to set a font color with which the text is easy to read (having a contrast) while maintaining the impression of the image when an image, in which this image data and this text data are combined, is displayed.

A process which is performed by the font color setting unit 4021 and in which the tone of the PCCS color system is changed will be described.

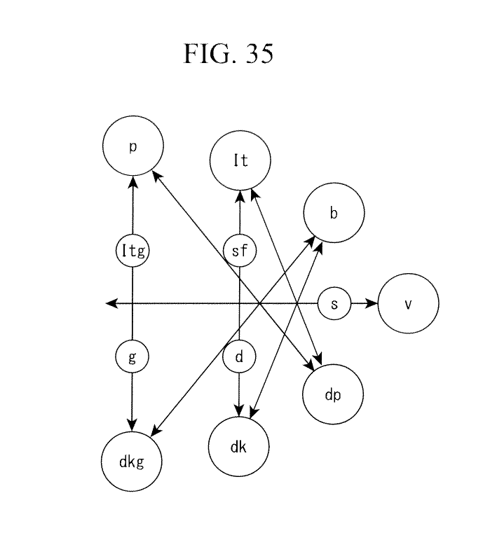

FIG. 35 is a diagram showing a relation regarding harmony of contrast with respect to the tone in the PCCS color system.

Note that, the content of FIG. 35 is, for example, post on the website of DIC Color Design, Inc.

In the present embodiment, the information 4032 of the tone conversion table which specifies the correspondence between the tone before conversion and the tone after conversion is stored in the storage unit 4016.

As the content of this tone conversion table (the correspondence between the tone before conversion and the tone after conversion), a variety of contents may be set and be used. As an example, a tone conversion table is preliminarily set in consideration of the relation regarding harmony of contrast with respect to the tone in the PCCS color system, which is shown in FIG. 35.

Specifically, for example, a white tone or a light gray tone is assigned to a relatively dark tone.

In addition, for example, another tone in the relation regarding harmony of contrast which is shown in FIG. 35 is assigned to a relatively bright tone. Alternatively, a tone which is a tone of a chromatic color and is in the relation regarding harmony of contrast can also be assigned.

In addition, in the case that there are two or more candidates for the tone after conversion which correspond to the tone before conversion on the basis of the relation regarding harmony of contrast, for example, a tone which is a tone of a chromatic color is adopted, of these candidates, and moreover, a tone which is a relatively vivid tone (for example, the most vivid tone) is adopted.

For example, in the relation regarding harmony of contrast which is shown in FIG. 35, the more the tone is located at the lower left side, the more the tone is dark, and the more the tone is located at the right side, the more the tone is vivid. As a specific example in which a vivid tone is adopted, a tone which is close to “dp” (or “dp” itself) is adopted.

Next, a procedure of the process in the present embodiment will be described.

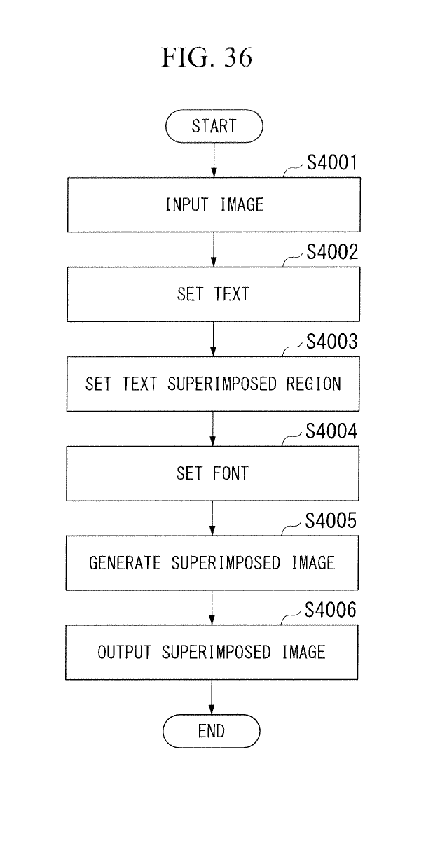

With reference to FIG. 36, a procedure of the process which is performed in the image processing unit 4140 according to the present embodiment will be described.

FIG. 36 is a flowchart showing the procedure of the process which is performed in the image processing unit 4140 according to the present embodiment.

First, in step S4001, the image input unit 4011 inputs image data.

Next, in step S4002, the text setting unit 4012 sets text data.

Next, in step S4003, the text superimposed region setting unit 4013 sets a text superimposed region for a case where the text data is superimposed on the image data.

Next, in step S4004, the font setting unit 4014 sets a font including a font color, for a case where the text data is superimposed on the text superimposed region set within the image data.

Next, in step S4005, the superimposed image generation unit 4015 applies the set font to the text data and superimposes the text data on the text superimposed region which is set within the image data. Thereby, data of a superimposed image is generated.

Finally, in step S4006, the superimposed image generation unit 4015 outputs the generated data of the superimposed image to, for example, another configuration unit via the bus 1300.

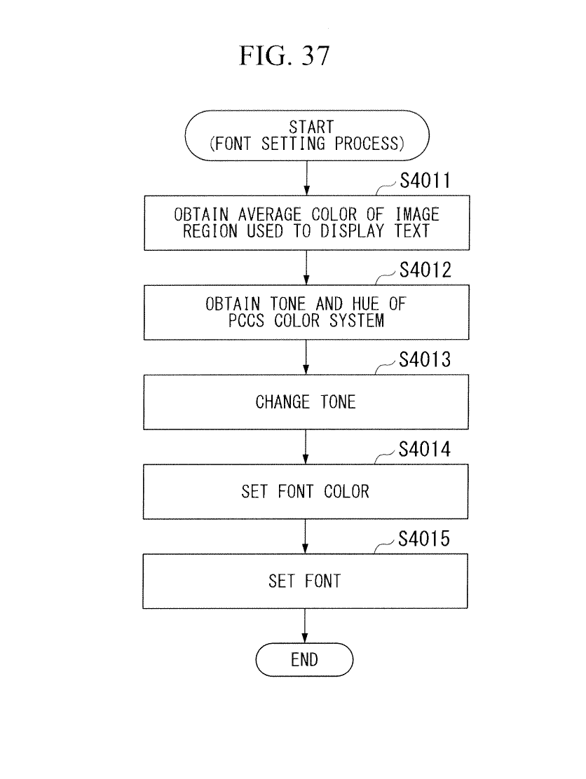

With reference to FIG. 37, a procedure of the process which is performed in the font setting unit 4014 according to the present embodiment will be described.

FIG. 37 is a flowchart showing the procedure of the process which is performed in the font setting unit 4014 according to the present embodiment.

This procedure of the process is a detail of the process of step S4004 which is shown in FIG. 36.

First, in step S4011, with respect to the image data which is the target of the present process, the text data, and the text superimposed region, the font color setting unit 4021 in the font setting unit 4014 obtains the average color in the RGB of this text superimposed region which is set in this image data so as to display this text data (region of the image which is used to display the text).

Next, in step S4012, the font color setting unit 4021 in the font setting unit 4014 obtains, from the obtained average color of the RGB, the tone and the hue of the PCCS color system corresponding to the average color of the RGB.

Next, in step S4013, the font color setting unit 4021 in the font setting unit 4014 changes the obtained tone into another tone.

Next, in step S4014, the font color setting unit 4021 in the font setting unit 4014 sets a color of the PCCS color system which is defined by the combination of the tone after the change (the another tone) and the obtained hue as is, as a font color.

Finally, in step S4015, the font setting unit 4014 sets a font which includes the font color which is set by the font color setting unit 4021, to the text data.

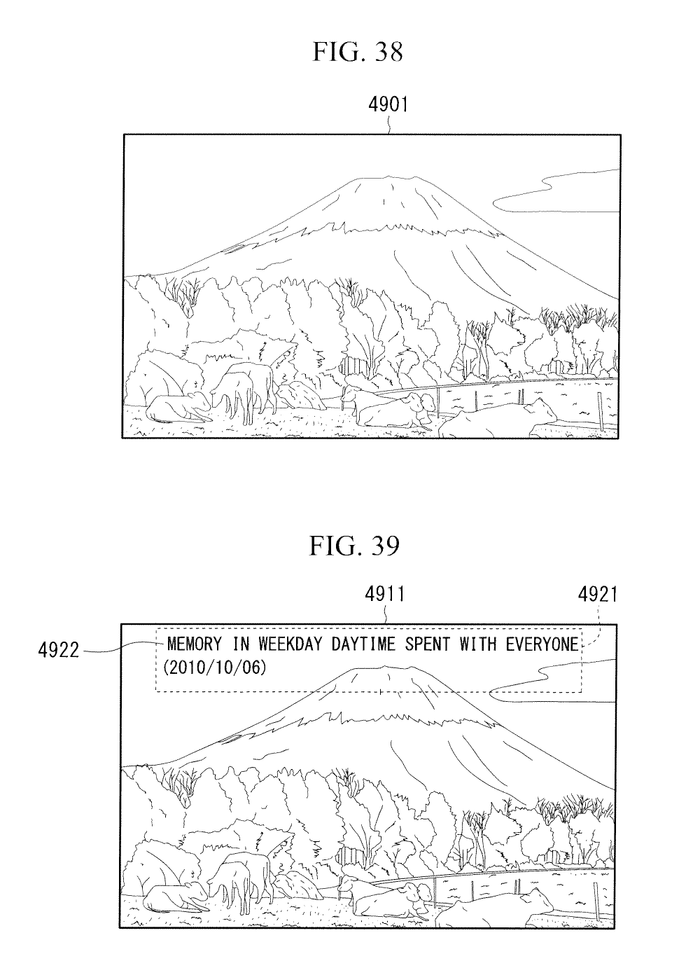

With reference to FIG. 38 and FIG. 39, a specific example of the image processing will be described.

FIG. 38 is a diagram showing an example of an image of image data 4901.

A case in which the image data 4901 shown in FIG. 38 is input by the image input unit 4011 of the image processing unit 4140 will be described.

FIG. 39 is a diagram showing an example of an image of superimposed image data 4911, in this case.

The superimposed image data 4911 which is shown in FIG. 39 is output from the superimposed image generation unit 4015 and thereby is output from the image processing unit 4140.

In the superimposed image data 4911 which is shown in FIG. 39, in addition to the same image as the image data 4901 which is shown in FIG. 38, this image data 4901 is combined, such that text data 4922 which is set by the text setting unit 4012 (in the example of FIG. 39, data of characters, “memory in weekday daytime spent with everyone (2010/10/06)”) is displayed on a text superimposed region 4921 which is set by the text superimposed region setting unit 4013 with a font (including at least a font color) which is set by the font setting unit 4014, with this text data 4922.

Note that, in FIG. 39, for a better visual understanding of the text superimposed region 4921, the text superimposed region 4921 is illustrated in the superimposed image data 4911. However, in the present embodiment, in an actual display, the text superimposed region 4921 (in the example of FIG. 39, a rectangular frame) is not displayed, but only the text data 4922 is superimposed on the original image data 4901 and is displayed.

As is described above, the image processing unit 4140 according to the present embodiment, by using color information of the image region in which a text is displayed in the image (text superimposed region), sets a font color of the text. Specifically, the image processing unit 4140 according to the present embodiment sets a font color of which the hue is unchanged and of which only the tone is changed in the PCCS color system from the color information on the basis of the text superimposed region. Thereby, for example, it is possible to not change the impression of the original image when the text is displayed.

Thus, in the image processing unit 4140 according to the present embodiment, when a text is displayed in a digital image such as a still image or a moving image, it is possible to obtain the best font color in consideration of the color information of the image region in which the text is displayed in the image (text superimposed region) such that the text is easy for a viewer to read.

In the present embodiment, with respect to the image data of one image frame which is a still image or one image frame which constitutes a moving image (for example, one image frame which is selected as a representative of a plurality of image frames), a case where the text data which is superimposed (combined) on this image data is set, the text superimposed region in which this text data is superimposed on this image data is set, and the font including the font color of this text data which is superimposed on this image data is set, is described, however, as another example, these settings can be performed with respect to the image data of two or more image frames which constitute a moving image. In this case, as an example, with respect to two or more continuous image frames or two or more intermittent image frames which constitute a moving image, it is possible to average the values (for example, the RGB values) of each pixel corresponding in the frames and to perform the same process as the present embodiment with respect to the image data of one image frame which is constituted by the result of the averaging (averaged image data).

In addition, as another configuration example, a configuration in which the font color setting unit 4021 sets the ratio of the hue value of the region in which the text is placed in the image data (text placement region) to the hue value of the text data, to a value which is closer to one than the ratio of the tone value of the text placement region of the image data to the tone value of the text data, can be used.

Where, the text placement region corresponds to the text superimposed region.

As an aspect, it is possible to configure an image processing apparatus (in the example of FIG. 34, the image processing unit 4140) which includes an acquisition unit that acquires image data and text data (in the example of FIG. 34, the image input unit 4011 and the text setting unit 4012), a region determination unit that determines a text placement region in which the text data is placed in the image data (in the example of FIG. 34, the text superimposed region setting unit 4013), a color setting unit that sets a predetermined color to the text data (in the example of FIG. 34, the font color setting unit 4021 of the font setting unit 4014), and an image generation unit that generates an image in which the text data of the predetermined color is placed in the text placement region (in the example of FIG. 34, the superimposed image generation unit 4015), wherein the ratio of the hue value of the text placement region of the image data to the hue value of the text data is closer to unity than the ratio of the tone value of the text placement region of the image data to the tone value of the text data.

In addition, as an aspect, in the above-described image processing apparatus (in the example of FIG. 34, the image processing unit 4140), it is possible to configure an image processing apparatus wherein the color setting unit (in the example of FIG. 34, the font color setting unit 4021 of the font setting unit 4014) obtains the tone value and the hue value of the PCCS color system from the average color of the RGB of the text placement region, and changes only the tone value of the PCCS color system but does not change the hue of the PCCS color system.

Note that, as the value of each ratio in the case where the ratio of the hue value of the region in which the text is placed in the image data (text placement region) to the hue value of the text data is set to a value which is closer to unity than the ratio of the tone value of the text placement region of the image data to the tone value of the text data, a variety of values may be used.

In such a configuration, it is also possible to obtain similar effects as the present embodiment.

### Eleventh Embodiment

The functional block diagram of an imaging apparatus according to the present embodiment is similar as the one which is shown in FIG. 8 according to the second embodiment.

In addition, the block diagram showing the functional configuration of an image processing unit according to the present embodiment is similar as the one which is shown in FIG. 34 according to the tenth embodiment.

Hereinafter, parts which are different from the second and the tenth embodiments will be described in detail.

Note that, in the description of the present embodiment, the same reference numerals as the reference numerals of each configuration unit which are used in FIG. 8, FIG. 34, FIG. 36, and FIG. 37, are used.

In the present embodiment, the font setting unit 4014 inputs the image data, the text data which is set, and the information which specifies the text superimposed region which is set, from the text superimposed region setting unit 4013, and in the case that the font setting unit 4014 sets the font of this text data, the font color setting unit 4021 sets the font color, and also the font setting unit 4014 sets a predetermined outline as a font of this text data, on the basis of outline information 4033 which is stored in the storage unit 4016.

As the predetermined outline, for example, a shadow, an outline, or the like, can be used.

As an example, the type of the predetermined outline (for example, a shadow, an outline, or the like) is fixedly set in advance.

As another example, in the case that it is possible to switchingly use two or more types of outlines as the predetermined outline, a configuration can be used in which the font setting unit 4014 switches the type of the outline which is used, in accordance with the command of switching which, for example, via the operation of the operation unit 1180 by the user, this operation unit 1180 accepts from this user.

In addition, as the color of the predetermined outline, for example, black or a color with a darker tone than the tone of the font color, can be used.

As an example, the color of the predetermined outline is fixedly set in advance.

As another example, in the case that it is possible to switchingly use two or more types of colors as the color of the predetermined outline, a configuration can be used in which the font setting unit 4014 switches the color of the outline which is used, in accordance with the command of switching which, for example, via the operation of the operation unit 1180 by the user, this operation unit 1180 accepts from this user.

Note that, as the outline information 4033 which is stored in the storage unit 4016, information which is referred to when the font setting unit 4014 sets an outline with respect to a text, is used. For example, at least one type of information or the like available which specifies the type of the outline or the color, is used.

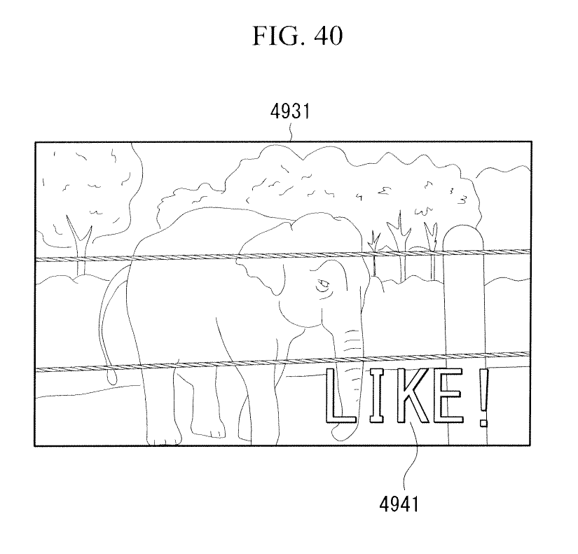

FIG. 40 is a diagram showing an example of an image of data of a superimposed image 4931.

In the data of the superimposed image 4931 which is shown in FIG. 40, in addition to the same image as the original image data (not shown in the drawings) which is constituted by portions of the image other than text data 4941, this image data is combined, such that the text data 4941 which is set by the text setting unit 4012 (in the example of FIG. 40, data of characters, “like!”) is displayed on the text superimposed region (not shown in the drawings) which is set by the text superimposed region setting unit 4013 with a font (including at least a font color and an outline) which is set by the font setting unit 4014, with this text data 4941.

Where, in the example of FIG. 40, a case where a shadow is used as the outline is shown.

Note that, in the present embodiment, in the process of step S4015 which is shown in FIG. 37 in the process of step S4004 which is shown in FIG. 36, the font setting unit 4014 sets the font of the predetermined outline when the font setting unit 4014 sets the font including the font color which is set by the font color setting unit 4021 to the text data.

As is described above, the image processing unit 4140 according to the present embodiment sets, by using color information of the image region in which a text is displayed in an image (text superimposed region), the font color of this text and also sets an outline as a font.

Therefore, by the image processing unit 4140 according to the present embodiment, it is possible to obtain similar effects as the tenth embodiment, and also by emphasizing the outline of the font by adding an outline such as a shadow to the text in addition to the font color which is set, it is possible to increase the contrast of the color. Such addition of an outline is particularly effective, for example, in the case that set font color of a text is white.

### Twelfth Embodiment

The functional block diagram of an imaging apparatus according to the present embodiment is similar to the one which is shown in FIG. 8 according to the second embodiment.

In addition, the block diagram showing the functional configuration of an image processing unit according to the present embodiment is similar as the one which is shown in FIG. 34 according to the tenth embodiment.

Hereinafter, parts which are different from the second and the tenth embodiments will be described in detail.

Note that, in the description of the present embodiment, the same reference numerals as the reference numerals of each configuration unit which are used in FIG. 8, FIG. 34, and FIG. 37, are used.

In the present embodiment, the font setting unit 4014 inputs the image data, the text data which is set, and the information which specifies the text superimposed region which is set, from the text superimposed region setting unit 4013, and in the case that the font color setting unit 4021 sets the font color of this text data, the font color setting unit 4021 determines whether or not the change of the color in this text superimposed region in which this text is displayed is equal to or greater than a predetermined value, on the basis of information of color change determination condition 4034 which is stored in the storage unit 4016, and when the font color setting unit 4021 determines that the change of the color in this text superimposed region is equal to or greater than the predetermined value, the font color setting unit 4021 sets two or more types of font colors in this text superimposed region.

Note that, when the font color setting unit 4021 determines that the change of the color in this text superimposed region is less than the predetermined value, the font color setting unit 4021 sets one type of font color to the whole of this text superimposed region, in a similar way as the tenth embodiment.

Specifically, the font color setting unit 4021 divides the text superimposed region in which the text is displayed, into a plurality of regions (in the present embodiment, referred to as a divided region), and performs a process in which the average color of the RGB is obtained (similar process as step S4011 which is shown in FIG. 37) for each divided region.

Then, the font color setting unit 4021 determines whether or not there is a difference which is equal to or greater than the predetermined value with respect to the values of the average color of the RGB of these divided regions, and when the font color setting unit 4021 determines that there is a difference which is equal to or greater than the predetermined value, the font color setting unit 4021 determines that the change of the color in this text superimposed region is equal to or greater than the predetermined value. On the other hand, when the font color setting unit 4021 determines that there is not a difference which is equal to or greater than the predetermined value with respect to the values of the average color of the RGB of these divided regions, the font color setting unit 4021 determines that the change of the color in this text superimposed region is less than the predetermined value.

As the method for determining whether or not there is a difference which is equal to or greater than the predetermined value with respect to the values of the average color of the RGB of the plurality of divided regions, a variety of methods may be used.

As an example, it is possible to use a method in which, in the case that a difference between the values of the average color of the RGB of arbitrary two divided regions of the plurality of divided regions is equal to or greater than the predetermined value, it is determined that there is a difference which is equal to or greater than the predetermined value with respect to the values of the average color of the RGB of the plurality of divided regions.

As another example, it is possible to use a method in which, in the case that a difference between the values of the average color of the RGB of two divided regions, which are a divided region having the minimum value of the average color of the RGB and a divided region having the maximum value of the average color of the RGB, of the plurality of divided regions is equal to or greater than the predetermined value, it is determined that there is a difference which is equal to or greater than the predetermined value with respect to the values of the average color of the RGB of the plurality of divided regions.

In addition, as another example, it is possible to use a method in which, in the case that the value of dispersion of the value of the average color of the RGB is obtained with respect to all the plurality of divided regions and that this value of dispersion is equal to or greater than the predetermined value, it is determined that there is a difference which is equal to or greater than the predetermined value with respect to the values of the average color of the RGB of the plurality of divided regions.

In these cases, when the values of the average color of the RGB are compared, as an example, it is possible to compare only any one of the R values, the G values, and the B values. As another example, it is possible to combine two or three of the R values, the G values, and the B values into one and compare the combined values. In addition, as another example, it is possible to separately compare two or more of the R values, the G values, and the B values.

In the case that two or more of the R values, the G values, and the B values are separately compared, for example, it is possible to use a method in which, when there is a difference which is equal to or greater than the predetermined value with respect to any one of the compared values (the R values, the G values, or the B values), it is determined that there is a difference which is equal to or greater than the predetermined value as a whole, or it is possible to use a method in which, (only) when there is a difference which is equal to or greater than the predetermined value with respect to all the compared values, it is determined that there is a difference which is equal to or greater than the predetermined value as a whole.

In addition, as the method of dividing the text superimposed region in which the text is displayed into the plurality of regions (divided regions), a variety of methods may be used.

As an example, it is possible to use a method in which, with respect to the character which is included in the text that is displayed in the text superimposed region, a region which is separated for each one character is defined as the divided region. In this case, for each one character, for example, a rectangular region which includes the peripheral of the character is preliminarily set, and the whole of the text superimposed region is configured by the combination of the regions of all the characters which are included in the text. Note that, the rectangular region for each character may be different, for example, depending on the size of each character.

As another example, it is possible to use a method in which a region which separates the text superimposed region with a division number which is preliminarily set or a size which is preliminarily set (for example, the length in the horizontal direction, the length in the vertical direction, or the size of a block such as a rectangle) is defined as the divided region.

Note that, in the present embodiment, on the basis of the values of the average color of the RGB of the plurality of the divided regions, it is determined whether or not the change of the color in the text superimposed region which is constituted by these divided regions is equal to or greater than the predetermined value. However, as another example, a configuration in which it is determined whether or not the change of the color in the text superimposed region is equal to or greater than the predetermined value on the basis of the values of the PCCS color system of the plurality of the divided regions (for example, values which specify the tone and the hue of the PCCS color system), may be used.

In the case that the font color setting unit 4021 sets the font color of the text data, when the font color setting unit 4021 determines that the change of the color in the text superimposed region in which this text is displayed is equal to or greater than the predetermined value, the font color setting unit 4021 performs, for each divided region, a process in which the average color of the RGB is obtained (similar process as step S4011 which is shown in FIG. 37), a process in which the tone and the hue of the PCCS color system are obtained (similar process as step S4012 which is shown in FIG. 37), a process in which the tone is changed (similar process as step S4013 which is shown in FIG. 37), and a process in which the font color is set (similar process as step S4014 which is shown in FIG. 37), in a similar way as the tenth embodiment, and sets the font color for each divided region.

Note that, for example, if the process in which the average color of the RGB is obtained (similar process as step S4011 which is shown in FIG. 37) or the like has already been performed, the process may not be performed again.

In the present embodiment, the whole of the font colors which are set to each of the plurality of divided regions as described above is defined as the font color which is set to the text data.

In the case that the font color is set to each of the plurality of divided regions, when there are two or more divided regions of which the difference of the average color of the RGB is less than the predetermined value in these divided regions, for example, with respect to these two or more divided regions, a font color may be obtained with respect to only any one of the divided regions, and the same font color as the one which is obtained may be set to all of these two or more divided regions.

Moreover, as another configuration example, after the font color setting unit 4021 sets the font color with respect to each of the plurality of divided regions, it is also possible to perform adjustment of the tone and the hue of the PCCS color system regarding the content of setting, such that the whole font color of the text superimposed region has unidirectional gradation.

Note that, as the information of color change determination condition 4034 which is stored in the storage unit 4016, information which is referred to when the font color setting unit 21 determines whether or not the change of the color in the text superimposed region in which the text is displayed is equal to or greater than a predetermined value, is used. For example, information which specifies a method for dividing the text superimposed region into a plurality of divided regions, information which specifies a method of determining whether or not there is a difference which is equal to or more than a predetermined value in the values of the average color of the plurality of divided regions, information which specifies a predetermined value (threshold value) that is used for a variety of determination, or the like, is used.

As is described above, in the case that there is a significant change of a color in the image region (text superimposed region) in which a text is displayed, the image processing unit 4140 according to the present embodiment sets two or more types of font colors in this image region corresponding to the change of the color.

In addition, as a configuration example, the image processing unit 4140 according to the present embodiment adjusts the tone and the hue of the PCCS color system such that the font color of the text in whole has unidirectional gradation.

Therefore, according to the image processing unit 4140 of the present embodiment, even in the case that there is a significant change of a color in the image region in which a text is displayed (text superimposed region), it is possible to improve the readability of the text. For example, in the case that there is a significant change of a color in the image region in which a text is displayed (text superimposed region), if the font color is obtained on the basis of a single average color of the image region, then the readability of the text may be degraded because the contrast of a part of the text is not acquired. However, according to the image processing unit 4140 of the present embodiment, it is possible to overcome such a problem.

Note that, in the present embodiment, furthermore, in a similar way as the eleventh embodiment, a configuration in which the font setting unit 4014 sets a font of a predetermined outline can also be used.

The process may be implemented by recording a program for performing the procedure of the process (the step of the process) which is performed in the above-described embodiments such as each step which is shown in FIG. 36 and FIG. 37 into a computer readable recording medium, causing the program recorded in this recording medium to be read by a computer system, and executing the program.

In addition, the program described above may be transmitted from the computer system which stores this program in the storage device or the like to other computer systems via a transmission medium or by transmitted waves in a transmission medium.

In addition, the program described above may be used to achieve part of the above-described functions or a particular part. Moreover, the program may be a program which can perform the above-described functions by combining the program with other programs which are already recorded in the computer system, namely, a so-called differential file (differential program).

### Other Embodiments

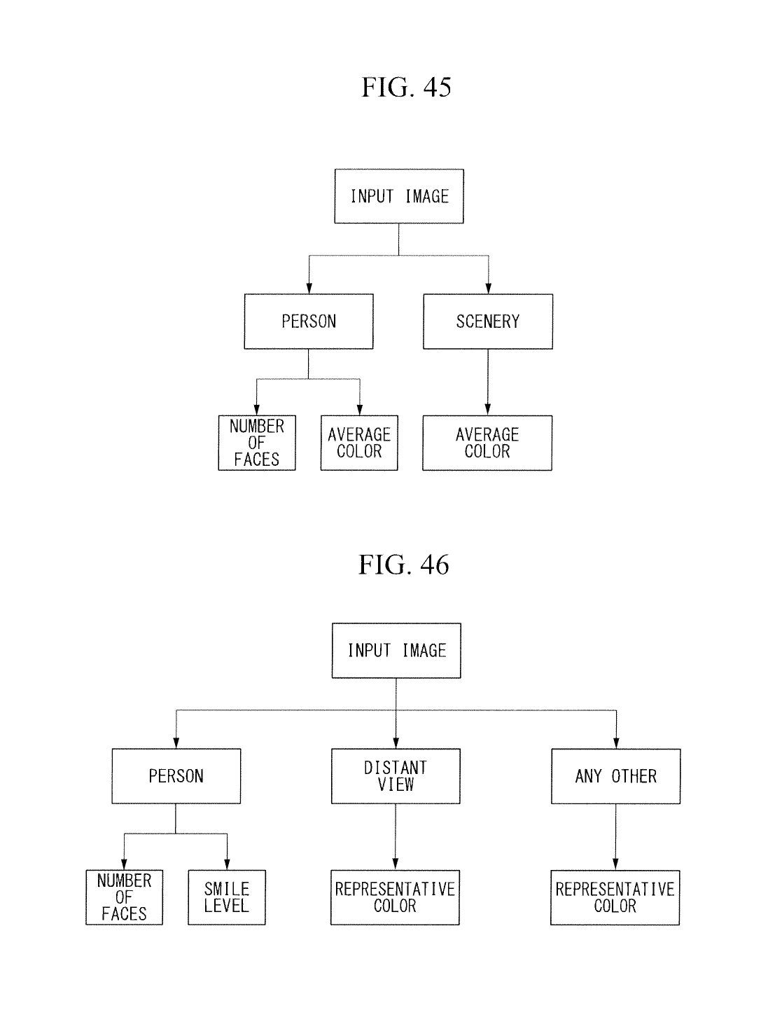

FIG. 45 is a diagram schematically showing an example of a process that extracts a characteristic attribute of a captured image which is used to determine a sentence that is placed on an image. In the example of FIG. 45, the determination unit of the image processing apparatus categorizes a scene of the captured image into a person image or a scenery image. Then, the image processing apparatus extracts the characteristic attribute of the captured image depending on the scene. The characteristic attribute can be the number of faces (the number of persons in the imaged object) and the average color (the color combination pattern) in the case of the person image, and can be the average color (the color combination pattern) in the case of the scenery image. On the basis of these characteristic attributes, a word (adjective or the like) which is inserted in the person image template or the scenery image template is determined.

In the example of FIG. 45, the color combination pattern is constituted by the combination of a plurality of representative colors which constitute the captured image. Therefore, the color combination pattern can represent an average color (average color) of the captured image. In an example, it is possible to define “the first color”, “the second color”, and “the third color” as the color combination pattern, and to determine the word (adjective) which is inserted in the sentence template for the person image or for the scenery image, on the basis of the combination of these three types of colors, namely three average colors.

In the example of FIG. 45, the scene of the captured image is categorized into two types (the person image and the scenery image). In another example, the scene of the captured image can be categorized into three or more types (three, four, five, six, seven, eight, nine, ten, or more types).

FIG. 46 is a diagram schematically showing another example of a process that extracts a characteristic attribute of a captured image which is used to determine a sentence that is placed on an image. In the example of FIG. 46, it is possible to categorize the scene of the captured image into three or more types.

In the example of FIG. 46, the determination unit of the image processing apparatus determines which one of a person image (first mode image), a distant view image (second mode image), and any other image (third mode image) is the captured image. First, the determination unit determines whether the captured image is the person image, or the captured image is an image which is different from the person image, in a similar way as the example of FIG. 45.

Next, in the case that the captured image is the image which is different from the person image, the determination unit determines which one of the distant view image (second mode image) and the any other image (third mode image) is the captured image. This determination can be performed, for example, by using a part of image identification information which is added to the captured image.

Specifically, in order to determine whether or not the captured image is the distant view image, a focus distance which is a part of the image identification information can be used. In the case that the focus distance is equal to or greater than a reference distance which is preliminarily set, the determination unit determines that the captured image is the distant view image, and in the case that the focus distance is less than the reference distance, the determination unit determines that the captured image is the any other image. Accordingly, the captured image is categorized by the scene into three types of the person image (first mode image), the distant view image (second mode image), and the any other image (third mode image). Note that, the example of the distant view image (second mode image) includes a scenery image such as a sea or a mountain, and the like, and the example of the any other image (third mode image) includes a flower, a pet, and the like.

Even in the example of FIG. 46, after the scene of the captured image is categorized, the image processing apparatus extracts the characteristic attribute of the captured image depending on the scene.

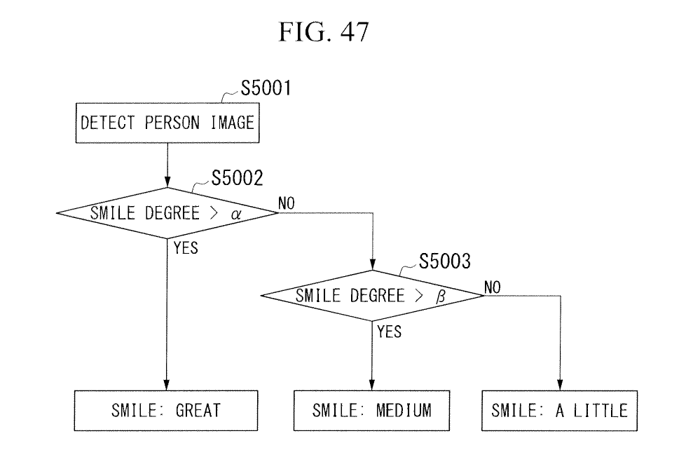

In the example of FIG. 46, in the case that the captured image is the person image (first scene image), as the characteristic attribute of the captured image which is used to determine the sentence that is placed on the image, the number of faces (the number of persons in the imaged object) and/or a smile level can be used. In other words, in the case that the captured image is the person image, it is possible to determine the word which is inserted in the person image template on the basis of the determination result of the smile level in addition to or alternative to the determination result of the number of faces (the number of persons in the imaged object). Hereinafter, an example of the determination method of the smile level will be described by using FIG. 47.

In the example of FIG. 47, the determination unit of the image processing apparatus detects a facial region with respect to the person image by a method such as face recognition (step S5001). In an example, a smile degree of the person image is calculated by quantifying the degree to which the corner part of the mouth is lifted. Note that, for the calculation of the smile degree, for example, it is possible to use a variety of publicly known techniques according to the face recognition.

Next, the determination unit compares the smile degree with a first smile threshold value α which is preliminarily set (step S5002). In the case that the smile degree is determined to be equal to or greater than α, the determination unit determines that the smile level of this person image is “smile: great”.

On the other hand, in the case that the smile degree is determined to be less than α, the determination unit compares the smile degree with a second smile threshold value β which is preliminarily set (step S5003). In the case that the smile degree is determined to be equal to or greater than β, the determination unit determines that the smile level of this person image is “smile: medium”. Moreover, in the case that the smile degree is determined to be less than 3, the determination unit determines that the smile level of this person image is “smile: a little”.

On the basis of the determination result of the smile level of the person image, the word which is inserted in the person image template is determined. The examples of the words corresponding to the smile level of “smile: great” include “quite delightful”, “very good”, and the like. The examples of the words corresponding to the smile level of “smile: medium” include “delightful”, “nicely moderate”, and the like. The examples of the words corresponding to the smile level of “smile: a little” include “serious”, “cool”, and the like.

Note that, the above-identified embodiment is described using an example in which the word which is inserted in the person image template is an attributive form. However, the word which is inserted in the person image template is not limited thereto, and, for example, may be a predicative form. In this case, the examples of the words corresponding to the smile level of “smile: great” include “your smile is nice”, “very good smile, isn't it”, and the like. The examples of the words corresponding to the smile level of “smile: medium” include “you are smiling, aren't you”, “nice expression”, and the like. The examples of the words corresponding to the smile level of “smile: a little” include “you look serious”, “you look earnest”, and the like.

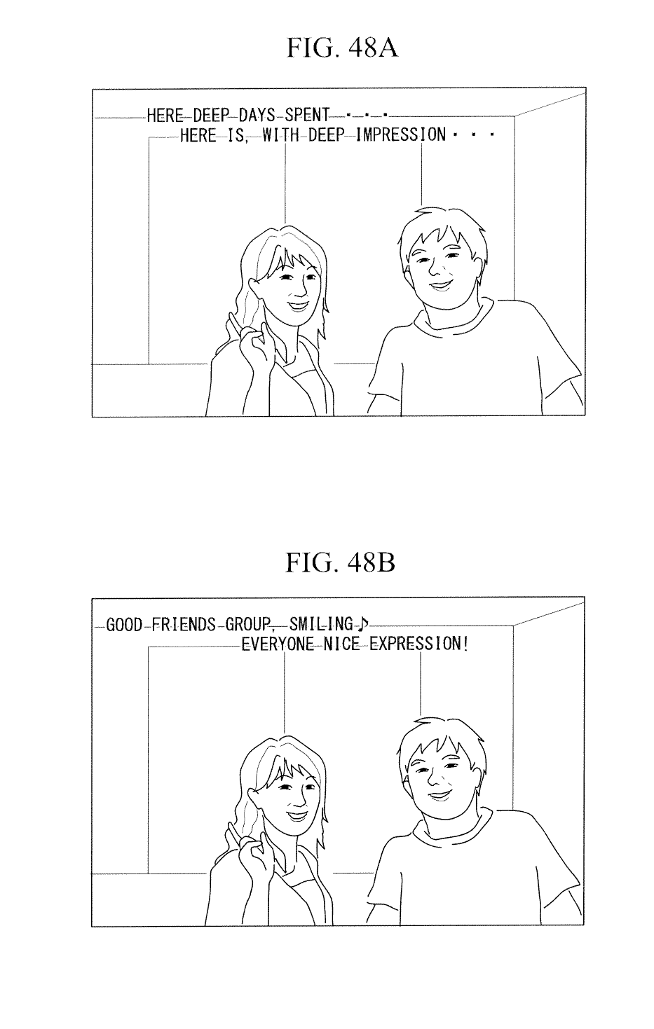

FIG. 48A is an example of an output image showing an operation result of the image processing apparatus, and this output image includes a sentence which is determined on the basis of the example of FIG. 45. In the example of FIG. 48A, it is determined that the captured image is the person image, and the number of persons in the imaged object and the color combination pattern (average color) are extracted as the characteristic attributes. In addition, it is determined that the word which is inserted in the person image template is “deep” corresponding to the color combination pattern. As a result, an output result which is shown in FIG. 48A is obtained. In other words, in the example of FIG. 48A, the word of “deep” (adjective, attributive form) is determined on the basis of the average color of the captured image.

FIG. 48B is another example of an output image showing an operation result of the image processing apparatus, and this output image includes a sentence which is determined on the basis of the example of FIG. 46. In the example of FIG. 48B, it is determined that the captured image is the person image, and the number of persons in the imaged object and the smile level are extracted as the characteristic attributes. In addition, it is determined that the word which is inserted in the person image template is “nice expression” corresponding to the smile level. As a result, an output result which is shown in FIG. 48B is obtained. In other words, in the example of FIG. 48B, the word of “nice expression” (predicative form) is determined on the basis of the smile level of the person in the captured image. As is shown in the output result of FIG. 48B, by using a word output in which the smile level is used with respect to the person image, character information which relatively adapts to the impression given by the image can be added.

With reference back to FIG. 46, in the case that the captured image is the scenery image (second scene image) or the any other image (third scene image), as the characteristic attribute of the captured image which is used to determine the sentence that is placed on the image, a representative color alternative to the average color can be used. As the representative color, “the first color” in the color combination pattern, namely the most frequently appearing color in the captured image, can be used. Alternatively, the representative color can be determined by using a clustering, as is described below.

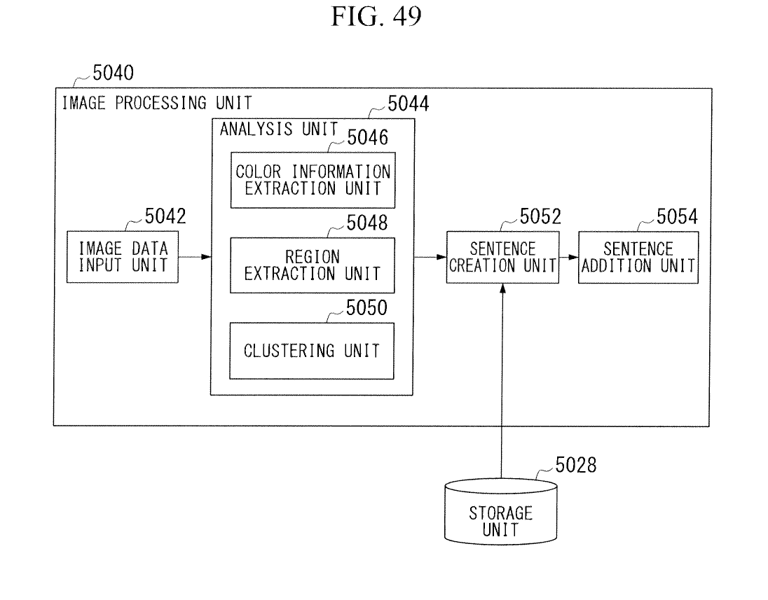

FIG. 49 is a schematic block diagram showing an internal configuration of an image processing unit which is included in an imaging apparatus. In the example of FIG. 49, the image processing unit 5040 of the image processing apparatus includes an image data input unit 5042, an analysis unit 5044, a sentence creation unit 5052, and a sentence addition unit 5054. The image processing unit 5040 performs a variety of analysis processes with respect to image data which is generated by an imaging unit or the like, and thereby the image processing unit 5040 can obtain a variety of information regarding the content of the image data, create a text having high consistency with the content of the image data, and add the text to the image data.

The analysis unit 5044 includes a color information extraction unit 5046, a region extraction unit 5048, and a clustering unit 5050, and applies an analysis process to the image data. The color information extraction unit 5046 extracts first information regarding color information of each pixel which is included in the image data, from the image data. Typically, the first information is obtained by aggregating the HSV values of all the pixels which are included in the image data. Note that, with respect to a predetermined color with a relationship in similarity (for example, related to a predetermined color space), the first information may be information indicating the frequency (frequency per pixel unit, area rate, or the like) with which this predetermined color appears in the image, and the resolution of the color or the type of the color space is not limited.

For example, the first information may be information indicating, with respect to each color which is represented by the HSV space vector (the HSV value) or the RGB value, the number of pixels of the each color which are included in the image data. Note that, the color resolution in the first information may be suitably changed in consideration of the burden of the arithmetic processing or the like. In addition, the type of the color space (color model) is not limited to HSV or RGB, and may be CMY, CMYK, or the like.

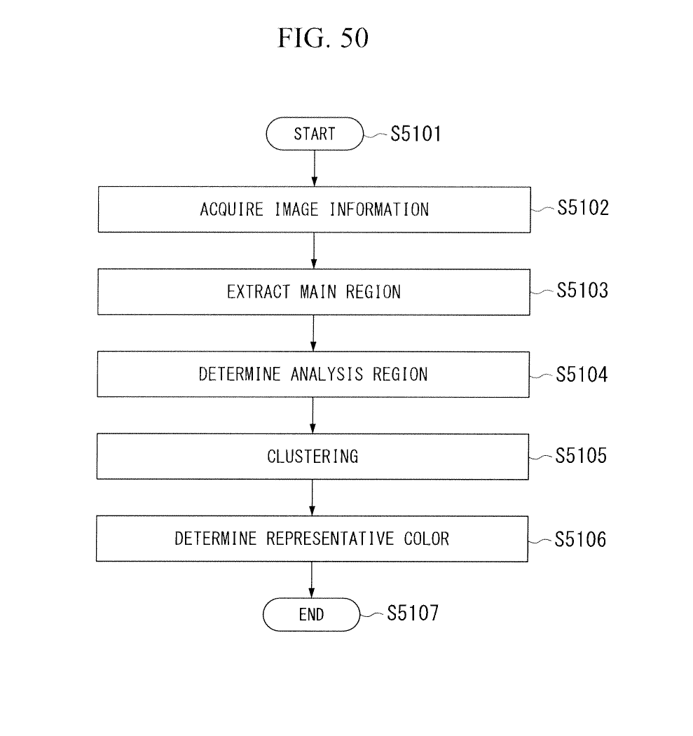

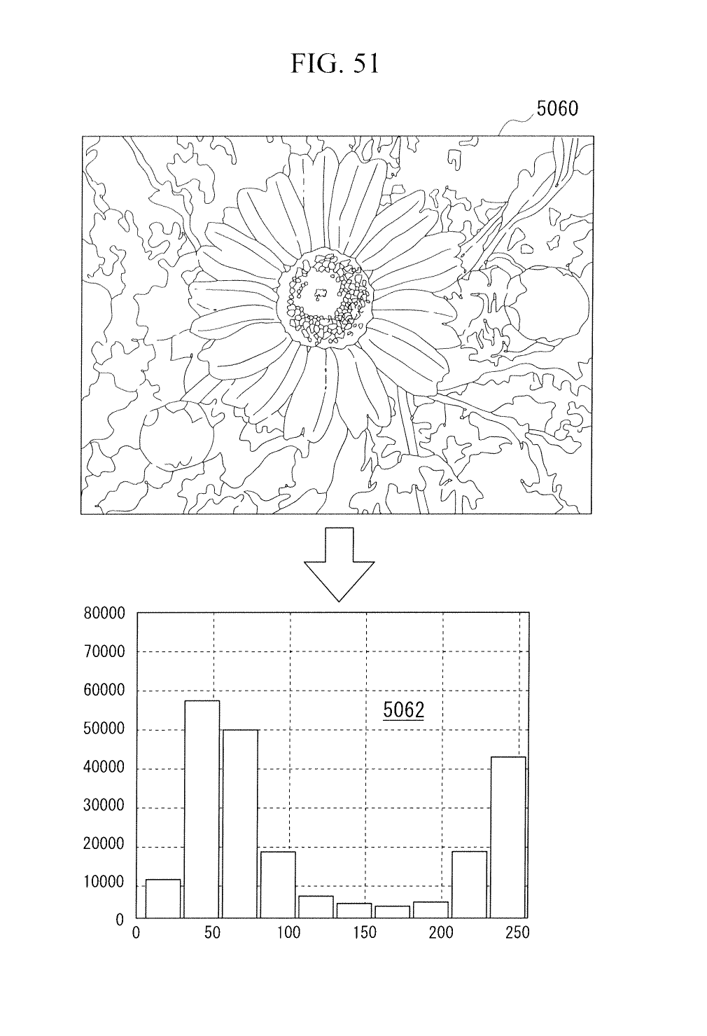

FIG. 50 is a flowchart illustrating a flow of the determination of the representative color which is performed in the analysis unit 5044. In the step S5101 of FIG. 50, the image processing apparatus begins to calculate the representative color of specific image data 5060 (captured image, refer to FIG. 51).

In step S5102, the image data input unit 5042 of the image processing apparatus outputs image data to the analysis unit 5044. Next, the color information extraction unit 5046 of the analysis unit 5044 calculates first information 5062 regarding color information of each pixel which is included in the image data (refer to FIG. 51).

FIG. 51 is a conceptual diagram showing a process for calculating the first information 5062 which is performed by the color information extraction unit 5046 in step 5102. The color information extraction unit 5046 aggregates the color information which is included in the image data 5060 for each color (for example, for each gradation of 256 gradations), and obtains the first information 5062. The histogram which is shown in the lower drawing of FIG. 51 represents an image of the first information 5062 which is calculated by the color information extraction unit 5046. The horizontal axis of the histogram of FIG. 51 represents the color, and the vertical axis represents the number of pixels of a predetermined color which are included in the image data 5060.

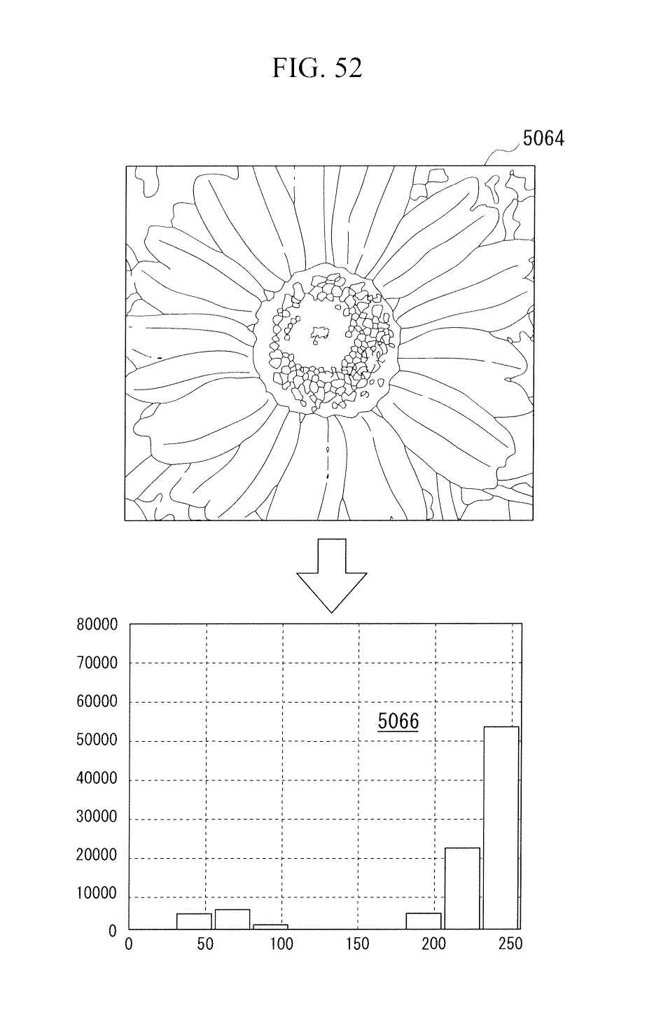

In step S5103 of FIG. 50, the region extraction unit 5048 of the analysis unit 5044 extracts a main region in the image data 5060. For example, the region extraction unit 5048 extracts a region in focus from the image data 5060 which is shown in FIG. 51, and identifies a center portion of the image data 5060 as the main region (refer to a main region 5064 in FIG. 52).

In step S5104 of FIG. 50, the region extraction unit 5048 of the analysis unit 5044 determines a target region of the clustering which is performed in step S5105. For example, in the case that the region extraction unit 5048 recognizes that a part of the image data 5060 is the main region 5064 in step S5103 as is shown in the upper portion of FIG. 52 and extracts the main region 5064, the region extraction unit 5048 determines that the target of the clustering is the first information 5062 which corresponds to the main region 5064 (main first information 5066). The histogram which is shown in the lower drawing of FIG. 52 represents an image of the main first information 5066.

On the other hand, in the case that the region extraction unit 5048 does not extract the main region 5064 in the image data 5060 in step S5103, the region extraction unit 5048 determines that the first information 5062 which corresponds to the whole region of the image data 5060 is the target of the clustering as is shown in FIG. 51. Note that, except for the difference in the target region of the clustering, there is no difference in the following process between the case in which the main region 5064 is extracted and the case in which the main region 5064 is not extracted. Therefore, hereinafter, an example of the case in which the main region is extracted will be described.

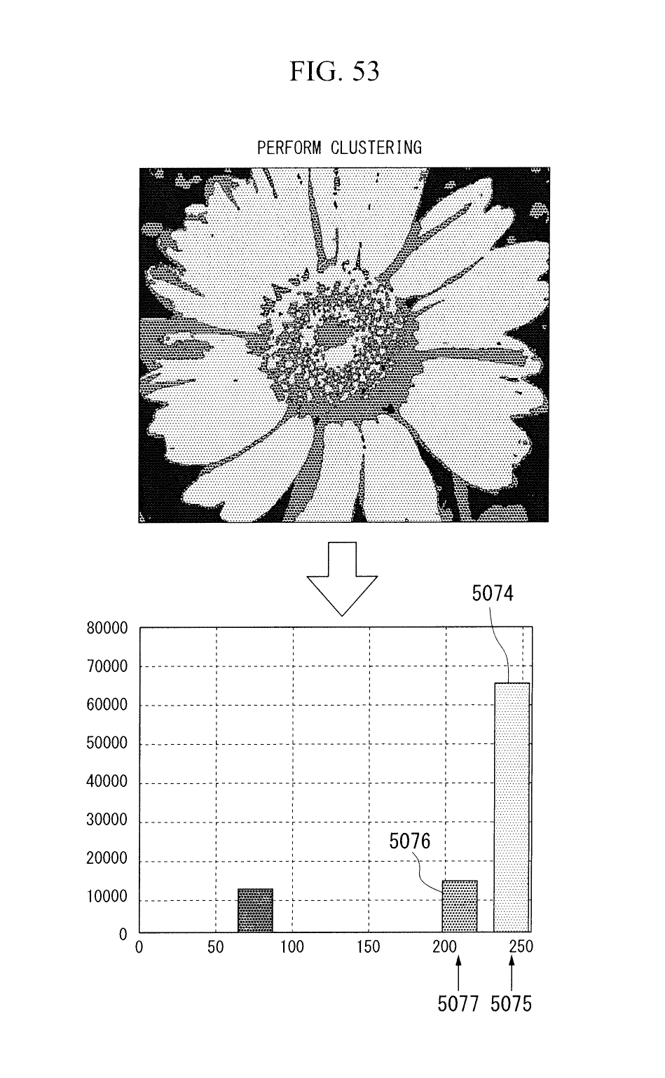

In step S5105 of FIG. 50, the clustering unit 5050 of the analysis unit 5044 performs a clustering with respect to the main first information 5066 which is the first information 5062 of the region which is determined in step S5104. FIG. 53 is a conceptual diagram showing a result of the clustering which is performed by the clustering unit 5050 with respect to the main first information 5066 of the main region 5064 which is shown in FIG. 52.

The clustering unit 5050 categorizes, for example, the main first information 5066 in 256 gradations (refer to FIG. 52) into a plurality of clusters by using a k-means method. Note that, the clustering is not limited to the k-means method (k averaging method). In another example, other methods such as a minimum distance method and the like can be used.

The upper portion of FIG. 53 represents the cluster into which each pixel is categorized, and the histogram which is shown in the lower portion of FIG. 53 shows the number of pixels which belong to each cluster. By the clustering by the clustering unit 5050, the main first information 5066 in 256 gradations (FIG. 52) is categorized into clusters which are less than 256 (in the example shown in FIG. 53, three clusters). The result of the clustering can include information regarding the size of each cluster and the information regarding the color of each cluster (the position on the color space of the cluster).

In step S5106, the clustering unit 5050 of the analysis unit 5044 determines the representative color of the image data 5060 on the basis of the result of the clustering. In an example, in the case that the clustering unit 5050 obtains the clustering result as is shown in FIG. 53, the clustering unit 5050 defines the color which belongs to a maximum cluster 5074 including the largest number of pixels of the calculated plurality of clusters, as the representative color of the image data 5060.

When the calculation of the representative color is finished, the sentence creation unit 5052 creates a text by using information relating to the representative color and adds the text to the image data 5060.

The sentence creation unit 5052 reads out, for example, a sentence template used for the scenery image and applies a word corresponding to the generation date of the image data 5060 (for example, “2012/03/10”) to {date} of the sentence template. In this case, the analysis unit 5044 can search information relating to the generation date of the image data 5060 from a storage medium or the like and output the information to the sentence creation unit 5052.

In addition, the sentence creation unit 5052 applies a word corresponding to the representative color of the image data 5060 to {adjective} of the sentence template. The sentence creation unit 5052 reads out corresponding information from the storage unit 5028 and applies the corresponding information to the sentence template. In an example, in the storage unit 5028, a table in which a color is related to a word for each scene is stored. The sentence creation unit 5052 can create a sentence (for example, “I found a very beautiful thing”) by using a word which is read out from the table.

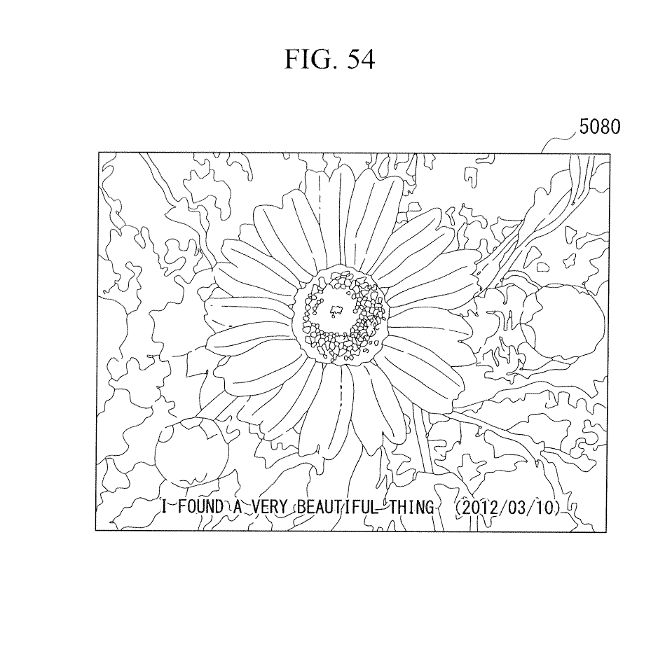

FIG. 54 shows image data 5080 to which a text is added by the above-described sequence of processes.

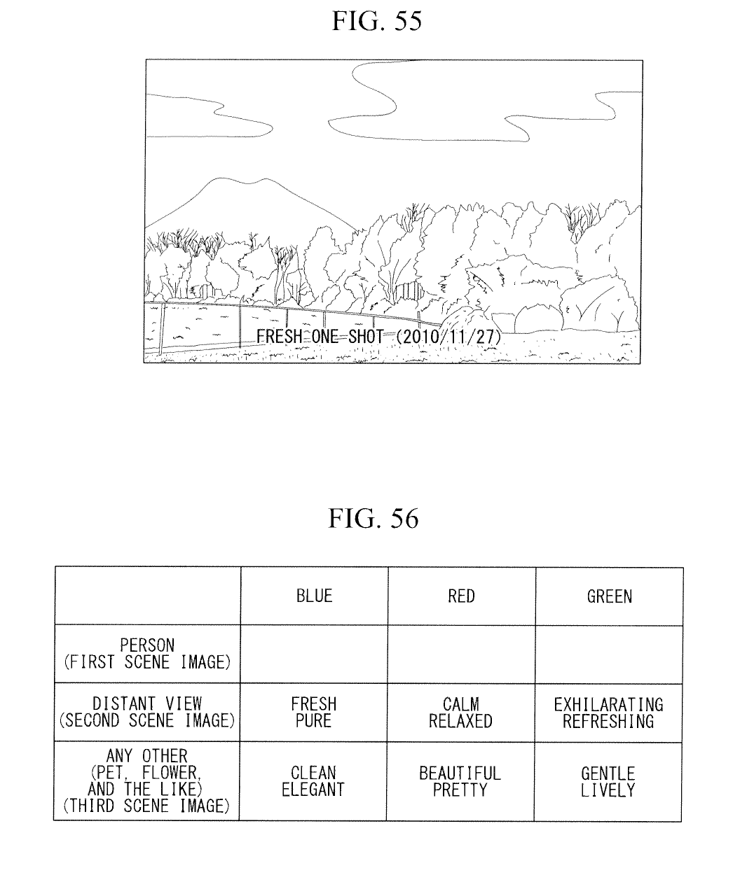

FIG. 55 shows an example of image data to which a text is added by the sequence of processes which is similar as described above, in the case that the scene is a distant view image. In this case, the scene is categorized into the distant view image, and it is determined that the representative color is blue. For example, in the table in which a color is related to a word for each scene, a word “fresh” and the like are related to a representative color “blue”.

FIG. 56 is a diagram showing an example of the table having correspondence information between a color and a word. In the table of FIG. 56, the color is related to the word for each scene of the person image (first scene image), the distant view image (second scene image), or the any other image (third scene image). In an example, when the representative color of the image data is “blue” and the scene is any other image (third scene image), the sentence creation unit 5052 selects a word which corresponds to the representative color (for example, “elegant”) from the correspondence information of the table and applies the word to (adjective) of the sentence template.

It is possible to set the correspondence table between a color and a word, for example, on the basis of a color chart of the PCCS color system, the CICC color system, the NCS color system, or the like.

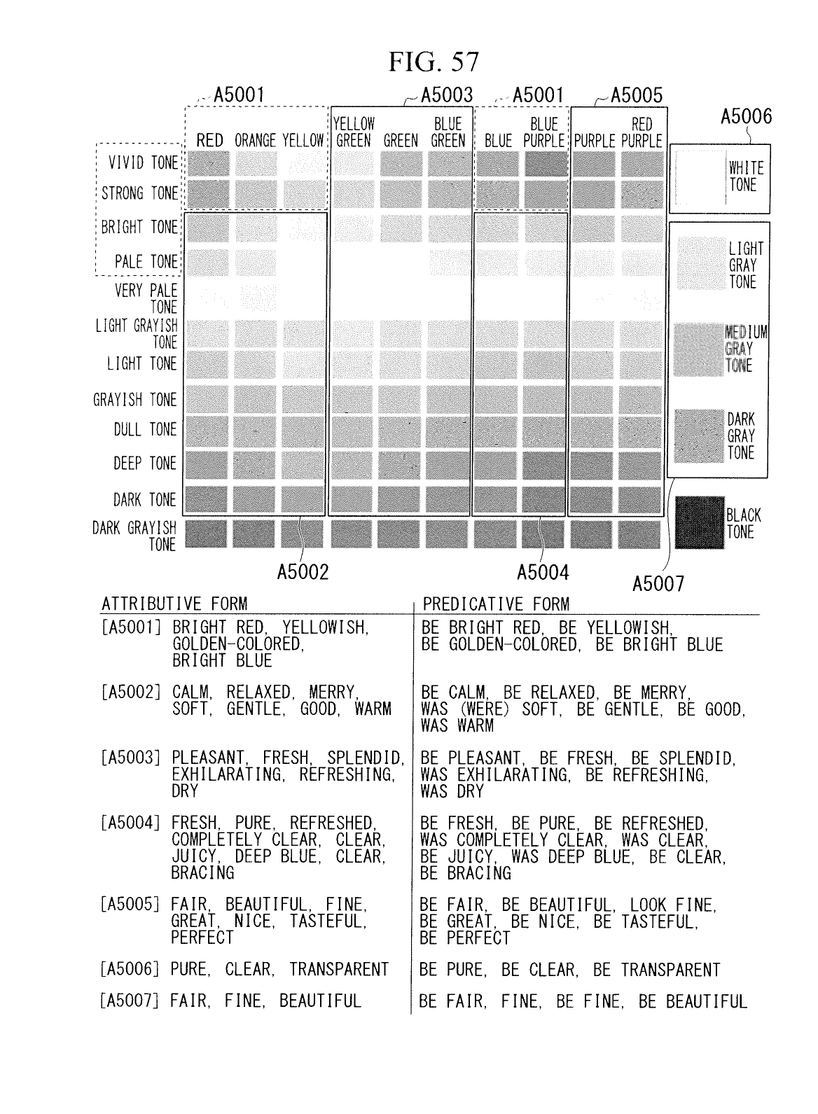

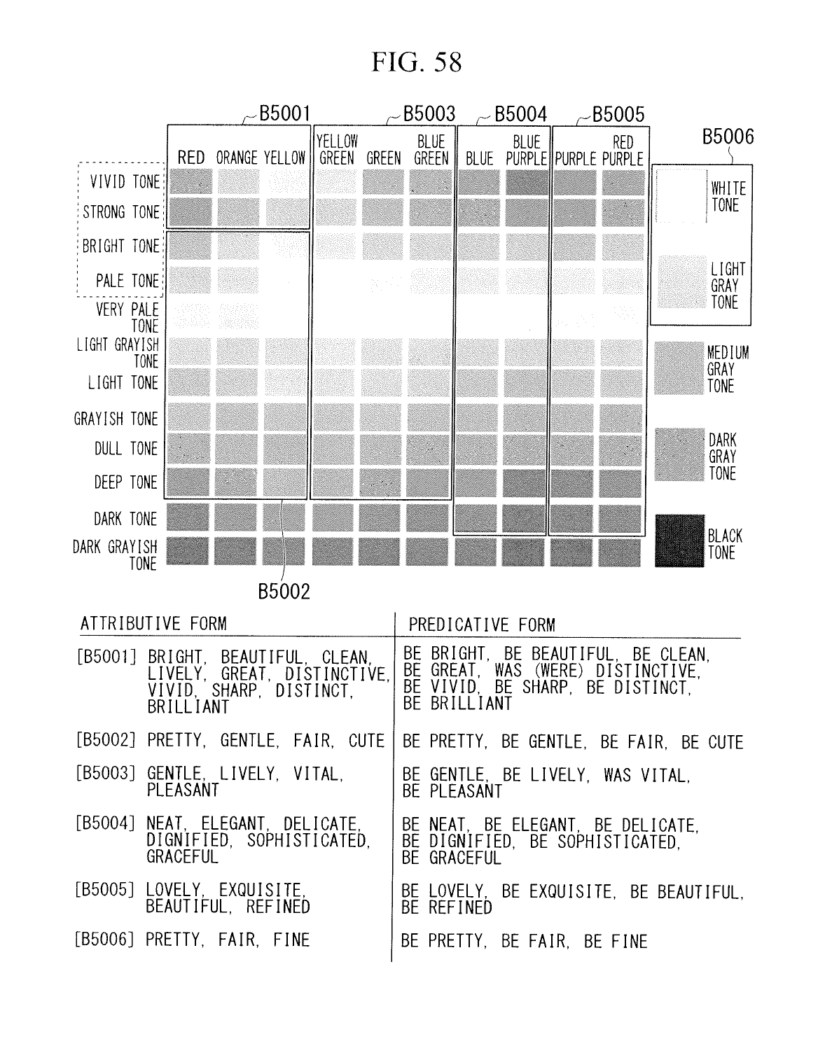

FIG. 57 shows an example of a correspondence table used for the distant view image (second scene image) which uses the color chart of the CCIC color system. FIG. 58 shows an example of a correspondence table used for the any other image (third scene image) which uses the color chart of the CCIC color system.

In FIG. 57, the horizontal axis corresponds to the hue of the representative color, and the vertical axis corresponds to the tone of the representative color. By using the table of FIG. 57 for determination of a word, it is possible to determine a word on the basis of not only information of the hue of the representative color but information of the tone of the representative color additionally and to add a text which relatively adapts to the human sensitivity. Hereinafter, a specific example of setting of a text by using the table of FIG. 57 in the case of the distant view image (second scene image) will be described. Note that, in the case of the any other image (third scene image), it is possible to perform the setting similarly by using the table of FIG. 58.

In FIG. 57, in the case that it is determined that the representative color is a color of a region A5001, the naming of the representative color (red, orange, yellow, blue, or the like) is directly applied to the word in the text. For example, in the case that the hue of the representative color is “red (R)” and that the tone is “vivid tone (V)”, an adjective “bright red” which represents the color or the like, is selected.

In addition, in the case that it is determined that the representative color is a color of a region A5002, A5003, A5004, or A5005, an adjective which is reminded of by the color is applied to the word in the text. For example, in the case that it is determined that the representative color is a color of the region A5003 (green), “pleasant”, “fresh”, or the like, which is an adjective associated with green, is applied.

Note that, in the case that it is determined that the representative color is a color in any one of the regions A5001 to A5005 and that the tone is a vivid tone (V), a strong tone (S), a bright tone (B), or a pale tone (LT), an adverb which represents degree (examples: very, considerably, and the like) is applied to the adjective.

In the case that it is determined that the representative color is a color of a region A5006, namely “white tone (white)”, “pure”, “clear”, or the like, which is a word associated with white, is selected. In addition, in the case that it is determined that the representative color is a color of a region A5007, namely a grayish color (a light gray tone: ltGY, a medium gray tone: mGY, or a dark gray tone: dkGY), “fair”, “fine”, or the like, which is a safe adjective, is selected. In an image in which a representative color is white or a grayish color, in other words, an achromatic color, a variety of colors are included in the whole image in many cases. Therefore, by using a word which has little relevancy to a color, it is possible to prevent from addition of text having an irrelevant meaning and to add text which relatively adapts to the impression given by the image.

In addition, in the case that the representative color belongs to none of the regions A5001 to A5007, in other words, in the case that the representative color is a low-tone color (a dark grayish tone), or black (a black tone), it is possible to select a character (a word or a sentence) having a specified meaning as the text. The character having a specified meaning includes, for example, “where am I”, “oh”, and the like. It is possible to store these word and sentence in the storage unit of the image processing apparatus as a “twitter dictionary”.

In other words, there may be a case in which it is difficult to determine the hue of the overall image when it is determined that the representative color is a low-tone color or black. However, in such a case, by using a character which has little relevancy to a color as described above, it is possible to prevent text with an irrelevant meaning from being added and to add text which adapts to the impression given by the image.

In addition, the above-identified embodiment is described using an example in which the sentence and the word are unambiguously determined corresponding to the scene and the representative color; however, the method for determination is not limited thereto. In the selection of the sentence and the word, it is possible to occasionally perform an exceptional process. For example, a text may be extracted from the above-described “twitter dictionary” once a given plurality of times (for example, once every ten times). Thereby, because the display content of the text does not necessarily follow fixed patterns, it is possible to prevent the user from getting bored with the display content.

Note that, the above-identified embodiment is described using an example in which the sentence addition unit places the text which is generated by the sentence creation unit in an upper portion of the image or in a lower portion of the image; however, the placement position is not limited thereto. For example, it is possible to place the text outside (outside the frame of) the image.

In addition, the above-identified embodiment is described using an example in which the position of the text fixes within the image. However, the method for placement is not limited thereto. For example, it is possible to display text such that the text streams in the display unit of the image processing apparatus. Thereby, the input image is less affected by the text, or the visibility of the text is improved.

In addition, the above-identified embodiment is described using an example in which the text is always attached to the image. However, the method for attachment is not limited thereto. For example, the text may not be attached in the case of a person image, and the text may be attached in the case of the distant view image or any other image.

In addition, the above-identified embodiment is described using an example in which the sentence addition unit determines the display format (such as the font, the color, and the display position) of the text which is generated by the sentence creation unit by using a predetermined method. However, the method is not limited thereto. It is possible to determine the display format of the text by using a variety of methods. Hereinafter, some examples of these methods are described.

In an example, the user can modify the display format (the font, the color, and the display position) of the text via the operation unit of the image processing apparatus. Alternatively, the user can change or delete the content (words) of the text. In addition, the user can set such that the whole text is not displayed, in other words, the user can select display/non-display of the text.

In addition, in an example, it is possible to change the size of the text depending on the scene of the input image. For example, it is possible to decrease the size of the text in a case that the scene of the input image is the person image and to increase the size of the text in the case that the scene of the input image is the distant view image or any other image.

In addition, in an example, it is also possible to display the text with emphasis and superimpose the emphasized text on the image data. For example, in the case that the input image is a person image, it is possible to add a balloon to the person and to place the text in the balloon.

In addition, in an example, it is possible to set the display color of the text on the basis of the representative color of the input image. Specifically, it is possible to use a color with a hue the same as that of the representative color of the image and with a tone different from that of the representative color of the image, as the display color of the text. Thereby, the text is not excessively emphasized, and it is possible to add text which moderately matches the input image.

In addition, specifically in the case that the representative color of the input image is white, an exceptional process may be performed in the determination of the display color of the text. Note that, in the exceptional process, for example, it is possible to set the color of the text to white and to set the color of the peripheral part of the text to black.

While embodiments of the present invention have been described in detail with reference to the drawings, it should be understood that specific configurations are not limited to the examples described above. A variety of design modifications or the like can be made without departing from the scope of the present invention.

For example, in the above-described embodiment, the imaging apparatus 1100 includes the image processing unit (image processing apparatus) 3140, 3140a, 3140b, or 4140. However, for example, a terminal device such as a personal computer, a tablet PC (Personal Computer), a digital camera, or a cellular phone, may include the image processing unit 3140, 3140a, 3140b, or 4140 which is the image processing apparatus.

### DESCRIPTION OF THE REFERENCE SYMBOLS

1001: IMAGE PROCESSING APPARATUS
1010: IMAGE INPUT UNIT
1020: DETERMINATION UNIT
1030: SENTENCE CREATION UNIT
1040: SENTENCE ADDITION UNIT
1090: STORAGE UNIT
1100: IMAGING APPARATUS
1110: IMAGING UNIT
1111: OPTICAL SYSTEM
1119: IMAGING ELEMENT
1120: A/D CONVERSION UNIT
1130: BUFFER MEMORY UNIT
1140: IMAGE PROCESSING UNIT
1150: DISPLAY UNIT
1160: STORAGE UNIT
1170: COMMUNICATION UNIT
1180: OPERATION UNIT
1190: CPU
1200: STORAGE MEDIUM
1300: BUS
2100: IMAGING APPARATUS
2001: IMAGING SYSTEM
2002: IMAGING UNIT
2003: CAMERA CONTROL UNIT
2004, 2004a, 2004b: IMAGE PROCESSING UNIT
2005: STORAGE UNIT
2006: BUFFER MEMORY UNIT
2007: DISPLAY UNIT
2011: OPERATION UNIT
2012: COMMUNICATION UNIT
2013: POWER SUPPLY UNIT
2015: BUS
2021: LENS UNIT
2022: IMAGING ELEMENT
2023: AD CONVERSION UNIT
2041, 2041b: IMAGE ACQUISITION UNIT
2042, 2042b: IMAGE IDENTIFICATION INFORMATION ACQUISITION UNIT
2043, 2043b: COLOR-SPACE VECTOR GENERATION UNIT
2044: MAIN COLOR EXTRACTION UNIT
2045: TABLE STORAGE UNIT
2046, 2046a: FIRST-LABEL GENERATION UNIT
2047: SECOND-LABEL GENERATION UNIT
2048: LABEL OUTPUT UNIT
2241: CHARACTERISTIC ATTRIBUTE EXTRACTION UNIT
2242: SCENE DETERMINATION UNIT
3011: IMAGE INPUT UNIT
3012: TEXT INPUT UNIT
3013: FIRST POSITION INPUT UNIT
3014: EDGE DETECTION UNIT
3015: FACE DETECTION UNIT
3016: CHARACTER SIZE DETERMINATION UNIT
3017, 3017a: COST CALCULATION UNIT
3018, 3018b: REGION DETERMINATION UNIT
3019: SUPERIMPOSITION UNIT
3021, 3031: SECOND POSITION INPUT UNIT
3140, 3140a, 3140b: IMAGE PROCESSING UNIT
4011: IMAGE INPUT UNIT
4012: TEXT SETTING UNIT
4013: TEXT SUPERIMPOSED REGION SETTING UNIT
4014: FONT SETTING UNIT
4015: SUPERIMPOSED IMAGE GENERATION UNIT
4016: STORAGE UNIT
4021: FONT COLOR SETTING UNIT
4031: INFORMATION OF A CONVERSION TABLE FROM THE RGB SYSTEM TO THE PCCS COLOR SYSTEM
4032: INFORMATION OF A TONE CONVERSION TABLE
4033: OUTLINE INFORMATION
4034: INFORMATION OF COLOR CHANGE DETERMINATION CONDITION
4140: IMAGE PROCESSING UNIT

1. An image processing apparatus comprising:
an image input unit that inputs a captured image;
a storage unit that stores a person image template that is used to create a sentence for a person image in which a person is an imaged object, and a scenery image template that is used to create a sentence for a scenery image in which a scene is an imaged object, as a sentence template in which a word is inserted into a predetermined blank portion and a sentence is completed;
a determination unit that determines whether the captured image is the person image or the captured image is the scenery image; and
a sentence creation unit that creates a sentence for the captured image, by reading out the sentence template which is any one of the person image template and the scenery image template from the storage unit depending on a determination result by the determination unit with respect to the captured image, and inserting a word according to a characteristic attribute of the captured image or an imaging condition of the captured image into the blank portion of the sentence template which is read out.

2. The image processing apparatus according to claim 1, wherein
the storage unit
stores, as the person image template, the sentence template in which the blank portion is set to a sentence from a viewpoint of a person who is captured as an imaged object, and
stores, as the scenery image template, the sentence template in which the blank portion is set to a sentence from a viewpoint of an image capture person who captures an imaged object.

3. The image processing apparatus according to claim 1, wherein
the determination unit
determines, in addition, a number of persons in an imaged object as the characteristic attribute, with respect to the person image, and
the sentence creation unit
inserts a word according to a number of persons in an imaged object into the blank portion and creates a sentence, with respect to the person image.

4. The image processing apparatus according to claim 3, wherein
the determination unit,
in the case that a plurality of facial regions are identified within the captured image,
when a ratio of a size of the largest facial region to a size of the captured image is equal to or greater than a first threshold value and is less than a second threshold value which is a value equal to or greater than the first threshold value, and a standard deviation or dispersion of ratios of a plurality of facial regions or a standard deviation or dispersion of sizes of a plurality of facial regions is less than a third threshold value,
or when the ratio of a size of the largest facial region is equal to or greater than the second threshold value,
determines that the captured image is the person image and also determines a number of persons in an imaged object on the basis of a number of facial regions having a ratio equal to or greater than the first threshold value.

5. The image processing apparatus according to claim 1, wherein
the sentence creation unit
inserts an adjective according to a color combination pattern of the captured image, as a word according to the characteristic attribute of the captured image, into the blank portion and creates a sentence.

6. The image processing apparatus according to claim 5, wherein
the sentence creation unit
inserts an adjective according to a color combination pattern of a predetermined region of the captured image into the blank portion and creates a sentence, the predetermined region being determined depending on whether the captured image is the person image or the captured image is the scenery image.

7. An image processing apparatus comprising:
an image input unit to which a captured image is input:
a decision unit that determines a text corresponding to at least one of a characteristic attribute of the captured image and an imaging condition of the captured image:
a determination unit that determines whether the captured image is an image of a first category or the captured image is an image of a second category that is different from the tirst category;
a storage unit that stores a first syntax which is a syntax of a sentence used for the first category and a second syntax which is a syntax of a sentence used for the second category; and
a sentence creation unit that creates a sentence of the first syntax using the text determined by the decision unit when the determination unit determines that the captured image is an image of the first category, and creates a sentence of the second syntax using the text determined by the decision unit when the determination unit determines that the captured image is an image of the second category.

8. The image processing apparatus according to claim 7, wherein the first category is a portrait and the second category is a scene.

9. An imaging apparatus comprising:
an imaging unit that images an object and generates a captured image;
a storage unit that stores a person image template that is used to create a sentence for a person image in which a person is an imaged object, and a scenery image template that is used to create a sentence for a scenery image in which a scene is an imaged object, as a sentence template in which a word is inserted into a predetermined blank portion and a sentence is completed;
a determination unit that determines whether the captured image is the person image or the captured image is the scenery image; and
a sentence creation unit that creates a sentence for the captured image, by reading out the sentence template which is any one of the person image template and the scenery image template from the storage unit depending on a determination result by the determination unit with respect to the captured image, and inserting a word according to a characteristic attribute of the captured image or an imaging condition of the captured image into the blank portion of the sentence template which is read out.

10. A program used to cause a computer of an image processing apparatus, the image processing apparatus comprising a storage unit that stores a person image template that is used to create a sentence for a person image in which a person is an imaged object and a scenery image template that is used to create a sentence for a scenery image in which a scene is an imaged object as a sentence template in which a word is inserted into a predetermined blank portion and a sentence is completed, to execute:
an image input step of inputting a captured image;
a determination step of determining whether the captured image is the person image or the captured image is the scenery image; and
a sentence creation step of creating a sentence for the captured image, by reading out the sentence template which is any one of the person image template and the scenery image template from the storage unit depending on a determination result by the determination step with respect to the captured image, and inserting a word according to a characteristic attribute of the captured image or an imaging condition of the captured image into the blank portion of the sentence template which is read out.

11. An image processing apparatus comprising:
a decision unit that determines a character having a predetermined meaning from a captured image;
a determination unit that determines whether the captured image is a person image or the captured image is an image which is different from the person image;
a storage unit that stores a first syntax which is a syntax of a sentence used for the person image and a second syntax which is a syntax of a sentence used for the image which is different from the person image; and
an output unit that outputs a sentence of the first syntax using the character having a predetermined meaning when the determination unit determines that the captured image is the person image, and outputs a sentence of the second syntax using the character having a predetermined meaning when the determination unit determines that the captured image is the image which is different from the person image.

12. An image processing apparatus comprising:
an image acquisition unit that acquires captured image data;
a scene determination unit that determines a scene from the acquired image data:
a main color extraction unit that extracts a main color on the basis of frequency distribution of color information from the acquired image data;
a storage unit in which color information and a first label are preliminarily stored in a related manner for each scene; and
a first-label generation unit that reads out the first label which is preliminarily stored and related to the extracted main color and the determined scene from the storage unit, and generates the first label which is read out as a label of the acquired image data.

13. The image processing apparatus according to claim 12, comprising
a second-label generation unit that normalizes, on the basis of frequencies of extracted main colors, a ratio of the main colors, and generates a second label by modifying the first label on the basis of the normalized ratio of the main colors.

14. The image processing apparatus according to claim 12, wherein
in the storage unit,
combination information of a plurality of color information is associated with a label for each of the determined scene.

15. The image processing apparatus according to claim 12, wherein,
the scene determination unit
acquires image identification information from the acquired image data, extracts information indicating the scene from the acquired image identification information, and determines the scene of the image data on the basis of the extracted information indicating the scene.

16. The image processing apparatus according to claim 15, wherein
the scene determination unit
extracts a characteristic attribute from the acquired image data and determines the scene of the image data on the basis of the extracted characteristic attribute.

17. The image processing apparatus according to claim 12, comprising
a region extraction unit that extracts a region from which the main color is extracted, from the acquired image data on the basis of the determined scene, wherein
the main color extraction unit
extracts the main color from image data of the region from which the main color is extracted.

18. The image processing apparatus according to claim 13, wherein
information on the basis of the first label and a second label which is generated by modifying the first label, or information on the basis of the first label or the second label, is stored in association with the acquired image data in the storage unit.

19. An imaging apparatus comprising the image processing apparatus according to claim 12.

20. A program used to cause a computer to execute an image processing of an image processing apparatus having an imaging unit, the program causing the computer to execute:
an image acquisition step of acquiring captured image data;
a scene determination step of determining a scene from the acquired image data;
a main color extraction step of extracting a main color on the basis of frequency distribution of color information from the acquired image data; and
a first-label generation step of reading out the extracted main color and a first label from a storage unit in which color information and the first label are preliminarily stored in a related manner for each scene, and generating the first label which is read out as a label of the acquired image data.

21. An image processing apparatus comprising:
a scene determination unit that determines whether or not a scene is a person imaging scene;
a color extraction unit that extracts color information from the image data when the scene determination unit determines that a scene is not a person imaging scene;
a storage unit in which color information and a character having a predetermined meaning are preliminarily stored in a related manner; and
a readout unit that reads out the character having a predetermined meaning corresponding to the color information extracted by the color extraction unit from the storage unit when the scene determination unit determines that a scene is not a person imaging scene.

22. An image processing apparatus comprising:
an acquisition unit that acquires image data and text data;
a detection unit that detects an edge of the image data acquired by the acquisition unit;
a region determination unit that determines a region in which the text data is placed in the image data, on the basis of the edge detected by the detection unit; and
an image generation unit that generates an image in which the text data is placed in the region determined by the region determination unit.

23. The image processing apparatus according to claim 22, wherein
the region determination unit determines a region having a small number of edges in the image data as the region in which the text data is placed.

24. An image processing apparatus comprising:
an image input unit that inputs image data;
an edge detection unit that detects an edge in the image data input by the image input unit;
a text input unit that inputs text data;
a region determination unit that determines a superimposed region of the text data in the image data, on the basis of the edge detected by the edge detection unit; and
a superimposition unit that superimposes the text data on the superimposed region determined by the region determination unit.

25. The image processing apparatus according to claim 24, wherein
the region determination unit determines a region having a small number of edges in the image data as the superimposed region.

26. The image processing apparatus according to claim 24, comprising
a cost calculation unit that calculates a cost representing a degree of importance in each position of the image data, such that a cost of a position, where the edge which is detected by the edge detection unit is positioned, is set to be high, wherein
the region determination unit determines, on the basis of the cost which is calculated by the cost calculation unit, a region where the cost is low and which corresponds to the superimposed region as the superimposed region.

27. The image processing apparatus according to claim 26, comprising
a first position input unit that inputs a first position in the image data, wherein
the cost calculation unit sets a cost to be higher as the position is closer to a the first position which is input by the first position input unit and sets a cost to be lower as the position is farther from the first position.

28. The image processing apparatus according to claim 26, comprising
a face detection unit that detects a face of a person from the image data, wherein
the cost calculation unit sets a cost of a region, where the face which is detected by the face detection unit is positioned, to be high.

29. The image processing apparatus according to claim 26, comprising
a second position input unit that inputs a second position where the text data is superimposed, wherein
the cost calculation unit sets a cost of the second position which is input by the second position input unit to be low.

30. The image processing apparatus according to claim 24, comprising
a character size determination unit that determines a character size of the text data such that the text including all texts of the text data can be superimposed within an image region of the image data.

31. The image processing apparatus according to claim 24, wherein
the image input unit inputs image data of a moving image, and
the region determination unit determines the superimposed region of the text data on the basis of a plurality of frame images which are included in the image data of the moving image.

32. A program causing a computer to execute:
a step of inputting image data;
a step of inputting text data;
a step of detecting an edge in the input image data;
a step of determining a superimposed region of the text data in the image data, on the basis of the detected edge; and
a step of superimposing the text data on the determined superimposed region.

33. An image processing method comprising:
a step in which an image processing apparatus inputs image data;
a step in which the image processing apparatus inputs text data;
a step in which the image processing apparatus detects an edge in the input image data;
a step in which the image processing apparatus determines a superimposed region of the text data in the image data, on the basis of the detected edge; and
a step in which the image processing apparatus superimposes the text data on the determined superimposed region.

34. An imaging apparatus comprising the image processing apparatus according to claim 24.

35. An image processing apparatus comprising:
a detection unit that detects an edge of image data;
a region determination unit that determines a placement region in which a character is placed in the image data, on the basis of a position of the edge detected by the detection unit; and
an image generation unit that generates an image in which the character is placed in the placement region determined by the region determination unit.

36. An image processing apparatus comprising:
an image input unit that inputs image data;
a text setting unit that sets text data;
a text superimposed region setting unit that sets a text superimposed region that is a region on which the text data set by the text setting unit is superimposed in the image data input by the image input unit;
a font setting unit including a font color setting unit that sets a font color with an unchanged hue and a changed tone with respect to the hue and the tone of a PCCS (Practical Color Co-ordinate System) color system on the basis of the image data input by the image input unit and the text superimposed region set by the text superimposed region setting unit, the font setting unit setting a font including at least a font color; and
a superimposed image generation unit that generates data of a superimposed image that is data of an image in which the text data set by the text setting unit is superimposed on the text superimposed region set by the text superimposed region setting unit in the image data input by the image input unit using the font including at least the font color set by the font setting unit.

37. The image processing apparatus according to claim 36, wherein
the font color setting unit obtains an average color of RGB of the text superimposed region which is set by the text superimposed region setting unit in the image data which is input by the image input unit, obtains the tone and the hue of the PCCS color system from the obtained average color of the RGB, and sets a font color of which only the tone is changed of the obtained tone and the obtained hue of the PCCS color system.

38. The image processing apparatus according to claim 36, wherein
the font color setting unit changes the tone into a white tone or a light gray tone with respect to a relatively dark tone in the PCCS color system.

39. The image processing apparatus according to claim 36, wherein
the font color setting unit changes the tone into another tone which is a tone of a chromatic color and is in the relation regarding harmony of contrast, with respect to a relatively bright tone in the PCCS color system.

40. The image processing apparatus according to claim 39, wherein
the font color setting unit changes, with respect to a tone which is a relatively bright tone and has a plurality of other tones of a chromatic color and in the relation regarding harmony of contrast, the tone into a tone which is the most vivid tone of the plurality of other tones, in the PCCS color system.

41. The image processing apparatus according to claim 36, wherein
the font setting unit sets a font color by the font color setting unit and also sets a font of an outline.

42. The image processing apparatus according to claim 36, wherein
the font color setting unit determines whether or not a change of a color in the text superimposed region which is set by the text superimposed region setting unit in the image data which is input by the image input unit is equal to or greater than a predetermined value, and when the font color setting unit determines that the change of the color in the text superimposed region is equal to or greater than the predetermined value, the font color setting unit sets two or more types of font colors in the text superimposed region.

43. A program causing a computer to execute:
a step of inputting image data;
a step of setting text data;
a step of setting a text superimposed region that is a region on which the set text data is superimposed in the input image data;
a step of setting a font color with an unchanged hue and a changed tone with respect to the hue and the tone of a PCCS color system on the basis of the input image data and the set text superimposed region, and setting a font including at least a font color; and
a step of generating data of a superimposed image that is data of an image in which the set text data is superimposed on the set text superimposed region in the input image data using the set font including at least the font color.

44. An image processing method comprising:
a step in which an image processing apparatus inputs image data;
a step in which the image processing apparatus sets text data;
a step in which the image processing apparatus sets a text superimposed region that is a region on which the set text data is superimposed in the input image data;
a step in which the image processing apparatus sets a font color with an unchanged hue and a changed tone with respect to the hue and the tone of a PCCS color system on the basis of the input image data and the set text superimposed region, and sets a font including at least a font color; and
a step in which the image processing apparatus generates data of a superimposed image that is data of an image in which the set text data is superimposed on the set text superimposed region in the input image data using the set font including at least the font color.

45. An imaging apparatus comprising the image processing apparatus according to claim 36.

46. An image processing apparatus comprising:
an acquisition unit that acquires image data and text data;
a region determination unit that determines a text placement region in which the text data is placed in the image data;
a color setting unit that sets a predetermined color to text data; and
an image generation unit that generates an image in which the text data of the predetermined color is placed in the text placement region, wherein
a ratio of a hue value of the text placement region of the image data to a hue value of the text data is closer to one than a ratio of a tone value of the text placement region of the image data to a tone value of the text data.

47. The image processing apparatus according to claim 46, wherein
the color setting unit obtains a tone value and a hue value of a PCCS color system from an average color of RGB of the text placement region, and changes only the tone value of the PCCS color system and does not change the hue of the PCCS color system.

48. An image processing apparatus comprising:
a determination unit that determines a placement region in which a character is placed in image data;
a color setting unit that sets a predetermined color to a character; and
an image generation unit that generates an image in which the character is placed in the placement region, wherein
the color setting unit sets the predetermined color such that a ratio of a hue value of the placement region to a hue value of the character is closer to one than a ratio of a tone value of the placement region to a tone value of the character.
